(19) United States
(12) Patent Application Publication
(10) Pub. No.: US 2015/0379521 A1
(43) Pub. Date: Dec. 31, 2015

(54) Systems and Methods for Compliance and Announcement Display and Notification

(71) Applicant: C-Scape Consulting Corporation, Rockville Centre, NY (US)

(72) Inventors: Stephen J. WEISS, New Rochelle, NY (US); James J. FALLON, Armonk, NY (US)

(73) Assignee: C-Scape Consulting Corporation

(21) Appl. No.: 14/642,292

(22) Filed: Mar. 9, 2015

Related U.S. Application Data
(63) Continuation of application No. 12/070,699, filed on Feb. 19, 2008, now abandoned.
(60) Provisional application No. 60/925,427, filed on Apr. 19, 2007.

(51) Int. Cl. G06Q 30/00; G06Q 10/10

(52) U.S. Cl. CPC G06Q 30/018; G06Q 10/105

(57) ABSTRACT

Systems and methods are provided for compliance and announcement display and notification.

### CROSS REFERENCE TO RELATED APPLICATIONS

This application is a continuation of U.S. patent application Ser. No. 12/070,699, filed Feb. 19, 2008, which claims benefit of U.S. Provisional Patent Application No. 60/925,427, filed Apr. 19, 2007, now expired, all of which are incorporated herein by reference in their entirety.

### BACKGROUND OF THE INVENTION

This relates generally to display of information and, more particularly, to systems and methods for providing automated notification and display of compliance issues and other announcements.

Labor laws have been enacted in nearly all countries of the world. Some of the goals of labor laws are to protect workers and employers from mutual abuse, define the expectations between employer and employee, and, in some instances, try to equalize the bargaining power between employers and employees. Certain countries, or portions of specific countries, also permit the formation of unions or other organizations that collectively represent a pool of employees to one or more employers. Thus certain labor laws grant employees the right to unionize and allows employers and employees to engage in certain activities (e.g. strikes, picketing, seeking injunctions, lockouts) so as to have their demands fulfilled.

In the United States of America, labor law is governed by federal law, state law and specific judicial decisions, both at the Federal and State level. Labor law is also governed by regulations and decisions of specific administrative agencies. As defined by the Constitution of the United States of America, States are preempted from interfering with both federal statutory law and with the guidelines promulgated by agencies established under federal law or by the U.S. Constitution.

The National Labor Relations Act (NLRA) was enacted by Congress in 1935. The NLRA has the powers to regulate interstate commerce, to govern the employer/employee bargaining, and union relationship on a national level. The NLRA was amended by the Labor Management Relations (Taft-Hartley) Act in 1947 and the Labor Management Reporting and Disclosure (Landrum-Griffen) Act in 1959. Most employers and employees involved in businesses that affect interstate commerce are regulated by the act. Employers and employees that are not subject to the NLRA may have their relationships governed by other federal or state statutes. The Railway Labor Act governs labor relations in the railway and airline industries. The employees and agencies in the federal public sector are subject to the Federal Service Labor-Management Relations Act (FSLMRA), which is administered by the Federal Labor Relations Authority. States also extensively regulate the employer/employee bargaining relationship.

One constant within this ever changing set of laws and regulatory requirements is the need to notify both employees and employers of these requirements. In specific, many of the statutes and regulations enforced by agencies within the U.S. Department of Labor require that posters or notices be posted conspicuously in the workplace.

The U.S. Department now provides electronic copies of the required posters and some of the posters are available in languages other than English. It should be noted that posting requirements vary by statute; that is, not all employers are covered by each of the Department's statutes and thus may not be required to post a specific notice. For example, some small businesses may not be covered by the Family and Medical Leave Act and thus would not be subject to the Act's posting requirements.

Non-compliance to posting up-to-date information can bring a wide variety of penalties including: citations, fines, civil monetary penalties and damages, and loss of government contracts, dependent upon the employer, state, and nature of the offense. Multiple violations may incur incrementally larger penalties.

Specific Federal Posting requirements include items such as: the Uniformed Services Employment and Reemployment Act, Job Safety and Health Protection, Equal Employment Opportunity, Family and Medical Leave Act, Federal Minimum Wage, and the Employee Polygraph Protection Act. It is anticipated that many new requirements will be added or amended over time as regulations grow ever more complex and demanding.

State requirements vary significantly from state to state. By way of example, the requirements for New York State includes: Right-to-Know, Clean Indoor Air Act, Workers' Compensation, Unemployment Insurance, Disability Benefits, Discrimination Notice, Time Off to Vote, Minimum Wage, and Child Labor. Once again, it is anticipated that many new requirements will be added or amended over time as regulations grow ever more complex and demanding.

Comprehensive Labor Law Posters are currently offered. These posters often contain many or all of the state and federal mandated posters on one poster. Alternately, many of these companies also offer the ability to purchase state only labor law posters with all the state requirements on one poster and a separate federal labor law poster with all or many of the federal requirements on one poster. The primary reason for this segregation of topics is to enhance readability. Often each poster can contain large amounts of text covering a diverse number of topics. By way of example, one widely used poster is 37 inches tall by 24 inches wide. Thus, one problem is that a large amount of wall space is required to display various labor law posters.

Another problem is that the posters are often time consuming and uncomfortable to read. This often renders many of the postings ineffective. Posters are typically mounted at standing eye level and utilize fairly small type in order to display all the requisite information in even a fairly substantial space. While segregating the Federal and State laws on separate posters would make them somewhat more readable, an even larger area of 4 feet by 3 feet of wall space would be required. Yet another problem with the current art is cost; having multiple posters adds to the recurring costs of procuring and updating postings on a periodic basis.

Yet another problem occurs with companies that have a diverse ethnicity of employees, thus requiring postings in multiple languages. Federal and State Postings in only two languages would require an area of over 8 feet wide by 3 feet high of wall space. Companies with a more diverse employee base may wish to have postings in more than two languages, further compounding the problem.

Yet another problem occurs with large businesses. Posting requirements for large businesses can be an even a greater logistical burden as there may be postings at multiple locations. Even medium size facilities may require multiple postings within the same location. Further, diverse geographic locations often require different postings as requirements vary from state to state and by the nature of work performed in a specific facility. Compounding this problem is the desire to post in multiple languages. Even a small change to one labor law results in an enormous amount of cost and labor to purchase the updated posters for all the various locations, ship them to the appropriate facilities, remove the old posters and put up the new ones, and then validate that the work has been performed.

Due to the cost and logistics of updating postings, many companies limit the number of times that they update postings. This is problematic as the company may have substantial periods of time when their postings are not in compliance. Posting requirements may be updated frequently and there is no reasonable cost effective methodology of maintaining and assuring compliance.

Yet another problem is the ambiguity among certain posting and notification requirements. By way of example, every employer covered by the non-discrimination and Equal Employment Opportunity (EEO) laws is required to post on its premises the poster, “Equal Employment Opportunity is the Law.” The notice must be posted prominently, where it can be readily seen by employees and applicants for employment. The notice provides information concerning the laws and procedures for filing complaints of violations of the laws with the Office of Federal Contract Compliance Programs (OFCCP). There is more than one allowed version of an EEO compliance poster. Specifically, the Office of Federal Contract Compliance Programs (OFCCP) recognizes that there are differences between this poster and the poster provided by the U.S. Equal Employment Opportunity Commission (EEOC). Despite these differences, both posters are currently accepted as valid by OFCCP and EEOC; however there are no assurances that this situation will always hold in the future.

The U.S. Department of Labor developed the Elaws® Advisors to help employees and employers understand their respective rights and responsibilities under numerous Federal employment laws. Each Advisor includes links to more detailed information that may be useful to the user, such as links to regulatory text, publications and organizations. In specific, as cited on the U.S. Department of Labor website, the elaws Advisors are interactive e-tools that provide easy to understand information about a number of employment laws. Each advisor simulates the interaction one might have with an employment law expert. It asks questions and provides answers based upon the responses given.

Within the U.S. Department of Labor elaws site is the elaws Poster Advisor. The elaws Poster Advisor is designed to help employers comply with the poster requirements of several laws administered by the U.S. Department of Labor. These laws require employers to display official U.S. Department of Labor posters where employees can readily observe them. U.S. Department of Labor provides the posters at no cost to employers. Thus the elaws Poster Advisor assists in determining the posters that must be displayed in a workplace. Since the posters required for a specific business establishment depend on such factors as the nature and location of the business, the number of employees, annual dollar volume, and whether the business has Federal contracts or subcontracts, the Advisor will ask a series of questions. The Advisor will then evaluate the responses, and provide a list of posters that must be displayed along with an opportunity to print them.

Given the complexity of the laws and the wide diversity of business types and structures, there are some situations where the Advisor may not be able to make a conclusive determination, or cases where one may wish to speak with a U.S. Department of Labor representative or a competent employment attorney or advisor about a particular issue. In order to assist in these cases, the Advisor also provides U.S. Department of Labor contact information for each poster.

However, elaws is problematic. Compliance posters are regularly changed and elaws does not provide any notification when such changes occur. A second limitation is that it only provides each compliance poster by specific law or charter. Thus numerous downloads must occur and posters printed. A third limitation is that elaws only applies to some DOL posting mandates. In specific, certain business operations may be required to display posters that can only be obtained from DOL's Office of Workers' Compensation Programs (OWCP). A fourth and very significant limitation is that elaws does not cover state posting mandates or notification requirements. Each state must be consulted on a state by state basis which can be a time consuming and error prone process. A fifth limitation is that some laws require that employers provide certain other information to employees, but do not require that a poster be displayed. The elaws Poster Advisor only deals with identifying the required Federal official posters for a given business.

As a part of the U.S. Department of Labor and other Federal, State, and Administrative Agencies, elaws have inherent limitations in their ability to service specific business needs. In specific, the onus for posting compliance is and should always reside with the business. This same limitation essentially resides with all Federal, State, and Regulatory agencies—they do not want to assume the liability of having to transfer and verifying receipt of the posting or notification data to the appropriate party or parties with a specific company. Employee turnover; administrative, organizational, or legal changes within an organization; mergers, acquisitions, and divestitures; changes of address (both physical and electronic mail), and a myriad other related factors make it nearly impossible to ensure that the posting and notification information has been received by the responsible party. This is a fundamental problem.

There have been a number of attempts over the years to address this limitation. Some current programs include plans that attempt to ensure compliance by having a company register and pay for specific products under a service plan that covers updates for a specified duration in time. By way of example, a company registers their mailing address and point of contact information, along with paying a fee based upon the posters desired and the duration for which they wish to be provided updates. The company then ships physical posters that may include such standard items as Federal, State, and OSHA Labor Law Posters. Additional postings may include other posters on a variety issues such as Sexual Harassment, Safety in the Workplace, HIPPAA Compliance, and other issues relating to compliance postings and notification. Items such as the date and revision level of the posters shipped to a company are retained in a manual or automated record keeping system. One or more replacement posters are then sent out automatically when changes occur. This service may also be tied in with a variety of marketing techniques including promotional newsletters that discuss labor law issues and updates on insurance.

There are several significant problems with this current solution. One problem is that posters have to be manufactured and delivered to the respective businesses well in advance of the actual effective date of any change. Each poster that has been updated must be changed on the effective date. Another problem is the cost associated with manufacturing and shipping each poster. Once an updated poster has been received the responsible party in a company must ensure that it is posted properly.

In addition to Federal and State notification and posting requirements, there exist a plethora of additional regulatory agencies and internal company notices that also have specific posting and notification requirements. By way of example, Insurance Companies often send Workmen's Comprehensive & Disability Insurance Notices that must be posted. Additional items include Company Employment Manuals, Company Policies & Procedures Manuals. Emergency Procedures, Hazardous Materials Requirements, OSHA Requirements, and rapid access to Materials Safety Data Sheets. Another limitation within the current art is the lack of an integrated system that provides rapid access to some or all of the above information, for display and on-demand printing.

E-paper and e-ink are organic electronics that use conductive materials containing microscopic balls of ink. The microscopic balls of ink respond to electric charges, thus act like pixels on a computer display. They change in response to the charges in a process known as electrophoresis and electrochromism. E-paper and e-ink utilizes minimal or no power to maintain displayed information.

### SUMMARY OF THE INVENTION

This is directed to systems and methods for Compliance and Announcement, Display and Notification providing a fast, efficient, and highly cost effective method of displaying compliance data and notifications. It is an object to address the limitations of conventional compliance techniques.

In addition to the objects and advantages of the present invention, a Compliance and Announcement, Display and Notification System and Method, providing a fast, efficient, and highly cost effective method of displaying compliance data and notifications, several additional objects and advantages of the present invention are described below.

Systems and methods are provided to receive compliance data by a company, person or any entity, optionally storing the data in a buffer, and displaying the compliance data using, for example, a web browser, e-paper, e-ink, a monitor, or any other display device, etc.

Systems and methods are provided to transmit compliance data to a company or any other person or entity; receiving compliance data by a company, person or any entity, and displaying the compliance data using a web browser, e-paper, e-ink, a monitor, or any other display device. The transmission may be via any method including electronic data transmission or in physical electronic media.

Systems and methods are provided to provide a compliance announcement, display and notification system that allows electronic distribution of compliance information notifications and other relevant company information via data transmission. Systems and methods are provided for the sending of physical media, or any other suitable media, to multiple locations, either within the same facility or amongst multiple diverse locations, where the location definition is via IP address or any other technique, thereby reducing the logistical burden for businesses.

Systems and methods are provided to provide a compliance announcement, display and notification system that allows electronic distribution of location specific compliance information, notifications, and other relevant company information to multiple locations, either within the same facility or amongst multiple diverse locations, thereby reducing the logistical burden for businesses.

Systems and methods are provided to provide a compliance announcement, display and notification system that may allow electronic distribution of compliance information, notifications, and other relevant company information on a state by state basis as required by the user, eliminating the need to contact various agencies within one or more states.

Systems and methods are provided to provide a compliance announcement, display and notification system that may allow electronic distribution of incremental updates to compliance information, notifications, and other relevant company information, thereby eliminating the need and costs associated with a physical poster purchase, shipping, receiving, posting, and verification of posting.

Systems and methods are provided to provide a compliance announcement, display and notification system that may allow electronic distribution of compliance information, notifications, and other relevant company information, facilitating frequent updates and allowing for shorter cycle times from information creation to display within various companies or other users.

Systems and methods are provided to provide a compliance announcement, display and notification system that may allow electronic distribution of compliance information, notifications, and other relevant company information, from a known database of valid, unambiguous compliance, notification, and company information, thereby eliminating possible user confusion and ambiguities.

Systems and methods are provided to provide a compliance announcement, display and notification system that maintains links to one or more sources of compliance data, and may be on a predetermined time schedule such as a recurring periodic cycle, or by request. The links may come from a known list or via scanning the internet or any other repository of information with an automated search tool or any other method to locate one or more relevant for sources of compliance or announcement information, and then creating a list of links to some or all of the sources of relevant compliance or announcement information. The links are utilized to automatically scan for updated compliance data or other information of interest and meta data associated with the information such as the effective date of the new compliance information, date and or time of receipt, date and or of creation, source of data, known ambiguities or conflicts and what data is replaced or superseded, thereby ensuring that up to date compliance data is available on a timely basis. In addition to automatic scanning, the scanning can also be done upon request, on a predetermined timetable, on a recurring periodic cycle, or upon notification that additional or updated compliance or announcement data or meta data is available. Some or all of the compliance or announcement data may be downloaded. The compliance and announcement data may be stored on a local hard drive or remotely, or in a centralized or distributed respository(s). Access to the data may be by any means including local area network, wide area network, internet, utilizing both wireless and hardwired access. Optionally, a history of compliance and announcement information may be maintained. Data storage management techniques may also be applied including storing all of the downloaded compliance and announcement data, archiving data older than a specified date, archiving revisions older than current data or above some number of prior revisions, discarding revisions older than current, discarding prior revisions above a specified number. In the case of incremental update at least all data that applies to the current revision must be saved, either in a series of incremental updates or a master document with a lists of the original document and applied updates.

Systems and methods are provided to provide a compliance announcement, display and notification system that may automatically notifies users when laws or other compliance information, notifications, or relevant company information changes, thereby ensuring that companies are aware of the latest compliance requirements and other information. The updated compliance or announcement data may come from one or more sources and notification via, for example, email (with or without attachments), instant messaging, a telephone call, voice mail messaging, file transfer protocol, any other means of electronic data transmission, or any combination of the above. Optionally the data or notification may be displayed on one or more displays.

Systems and methods are provided to provide a compliance announcement, display and notification system that may update a database or other repository of compliance or other information with additional or new information by receiving the information from a transmission from an external or internal website, a file server, or any other device. The data may be transmitted to the repository autonomously, by scheduled or periodic request, or any other mechanism including an autonomous scanning system (BOT) that may continuously scans for updated compliance data or information and requests or may deliver it when located, thus providing updated compliance information with a known update period.

Systems and methods are provided to provide a compliance announcement, display and notification system that may transmit compliance data that is stored locally on a requestor's internal data storage device and may be optionally accessible via a local area network, wide area network, or via any other transmission method, thus providing rapid access to compliance information.

Systems and methods are provided to provide a compliance announcement, display and notification system that may allow electronic distribution of compliance information, notifications, and other relevant company information, in aggregated downloads or data transfers, eliminating the need to go to multiple websites and other repositories of information and download information piecemeal.

Systems and methods are provided to provide a compliance announcement, display and notification system that may allow electronic distribution of compliance information, notifications, and other relevant company information that is formatted for specific displays, display types or display resolutions, may aggregate compliance data on multiple topics and/or from multiple sources for simultaneous display, and may utilize menus or other forms of user requests to display specific information. The systems and methods may provide a quick and easy means of viewing the information without the need for requestor formatting, the formatting may occur anywhere including the end users facility, the formatting may be utilized to aggregate information for simultaneous or sequential display. In addition formatting can utilize specific color palettes or any other visual or aural techniques for branding based upon supplied or known parameters.

Systems and methods are provided to provide a compliance announcement, display, and notification system where compliance data may be displayed utilizing one or more menu systems. The menu may list compliance topics or subtopics and optionally a brief description of what the compliance subject matter covered by the topics or subtopics. The menus may be organized in a hierarchical fashion. The viewer may select one or more topics to read or review. Selection may be by any technique including an input device such as a touch screen. The subject matter for each topic may be displayed in total, in part, via additional menus, etc. The selected data for display may be aggregated and reformatted if desired. If multiple menus are utilized, the menus may be displayed, for example, concurrently, in succession, in random order, or according to a predefined sequence. Similarly the displayed information may be cycled through in whole or in part on a periodic basis. Advantageously the usage pattern of menus, topics, or subtopics may be recorded for future use. In addition, the display of menus, specific topics, subtopics, or any other information may be learned by the system and displayed in an optimized fashion or sequence. The menu systems thus may provide information display in a compact and efficient format.

Systems and methods are provided to periodically display compliance data or internal company generated information on multiple displays simultaneously, in sequence, or any combination thereof, providing a highly effective, easy to read display.

Systems and methods are provided to provide a compliance announcement, display and notification system that may provide electronic distribution of compliance information, notifications, and other relevant company information that utilizes emergent display technologies such as E-paper and e-ink or other non-volatile or semi-volatile display devices, providing cost effective static or quasi static displays of the information.

Systems and methods are provided to provide a compliance announcement, display and notification system that may allow electronic distribution of information in one or more languages, that may optionally be location specific, including compliance information, notifications, and other relevant company information to multiple locations, either within the same facility or amongst multiple diverse locations, reducing the logistical burden for businesses.

Systems and methods are provided to provide a compliance display and notification system that may display compliance information in a more compact display area via user interactive menus, cycling through various displays, or a combination thereof, thus saving wall space and enhancing readability while also reducing cost by allowing selection of various notifications and compliance information within the same display area.

Systems and methods are provided to provide a compliance announcement, display and notification system that may utilize one or more compact displays that can be mounted or positioned in more convenient locations such as desktops, tables, or wall locations, thereby enhancing readability and reducing reader fatigue.

Systems and methods are provided to provide a compliance announcement, display and notification system that may allow selection of various notifications and compliance information in multiple languages or dialects, either automatically, by user request, or by sensing external information such as a badge or identification card, language recognition, visual recognition, biometric recognition, or DNA, etc., and displaying the compliance information in one or more languages within some or all of the same display area, thereby saving space and enhancing the readability of the information for the user by displaying the information in a more familiar language. The information may alternately be displayed in a new display area.

Systems and methods are provided to provide a compliance announcement, display and notification system that may allow electronic distribution of compliance information, notifications, and other relevant company information to employees, affiliates, consultants, shareholders, suppliers, and any other stakeholders that is required for distribution to the above recipients with or without the requirement for posting, thereby easing logistical requirements.

Systems and methods are provided to provide a compliance announcement, display and notification system that may allow electronic distribution of compliance information, notifications, and other relevant company information to employees, affiliates, consultants, shareholders, suppliers, and any other stakeholders and may validate receipt by the appropriate party and timely posting or distribution of the information, eliminating the typical problems associated with sending hardcopy posters to organizations that may experience employee turnover, administrative, organizational, or legal changes within an organization, mergers, acquisitions, and divestitures, changes of address (both physical and electronic mail). The information receipt and or display may be verified on a time sensitive basis.

Systems and methods are provided to provide a compliance announcement, display and notification system that provides electronic distribution of compliance information, notifications, and other relevant company information including: Certificates of Insurance, Workmen's Compensation Insurance, Disability Insurance, and also provide on-demand access to information such as Company Employment Manuals, Company Policy and Procedures, Emergency Procedures, Hazardous Material Requirements, OSHA Requirements, and Materials Safety Data Sheets to employees, affiliates, consultants, shareholders, suppliers, and any other stakeholders in advance of the actual effective date and time and displays, prints, or sends the information at a prescribed date and time, thereby ensuring time receipt and display, printing, or retransmitting of the information.

Systems and methods are provided to provide a compliance announcement, display and notification system that may combine compliance data with requestor data of interest and optionally may display the combined information. The company data may include internal company notices that also have specific posting and notification requirements such as Insurance Companies Workmen's Comprehensive & Disability Insurance Notices, Company Employment Manuals, Company Policies & Procedures, Emergency Procedures, Hazardous Materials Requirements, OSHA Requirements, and Materials Safety Data Sheets.

Systems and methods are provided to provide a compliance announcement, display and notification system that may automatically request and obtain compliance data or other information is from a third party source and displayed alone or in combination with other compliance data or information, easing the logistical burden on a company or other entity. If the requested data is not received, it may be re-requested. Some or all of the requests may be logged. Received information may be optionally printed or displayed.

Systems and methods are provided to provide a compliance announcement, display and notification system that may provide electronic distribution and on-demand printing by user request of compliance information, notifications, and other relevant company information including Certificates of Insurance, Workmen's Compensation Insurance, Disability Insurance, and also provide on-demand access to information such as Company Employment Manuals, Company Policy and Procedures, Emergency Procedures, Hazardous Material Requirements, OSHA Requirements, and Materials Safety Data Sheets, providing easy access to the information. Items may be selected to print and also display.

Systems and methods are provided to provide a compliance announcement, display and notification system that may allow a requestor wishing compliance data to register relevant user information over the internet or any other means. The user may specify which types of compliance data are required, for example Federal, State, and Regulatory compliance information. The compliance data is transmitted to the requestor and automatically displayed on one or more display devices, thereby providing a paperless end to end compliance display system.

Systems and methods are provided to provide a compliance announcement, display and notification system that may prompt the requestor to fill out one or more forms that determine the compliance posting and notification requirements for a specific business establishment. Representative information may include the nature and location or locations of the business, number of posting sites along with their physical and electronic locations, the types of displays utilized at each location, the number of employees at each location and in total, the languages spoken by employees at each physical location or display location, the annual dollar volume of the business at each location or in total, whether the requestor has Federal contracts or subcontracts, etc. The answers may then be utilized to build a list of compliance data posting and notification requirements for each physical location and/or display. In addition a master list may be compiled with all compliance and notification requirements for a given requestor. The individual lists may then be utilized to aggregate the compliance and notification information for each display.

Systems and methods are provided to provide a compliance announcement, display and notification system that may allow the requestor to select a fixed period of time to receive compliance data and compliance data updates and to pay for the service online, or may be billed if appropriate credit information is received and approved by the compliance data service provider, providing a flexible and convenient means for selecting service period and payment option.

Systems and methods are provided to provide a compliance announcement, display and notification system that may provide compliance data to the requestor for free. The compliance data may be appended to information from one or more advertisers which may then be displayed concurrently with the compliance data. The advertising may be based on one or more of the following factors: a fixed or variable fee, a per user basis, per display basis, per industry basis, flat fee, by display size, may be promotional from the compliance data service provider, etc.

Systems and methods are provided to provide a compliance announcement, display and notification system that may transmit new or updated compliance or announcement data in advance of the compliance data becoming effective. The updated compliance or announcement data may be cached or otherwise stored in memory until the compliance data becomes effective, and may optionally be displayed. The updated data may, for example, replace existing data being displayed, may be appended to existing data, already being displayed, or may replace other data being displayed, etc., thereby affording display of the information on or before the effective date as desired. The data may also be displayed in advance of or on the effective date and (optionally) time. Alternately the data may be displayed in advance of its effective data simultaneously or in sequence with the currently effective data, or the currently effective data may be displayed simultaneously or in sequence with the upcoming incremental changes, or vice versa.

Systems and methods are provided to provide a compliance announcement, display and notification system that stores compliance data on one or more Document Servers. The Document Servers may be, for example, manually or automatically updated. In addition the Document Servers may hold multiple revisions of the same compliance data with past, present, or future effective dates and any other information that may be desired by some or all of the various requestors. In addition, this data, including the compliance data, may reside in multiple proprietary, industry standard, document, database, or display formats for a variety of requestors and display devices. The Document Servers may keep all revisions of a document, revisions received after a specific date, only the currently effective documents, a specified number of revisions, or any other retention criteria. The retention policy may vary by document type or area of affectivity (for example, labor law), or by regulatory agency. The Document Server may store complete documents or documents and incremental updates.

Systems and methods are provided to provide a compliance announcement, display and notification system that may generate compliance data specific to a given requestor. Each requestor may request multiple different reports comprising various mixtures of compliance data, internal company information, information external to the company, and any other desired information by the requestor. A Report Generator may be utilized to gather requisite information from a Document Server, Company Internal Information Systems or storage, and External Sources of Information such as, for example, the Internet. The Display Server may be utilized to transmit the report data to one or more physical or electronic locations. The transmitted data may be sent by any way including physical media or electronic connections including Ethernet, Wifi, any type of modem including cable modem, Local Area Network, Wide Area Network, Cellular, two way radio pager, one way radio pager, satellite transmission, or any combination thereof. It is anticipated that new technologies will become available and may be advantageously employed by the present invention. The report information may be displayed on any form of display including liquid crystal displays, plasma displays, projection displays, LED displays, OLED displays, e-paper, and electronic ink displays.

Systems and methods are provided to provide a compliance announcement, display and notification system that may transmit some or all of the compliance information along with any other information in an encrypted to provide data security; optionally the encrypted data may be transmitted, received, decrypted and/or displayed. The decryption may be performed on a request basis by authorized transmitter, receiver, or end user.

Systems and methods are provided to provide a compliance announcement, display and notification system that may store some or all of the compliance information and any other information in an encrypted format to provide data security.

Systems and methods are provided to provide a compliance announcement, display and notification system that may tag some or all of the compliance data and any other information with error correction and validation information to ensure that all requested compliance data is received properly. The received data may be checked for errors, errors may be fixed if possible, and data with received errors may be flagged for the end, system administrator, or data provider with status items such as, for example, if data is received corrupted, amount of corruption, and if some or all of the corrupted data has been corrected.

Systems and methods are provided to provide a compliance announcement, display and notification system that may periodically test one or more displays to ensure proper operation.

Systems and methods are provided to provide a compliance announcement, display and notification system that may utilize one or more redundant displays at the same physical location to ensure continuous uninterrupted display of compliance information and any other desired notification or emergency information.

Systems and methods are provided to provide a compliance announcement, display and notification system that may utilize multiple displays devices to display compliance information in a more optimal fashion, and upon the failure of one or more, but not all of the displays, the display or displays may be altered to show mandated or highest priority compliance data and or information.

Systems and methods are provided to provide a compliance announcement, display and notification system that may utilize one or more displays co-located within a fixed proximity of each other showing compliance information. In the event of a failure of one or more, but not all, displays, the remaining display(s) may be positioned to fulfill compliance for both geographic areas. Optionally, a fixed sign may indicate that, if this display is inoperative, please see display located at xyz location.

Systems and methods are provided to provide a compliance announcement, display and notification system that may utilize an input device to select compliance or any other information to display along with remote access and system setup.

Systems and methods are provided to provide a compliance announcement, display and notification system that may control the compliance announcement, display and notification system via one or more devices utilizing wireless interfaces such as Bluetooth and wireless Local or Wide Area networking, utilizing and available protocol including text messaging and other standard and non-standard protocols. A wireless device may also be utilized for remote access for system setup, monitoring, updates, and compliance verification. The wireless input and optional display device may be a cell phone device or Personal Digital Assistant or Smart Phone wirelessly coupled to the Internet, to select compliance or any other information to display according to any embodiment of the present invention. In addition, the connections to the network and display device may any form of wireless including LAN, WAN, Cell, or Bluetooth.

Systems and methods are provided to provide a compliance announcement, display and notification system that has one or more of the displays utilized to show compliance information or other information that may be operatively coupled to an emergency notification systems such as the Emergency Broadcast System, a fire alarm, a burglar alarm, a carbon monoxide alarm, chemical agent detection, biological agent detection, or a warning system for any type of imminent or an emergent emergency situation. In the event of an emergency the display may conspicuously display one or more of the following pieces of information: that an emergency condition exists, the nature of the emergency, any corrective actions or emergency procedures to follow, etc. One or more emergency notices may be displayed on a priority basis, pre-empting some or all of the otherwise displayed information. Emergency, Redundant, or Backup Power may be employed to keep all devices operational. Static Display Devices such as e-paper and e-ink may advantageously retain information during periods of power loss.

Systems and methods are provided to provide a compliance announcement, display and notification system that may utilize one or more standardized Emergency Notification Protocols to provide integration of emergency detection and notification systems and rapid dissemination of emergency information and procedures. The standard protocols may have Emergency Notification flags embedded within the header field or body of the message to provide integration of emergency detection and notification systems and rapid dissemination of emergency information and procedures.

Systems and methods are provided to provide a compliance announcement, display and notification system that may utilize an emergency notification and services routing system that accepts sensor input, external information and automatically generates emergency notification messages and procedures for specific address or broadcast to a range of addresses. This can be targeted for specific facilities or specific locations within a given facility.

Systems and methods are provided to provide a compliance announcement, display and notification system that may utilize authentication and validation of both compliance data and or emergency messages to ensure that messages are authentic and valid.

### BRIEF DESCRIPTION OF THE DRAWINGS

The above and other objects and advantages of the present invention will be apparent upon consideration of the following detailed description, taken in conjunction with accompanying drawings, in which like reference characters refer to like parts throughout, and in which:

FIGS. 1A & 1B are block diagrams of an Announcement, Display and Notification System receiving and displaying compliance data constructed in accordance with the principles of the present invention;

FIG. 2 is a block diagram of an Announcement, Display, and Notification System that may transmit, receive, and display compliance data and is constructed in accordance with the principles of the present invention;

FIGS. 3A & 3B are block diagrams of an Announcement, Display, and Notification System that may provide electronic distribution of compliance information to multiple diverse locations constructed in accordance with the principles of the present invention;

FIGS. 4A & 4B are block diagrams of an Announcement, Display, and Notification System that may provide electronic distribution of compliance location specific information to multiple diverse locations constructed in accordance with the principles of the present invention;

FIG. 5 is a flow diagram of an Announcement, Display, and Notification System that may provide electronic distribution of compliance location specific and location non-specific information to multiple diverse locations constructed in accordance with the principles of the present invention;

FIG. 6 is a flow diagram of an Announcement, Display, and Notification System that may provide electronic distribution of compliance location specific information on a state-by-state basis to multiple diverse locations constructed in accordance with the principles of the present invention;

FIG. 7 is a flow diagram of an Announcement, Display, and Notification System that may provide electronic distribution of incremental updates of compliance information, notifications, and other relevant company information, constructed in accordance with the principles of the present invention;

FIG. 8 is a block diagram of an Announcement, Display, and Notification System that may provide electronic distribution of electronic distribution of compliance information, notifications, and other relevant company information, facilitating frequent updates and allowing for shorter cycle times from information creation to display, constructed in accordance with the principles of the present invention;

FIG. 9 is a flow diagram of an Announcement, Display, and Notification System that may provide electronic distribution of compliance information, notifications, and other relevant company information, from a known database of valid, unambiguous compliance, notification, and company information, constructed in accordance with the principles of the present invention;

FIGS. 10A and 10B are flow diagrams of an Announcement, Display, and Notification System that may maintain links to one or more sources of compliance data and automatically, or upon request, scans for updated compliance data and associated meta data maintains links to sources of each type of compliance information, notifications, and other relevant company information, constructed in accordance with the principles of the present invention;

FIG. 11 is a flow diagram of an Announcement, Display, and Notification System that may automatically notify users when laws or other compliance information, notifications, or relevant company information changes, constructed in accordance with the principles of the present invention;

FIGS. 12A, 12B, and 12C are flow diagrams of an Announcement, Display, and Notification System that may receive updates via transmission from an external or internal website, a file server, or any other device and maintains a database or other repository of information, constructed in accordance with the principles of the present invention;

FIG. 13 is a block diagram of an Announcement, Display, and Notification System that may store transmitted compliance data locally on a requestors internal data storage device and may be optionally accessible via a local area network, wide area network, or via any other transmission method, constructed in accordance with the principles of the present invention;

FIG. 14 is a block diagram of an Announcement, Display, and Notification System that that may allow electronic distribution of compliance information, notifications, and other relevant company information, in aggregated downloads or data transfers, constructed in accordance with the principles of the present invention;

FIG. 15 is a block diagram of an Announcement, Display, and Notification System that may allow electronic distribution of compliance information, notifications, and other relevant company information that is formatted for specific displays, display types or display resolutions, may aggregate compliance data from on multiple topics or sources for simultaneous display, and may utilize menus or other forms of user requests to display specific information, constructed in accordance with the principles of the present invention;

FIG. 16 is a diagram of an Announcement, Display, and Notification System that may display compliance information utilizing one or more menu systems or sub menu systems, constructed in accordance with the principles of the present invention;

FIGS. 17A and 17B are block diagrams of an Announcement, Display and Notification System that may display compliance data or internal company generated information on multiple co-located displays simultaneously, in sequence, or any combination thereof, constructed in accordance with the principles of the present invention;

FIG. 18 is a block diagram of an Announcement, Display, and Notification System that may provide electronic distribution of compliance information, notifications, and other relevant company information utilizing static or quasi static emergent display technologies such as e-paper and e-ink or other non-volatile or semi-volatile display devices, constructed in accordance with the principles of the present invention;

FIG. 19 is a block diagram of an Announcement, Display, and Notification System that may allow electronic distribution of information in one or more languages, that may optionally be location specific, including compliance information, notifications, and other relevant company information to multiple locations, either within the same facility or amongst multiple diverse locations, constructed in accordance with the principles of the present invention;

FIG. 20 is an illustration of an Announcement, Display, and Notification System that may display compliance information using interactive menus, constructed in accordance with the principles of the present invention;

FIGS. 21A and 21B is an illustration of an Announcement, Display, and Notification System that may display compliance information in a more compact display area via user interactive menus, cycling through various displays, or a combination thereof constructed in accordance with the principles of the present invention;

FIG. 22 is an illustration an Announcement, Display, and Notification System that may utilize one or more compact displays that can be mounted or positioned in more convenient locations such as desktops, tables, or wall locations constructed in accordance with the principles of the present invention;

FIG. 23 is a flow diagram of an Announcement, Display, and Notification System that may allow selection of various notifications and compliance information in multiple languages automatically by sensing external information such as a badge or identification card, and displaying the compliance information in one or more languages constructed in accordance with the principles of the present invention;

FIGS. 24A and 24B are flow diagrams of an Announcement, Display, and Notification System that may allow selection of various notifications and compliance information in multiple languages automatically and displaying the compliance information in one or more languages constructed in accordance with the principles of the present invention;

FIG. 25 is a block diagram of an Announcement, Display, and Notification System that may allow selection of various notifications and compliance information in multiple languages by sensing external information such as a badge or identification card, and displaying the compliance information in one or more languages constructed in accordance with the principles of the present invention;

FIG. 26 is a block diagram of an Announcement, Display, and Notification System that may allow electronic distribution of compliance information, notifications, and other relevant company information to employees, affiliates, consultants, shareholders, suppliers, and any other stakeholders that is required for distribution to the above recipients without the requirement for posting constructed in accordance with the principles of the present invention;

FIG. 27 is a block diagram of an Announcement, Display, and Notification System that may allow electronic distribution of compliance information, notifications, and other relevant company information to employees, affiliates, consultants, shareholders, suppliers, and any other stakeholders and validates receipt by the appropriate party and timely posting or distribution of the information, constructed in accordance with the principles of the present invention;

FIG. 28 is a flow diagram of an Announcement, Display, and Notification System that may provide electronic distribution of compliance information, notifications, and other relevant company information to employees, affiliates, consultants, shareholders, suppliers, and any other stakeholders in advance of the actual effective date and time and then displays, prints, or may send the information at a prescribed date and time constructed in accordance with the principles of the present invention;

FIG. 29 is a block diagram of an Announcement, Display, and Notification System that may combine compliance data with requestor data of interest for display. Such as internal company notices that also have specific posing and notification requirements, constructed in accordance with the principles of the present invention;

FIG. 30 is a block diagram of an Announcement, Display, and Notification System that may automatically request and obtain compliance data or other information from a third party source and may be displayed alone or in combination with other compliance data or information constructed in accordance with the principles of the present invention;

FIG. 31 is a block diagram of an Announcement, Display, and Notification System that may provide electronic distribution and on-demand printing by user request of compliance information, notifications, and other relevant company information, and may also provide on-demand access to internal company documents, manuals, safety documentation, emergency procedure constructed in accordance with the principles of the present invention;

FIG. 32 is a block diagram of an Announcement, Display, and Notification System that may allow users to register relevant information over the internet or any other means and specify which types of compliance data are required, for Federal, State, and Regulatory compliance information. Compliance data may be transmitted to the requestor and automatically displayed on one or more display devices constructed in accordance with the principles of the present invention;

FIG. 33 is a block diagram of an Announcement, Display, and Notification System that may prompt the requestor to fill out one or more forms that determine the compliance posting and notification requirements, where the answers may be utilized to build a list of compliance data posting and notification requirements for each physical location and display. In addition a master list may be compiled with all compliance and notification requirements for a given requestor. The individual lists may be utilized to aggregate the compliance and notification information for a specific business establishment or user constructed in accordance with the principles of the present invention;

FIG. 34 is a block diagram of an Announcement, Display, and Notification System that may allow the requestor to select a fixed period of time to receive compliance data and compliance data updates. The user may be required to pay for the service online, or may be billed if appropriate credit information is received and approved by the compliance data service provider constructed in accordance with the principles of the present invention;

FIG. 35 is a block diagram of an Announcement, Display, and Notification System that provides compliance data free of charge. The compliance data may be appended to information from one or more advertisers which is displayed concurrently with the compliance data. The advertising may be for a fixed or variable fee, or may be promotional from the compliance data service provider constructed in accordance with the principles of the present invention;

FIG. 36 is a block diagram of an Announcement, Display, and Notification System that transmits new or updated compliance data to the requestor in advance of the compliance data becoming effective. The updated compliance data is cached or otherwise stored in memory until the compliance data becomes effective, and may then be displayed. The updated compliance data may replace existing compliance data being displayed, may be appended to existing compliance data, already being displayed, or may replace other data being displayed constructed in accordance with the principles of the present invention;

FIG. 37 is a block diagram of an Announcement, Display, and Notification System that may maintain compliance data on one or more Document servers. The Document Servers may be manually or automatically updated. In addition the Document Servers may hold multiple revisions of the same compliance data with past, present, or future effective dates constructed in accordance with the principles of the present invention;

FIGS. 38A and 38B are block diagrams of an Announcement, Display, and Notification System that may provide compliance data specific to a given requestor. Each requestor may request multiple different reports comprising various mixtures of compliance data, internal company information, information external to the company, and any other desired information by the requestor. A Report Generator may be utilized to gather requisite information from a Document Server, Company Internal Information Systems or storage, and External Sources of Information such as, but not limited to, the Internet. The Display Server may then be utilized to transmit the report data to one or more physical or electronic locations. The report information may then be displayed on any form of display including liquid crystal displays, plasma displays, projection displays, LED displays, OLED displays, e-paper, and electronic ink displays constructed in accordance with the principles of the present invention;

FIG. 39 is a flow diagram of an Announcement, Display, and Notification System that may encrypt some or all of the compliance information and all other information for transmission to provide data security constructed in accordance with the principles of the present invention;

FIGS. 40A and 40B are flow diagrams of an Announcement, Display, and Notification System that may encrypts some or all of the compliance information and all other information for storage to provide data security constructed in accordance with the principles of the present invention;

FIG. 41 is a flow diagram of an Announcement, Display, and Notification System that some or all of the compliance data and any other information may be tagged with error correction and validation information to ensure that all requested compliance data is received properly and is constructed in accordance with the principles of the present invention;

FIG. 42 is a flow diagram of an Announcement, Display, and Notification System that may periodically test the display or displays to ensure proper operation and is constructed in accordance with the principles of the present invention;

FIG. 43 is a block diagram of an Announcement, Display, and Notification System that may utilize one or more redundant displays at the same physical location to ensure continuous uninterrupted display of compliance information and any other desired notification or emergency information and is constructed in accordance with the principles of the present invention;

FIG. 44 is a block diagram of an Announcement, Display, and Notification System that may utilize multiple displays devices to display compliance information in a more optimal fashion, and upon the failure of one or more, but not all of the displays, the display or displays are altered to show mandated or highest priority compliance data and or information and is constructed in accordance with the principles of the present invention;

FIG. 45 is a block diagram of an Announcement, Display, and Notification System that may utilize one or more displays, co-located within a fixed proximity of each other, displaying compliance information. In the event of a failure of one or more, but not all, displays, the remaining display(s) may be positioned to fulfill compliance for both geographic areas. Optionally a fixed sign may indicate that, if this display is inoperative, please see display located at xyz location, and is constructed in accordance with the principles of the present invention;

FIG. 46 is a block diagram of an Announcement, Display, and Notification System that may utilize an input device utilized to select compliance or any other information to display constructed in accordance with the principles of the present invention;

FIGS. 47A & 46B are block diagrams of an Announcement, Display, and Notification System that may utilize a wireless input and optional display device utilizing Bluetooth or another protocol to select compliance, or any other information, to display according to another embodiment of the present invention. The wireless input and optional display device may be a cell phone device or wireless Internet-connected Personal Digital Assistant or Smart Phone to select compliance or any other information to display according to another embodiment of the present invention; In addition the connections to the network and display device may any form of wireless including LAN, WAN, Cell, or Bluetooth.

FIG. 48 is a block diagram of an Announcement, Display, and Notification System that utilizes one or more of the displays to display compliance information or other information and may be operatively coupled to an emergency notification systems such as the Emergency Broadcast System, a fire alarm, a burglar alarm, a carbon monoxide alarm or a warning system for any type of imminent or an emergent emergency situation. In the event of an emergency, the display may conspicuously display one or more of the following pieces of information: that an emergency condition exists, the nature of the emergency, any corrective actions or emergency procedures to follow, according to another embodiment of the present invention; Emergency, Redundant, or Backup Power may be employed to keep all devices operational.

FIG. 49 is a block diagram of an Announcement, Display and Notification System that may utilize one or more standardized Emergency Notification Protocols to provide integration of emergency detection and notification systems and rapid dissemination of emergency information and procedures, according to another embodiment of the present invention; the standard Emergency Notification Protocols may optionally employ flags embedded within the header field or body of the message to provide integration of emergency detection and notification systems and rapid dissemination of emergency information and procedures, constructed in accordance with the principles of the present invention;

FIGS. 50A and 50B are block diagrams of an Announcement, Display, and Notification System that may utilize an emergency notification and services routing system that accepts sensor input, external information and automatically generates emergency notification messages and procedures for specific address or broadcast to a range of addresses, constructed in accordance with the principles of the present invention; and

FIGS. 51A and 51B are block diagrams of an Announcement, Display, and Notification System that may utilize authentication and validation of both compliance data and or emergency messages to ensure that messages are authentic and valid constructed in accordance with the principles of the present invention.

### DETAILED DESCRIPTION OF THE INVENTION

Systems and methods are provided for the display of information and, more particularly, for the automated notification and display of compliance issues and other announcements.

Systems may be implemented in various forms of displays, hardware, software, firmware, or a combination thereof. For example, the system modules described herein may be implemented in software as an application program that is executable by a general purpose computer or any machine or device having any suitable and preferred microprocessor architecture. Systems may be implemented, for example, on a computer platform including hardware such as one or more central processing units (CPU), a random access memory (RAM), and input/output (I/O) interface(s). The computer platform may include, for example, an operating system and microinstruction code. The various processes and functions described herein may, for example, be either part of the microinstruction code or application programs which are executed via the operating system. In addition, various other peripheral devices may, for example, be connected to the computer platform, such as an additional data storage device and a printing device.

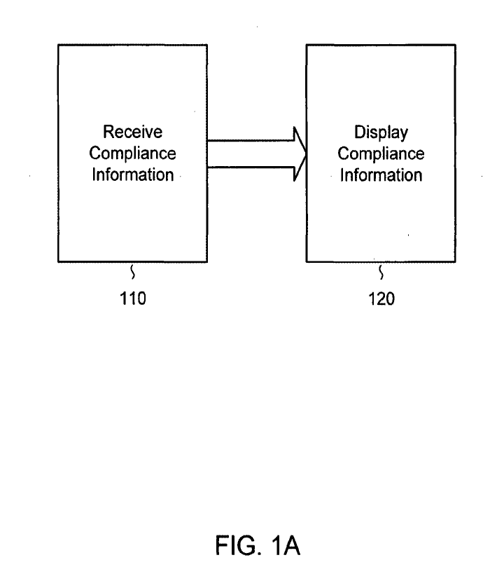

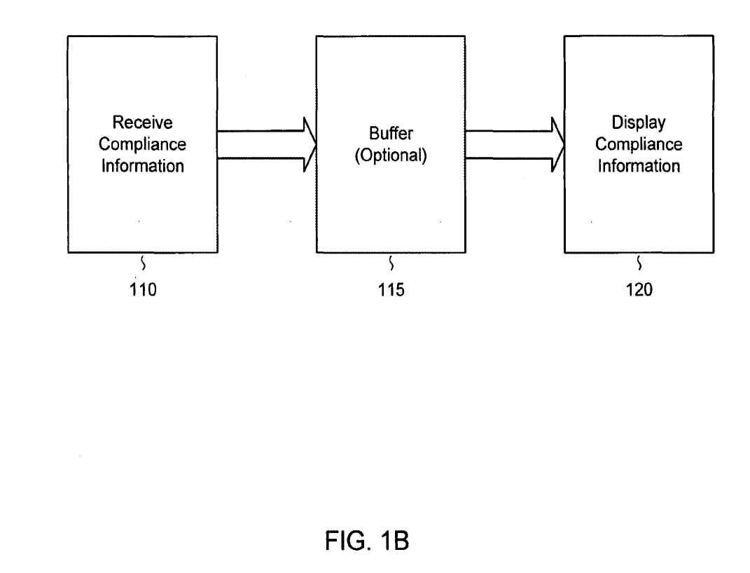

Referring now to FIG. 1, a block diagram illustrates a system for compliance announcement, display and notification system in accordance with an embodiment of the present invention. The system includes a means for receiving compliance data 110, operatively coupled to display device 120. Compliance data may be received via any form of hardware or software that has the ability to receive information stored in an electronic format. It should be noted that the compliance data may be received by any form of data transmission and storage media. Transmission systems include, but are not limited to, Wide Area Networks, Local Area Networks, Dial-up, and Memory Cards.

In addition to the objects and advantages of the present invention, a Compliance, Announcement, Display, and Notification System and Method, providing a fast, efficient, and highly cost effective method of displaying compliance data and notifications, several additional objects and advantages of the present invention are:

FIGS. 1A and 1B shows systems that may, for example, receive compliance data by a company, person or any entity, optionally storing the data in a buffer, and displaying the compliance data using a web browser, e-paper, e-ink, a monitor, or any other display device;

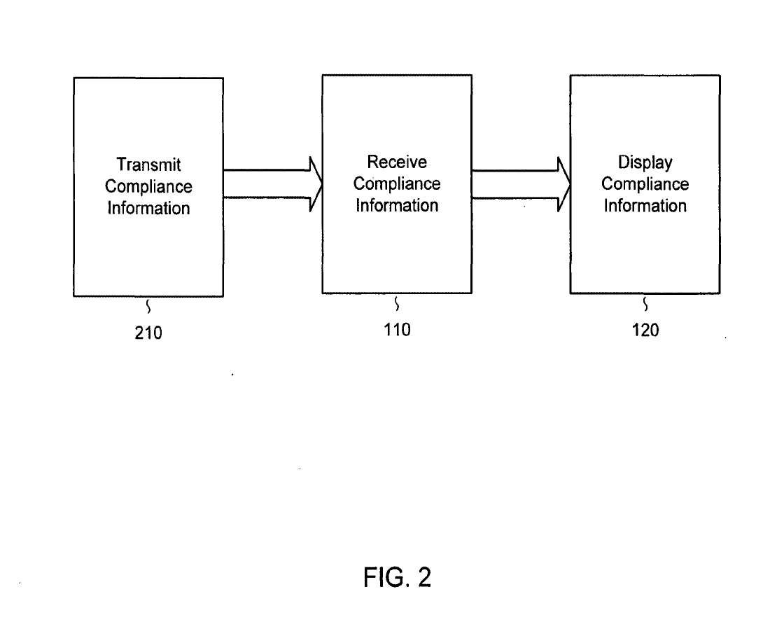

FIG. 2 shows a system that may transmit compliance data to a company or any other person or entity; receiving compliance data by a company, person or any entity, display the compliance data using a web browser, e-paper, e-ink, a monitor, or any other display device. The transmission may be via any method including electronic data transmission or in physical electronic media;

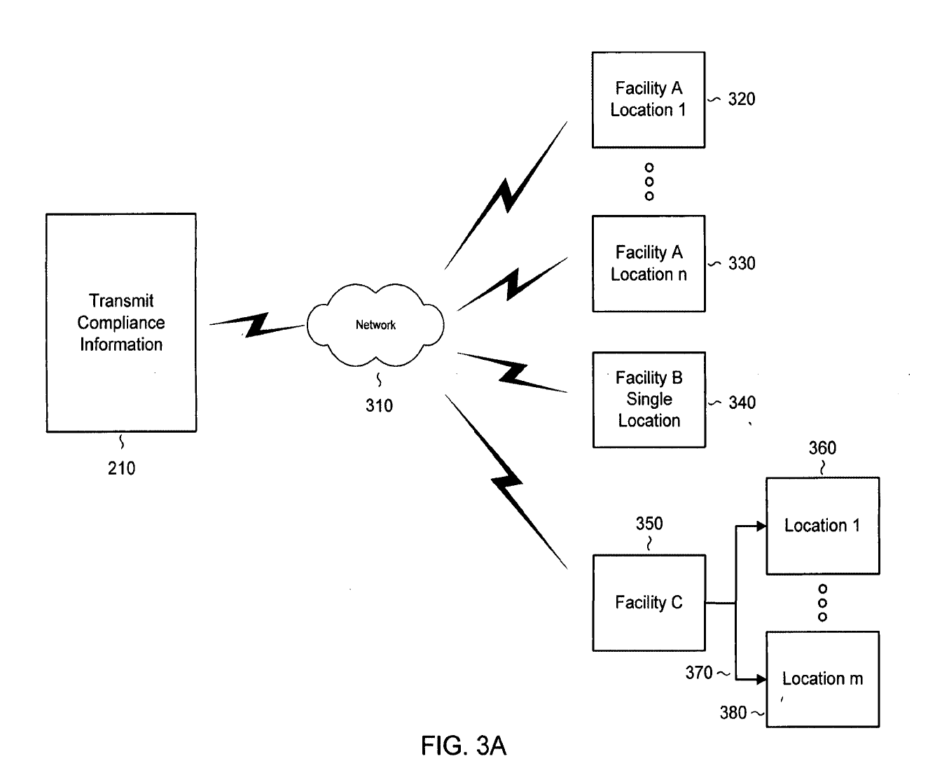

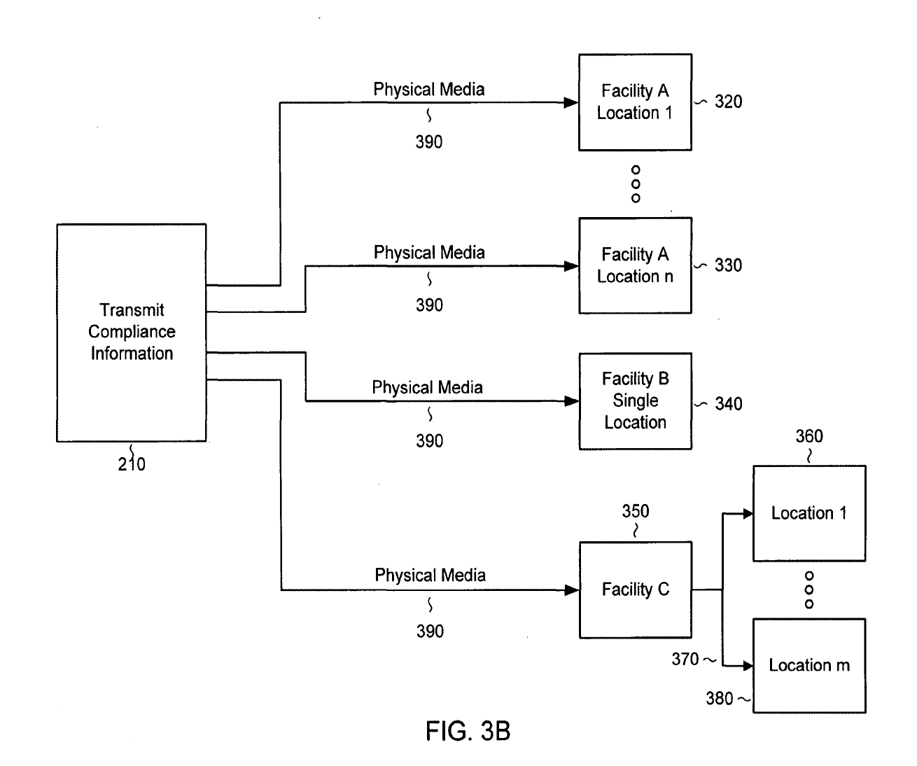

FIGS. 3A and 3B shows systems that may, for example, provide a compliance announcement, display and notification system that allows electronic distribution of compliance information notifications, and other relevant company information via data transmission, the sending of physical media, or any other method, to multiple locations, either within the same facility or amongst multiple diverse locations, where the location definition is via IP address or any other means, thereby reducing the logistical burden for businesses;

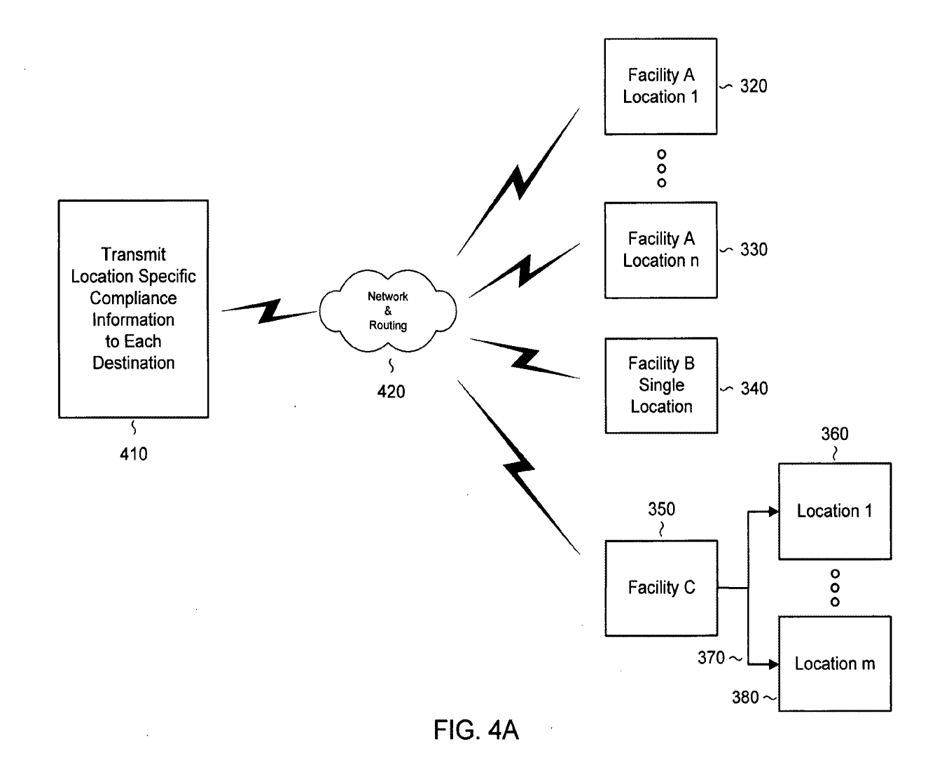

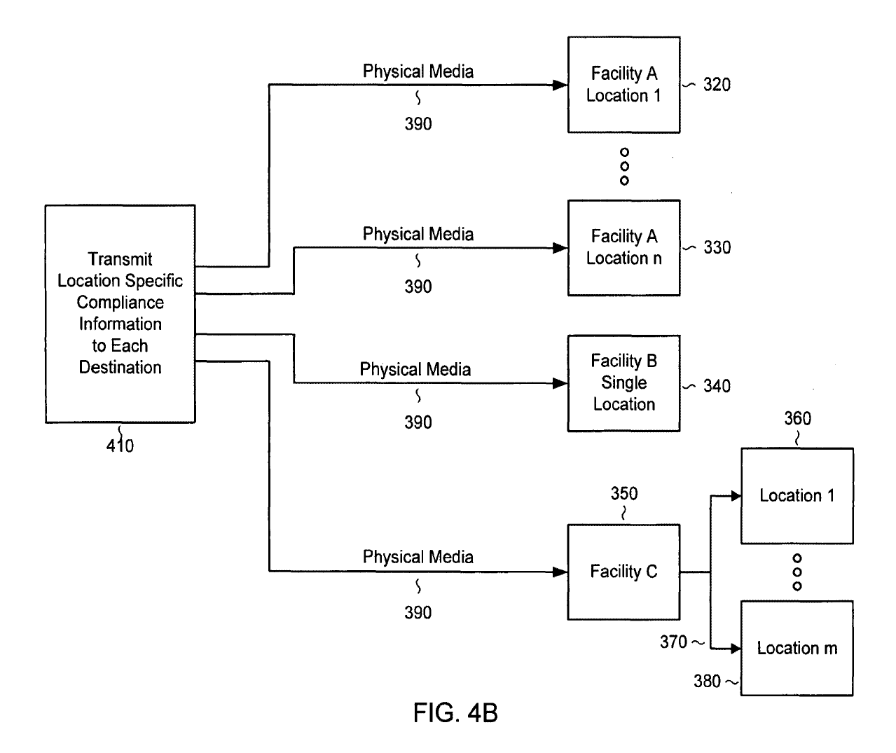

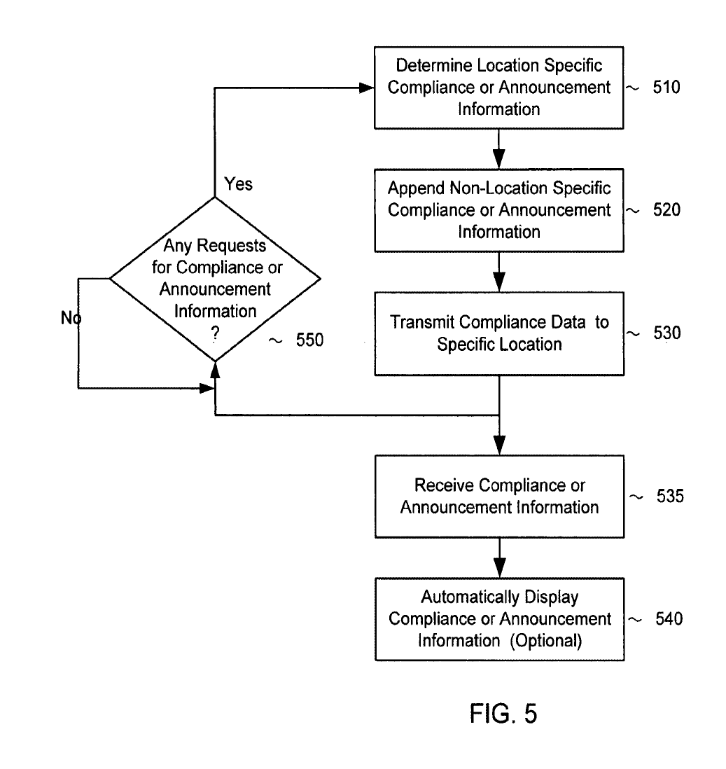

FIGS. 4A, 4B, and 5 shows system that may, for example, provide a compliance announcement, display, and notification system that allows electronic distribution of location specific compliance information, notifications, and other relevant company information to multiple locations, either within the same facility or amongst multiple diverse locations, thereby reducing the logistical burden for businesses;

FIG. 5 shows a system that may, for example, provide a compliance announcement, display, and notification system that allows electronic distribution of compliance information, notifications, and other relevant company information on a location by location basis as required by the user;

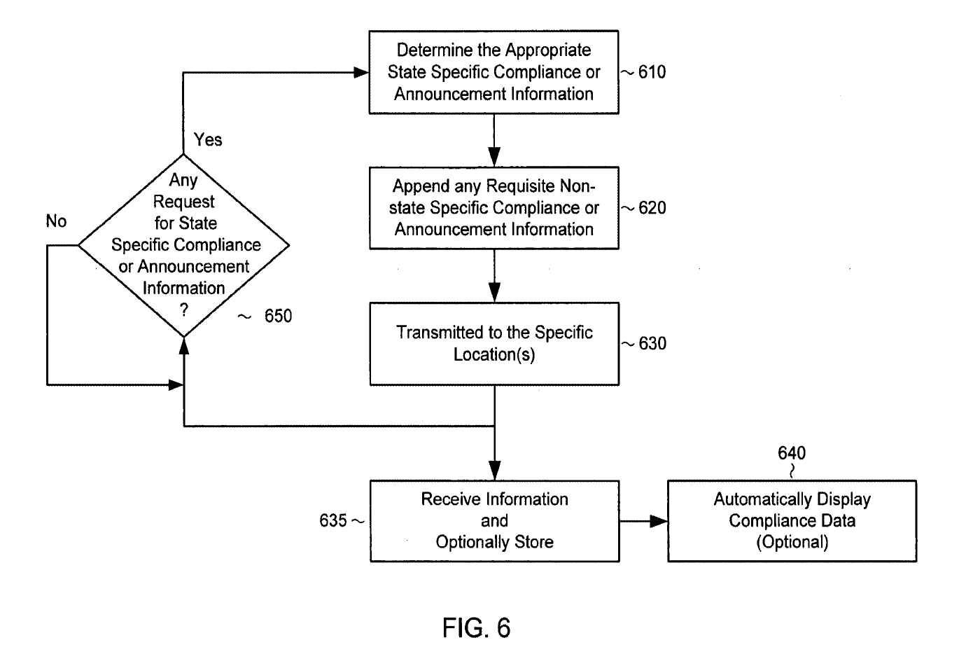

FIG. 6 shows a system that may, for example, provide a compliance announcement, display, and notification system that allows electronic distribution of compliance information, notifications, and other relevant company information on a state by state basis as required by the user, thereby eliminating the need to contact various agencies within one or more states;

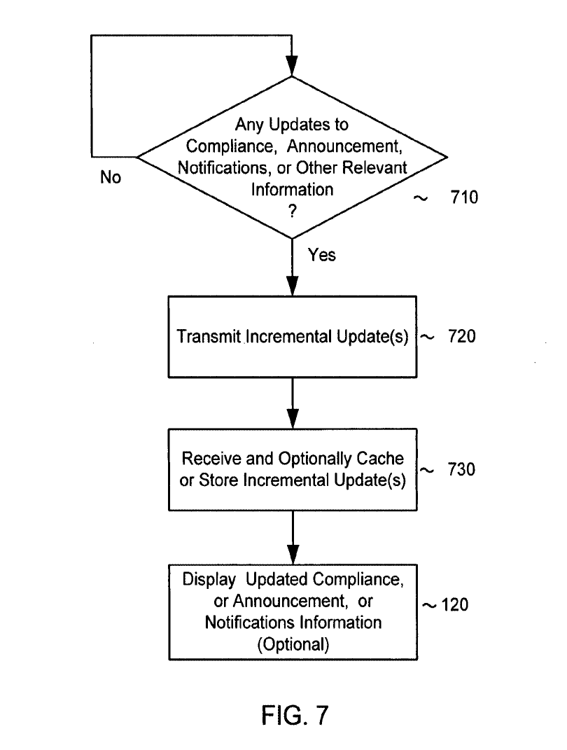

FIG. 7 shows a system that may, for example, provide a compliance announcement, display, and notification system that allows electronic distribution of incremental updates to compliance information, notifications, and other relevant company information, thereby eliminating the need and costs associated with a physical poster purchase, shipping, receiving, posting, and verification of posting;

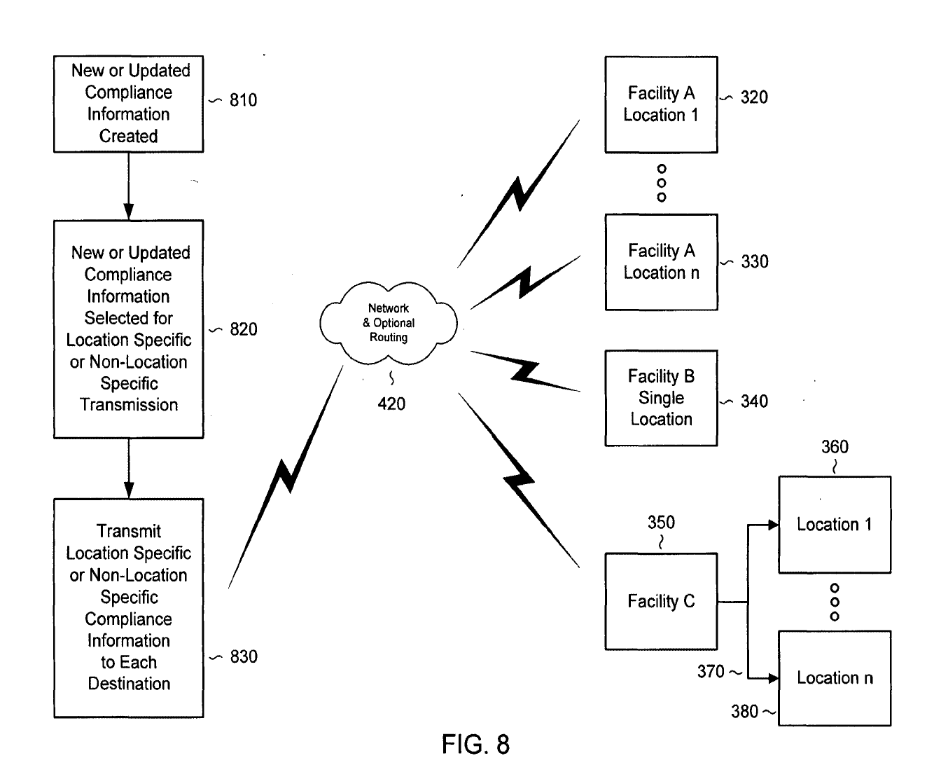

FIG. 8 shows a system that may, for example, provide a compliance announcement, display, and notification system that allows electronic distribution of compliance information, notifications, and other relevant company information, facilitating frequent updates and allowing for shorter cycle times from information creation to display within various companies or other users;

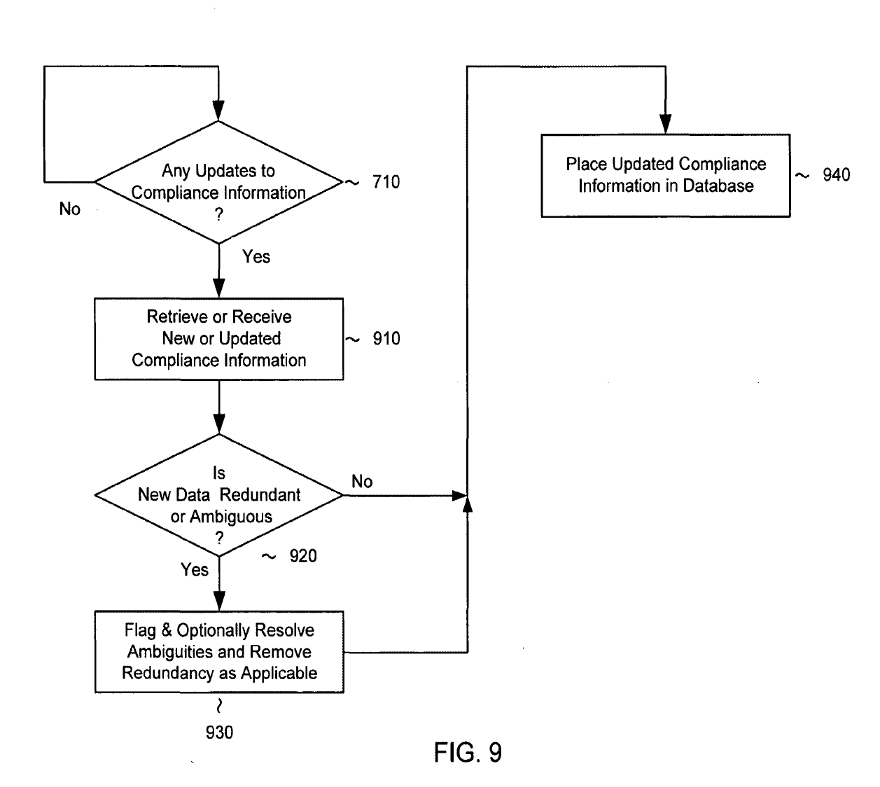

FIG. 9 shows a system that may, for example, provide a compliance announcement, display, and notification system that allows electronic distribution of compliance information, notifications, and other relevant company information, from a known database of valid, unambiguous compliance, notification, and company information, thereby eliminating possible user confusion and ambiguities;

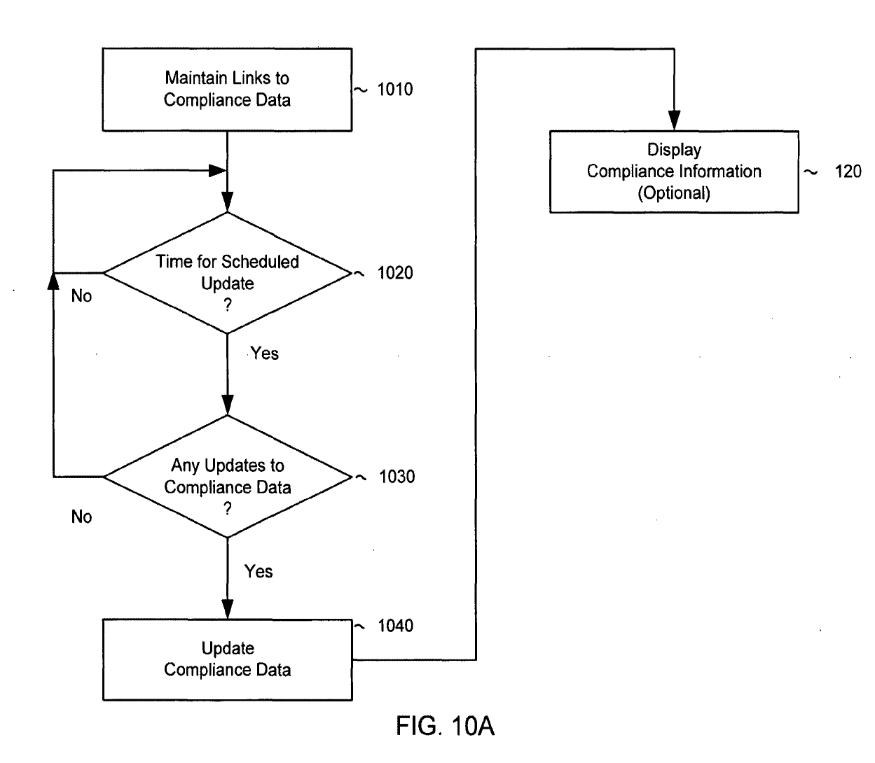

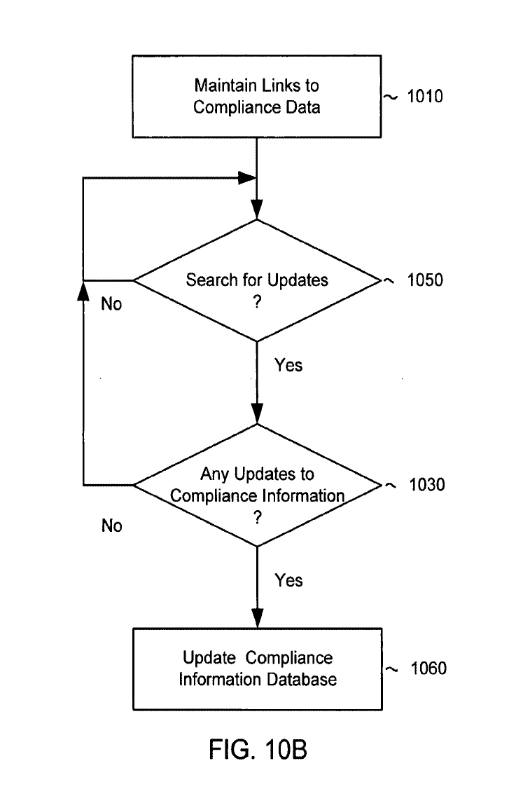

FIGS. 10A and 10B shows systems that may, for example, provide a compliance announcement, display, and notification system that maintains links to one or more sources of compliance data, and on a predetermined time schedule such as a recurring periodic cycle, or by request. The links may come from a known list or via scanning the internet or any other repository of information with an automated search tool or any other method to locate one or more relevant links for sources of compliance or announcement information, and then creating a list of links to some or all of the sources of relevant compliance or announcement information. The links may be utilized to automatically scan for updated compliance data or other information of interest and meta data associated with the information such as, for example, the effective date of the new compliance information, date and or time of receipt, date and or of creation, source of data, known ambiguities or conflicts and what data is replaced or superseded, etc., thereby ensuring that up to date compliance data is available on a timely basis. In addition to automatic scanning, the scanning can also be done upon request, on a predetermined timetable, on a recurring periodic cycle, or upon notification that additional or updated compliance or announcement data or meta data is available. Some or all of the compliance or announcement data may be downloaded. The compliance and announcement data may be, for example, stored on a local hard drive, stored remotely, or stored in a centralized or distributed respository(s), etc. Access to the data may be by any means including local area network, wide area network, Internet, utilizing both wireless and hardwired access. Optionally, a history of compliance and announcement information may be maintained. Data storage management techniques may also be applied including storing all of the downloaded compliance and announcement data, archiving data older than a specified date, archiving revisions older than current data or above some number of prior revisions, discarding revision older than current, discarding prior revisions above a specified number. In the case of incremental update, at least all data that applies to the current revision must be saved, either in a series of incremental updates or a master document with a lists of the original document and applied updates;

FIG. 11 shows a system that may, for example, provide a compliance announcement, display, and notification system that automatically notifies users when laws or other compliance information, notifications, or relevant company information changes, thereby ensuring that companies are aware of the latest compliance requirements and other information. The updated compliance or announcement data may come from one or more sources and notification to users may be via email (with or without attachments), instant messaging, a telephone call, voice mail messaging, file transfer protocol, etc., or any other means of electronic data transmission. Optionally, the data or notification may be displayed on one or more displays;

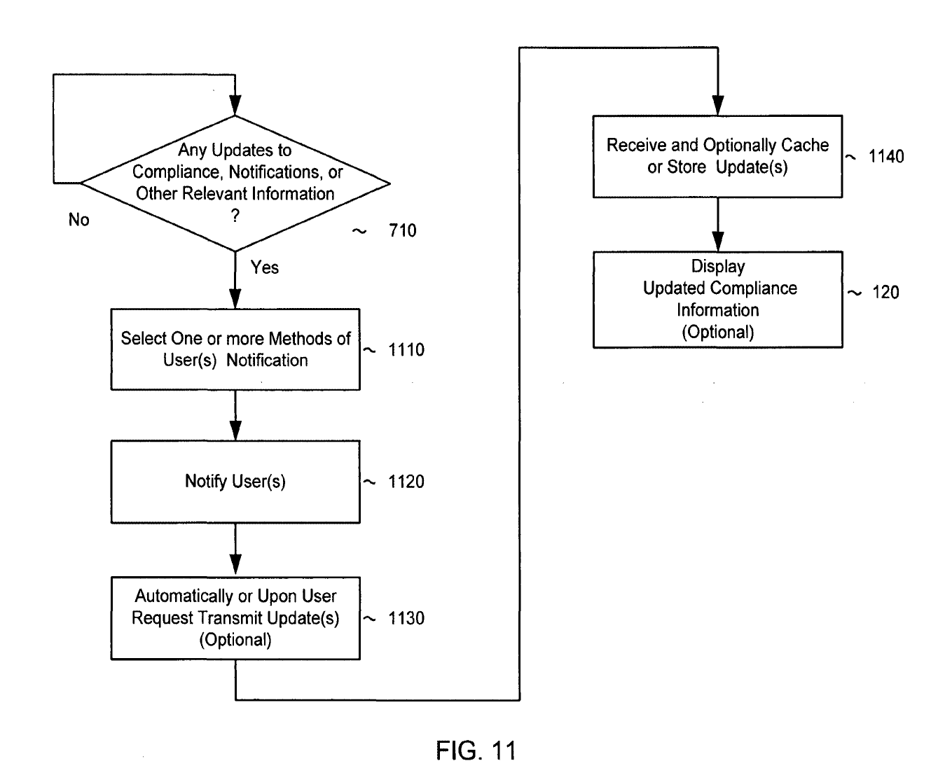

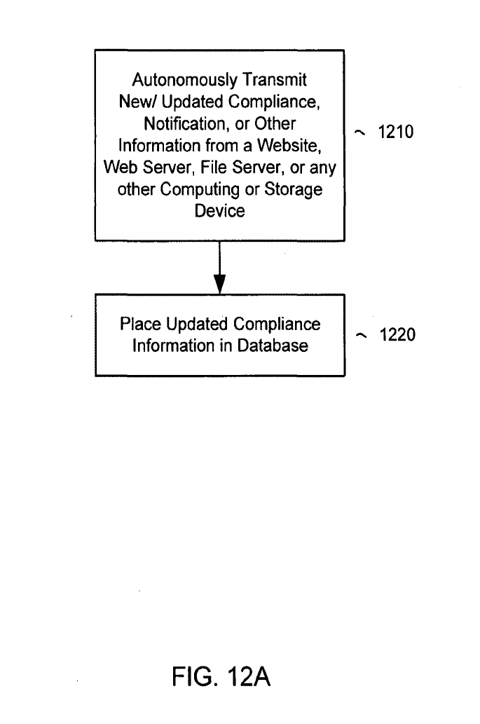

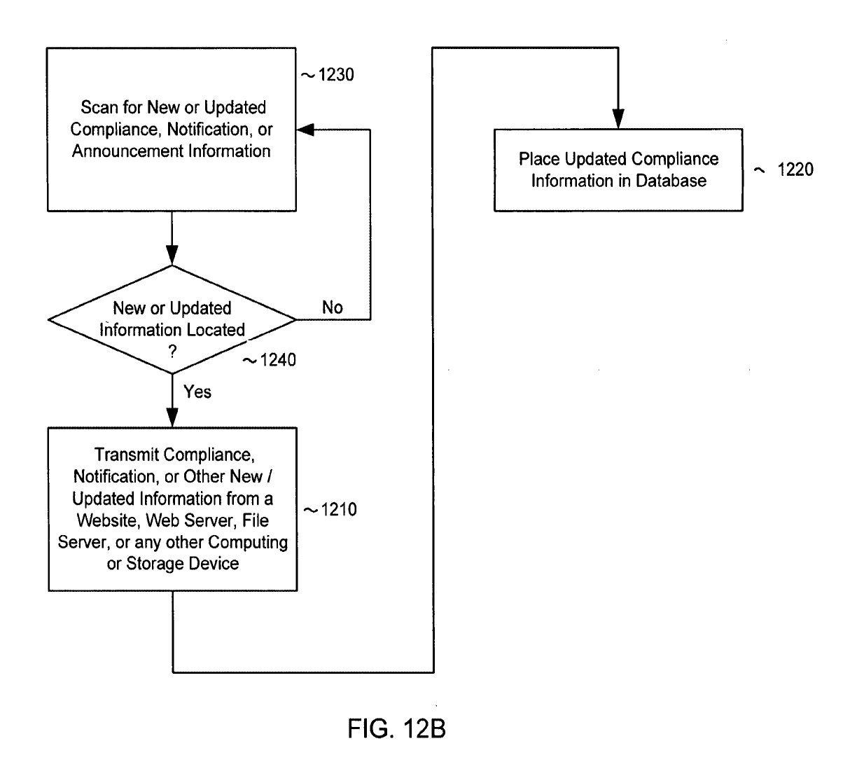

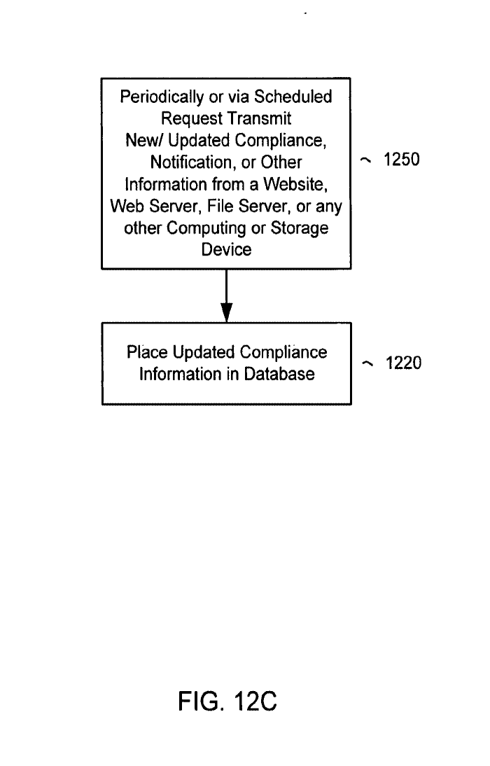

FIGS. 12A, 12B, and 12C shows systems to, for example, provide a compliance announcement, display, and notification system that may update a database or other repository of compliance or other information with additional or new information by receiving the information from a transmission from an external or internal website, a file server, or any other device. The data may be transmitted to the repository autonomously, by scheduled or periodic request, or any other mechanism including an autonomous scanning system (BOT) that continuously scans for updated compliance data or information and requests or delivers it when located, thus providing updated compliance information with a known update period;

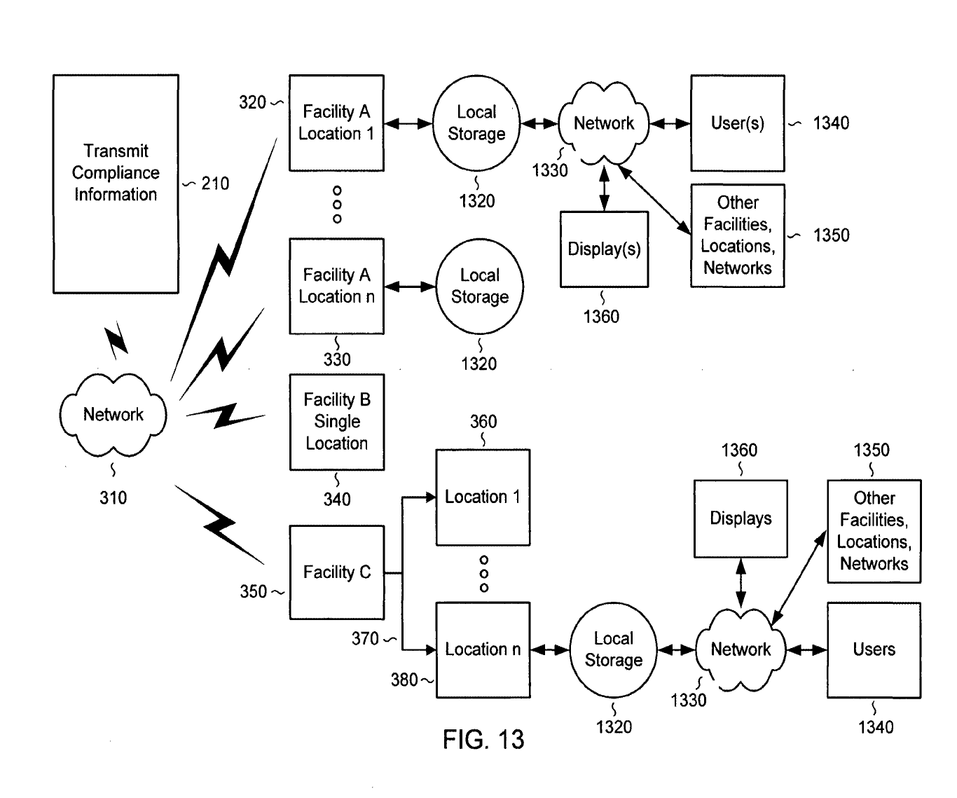

FIG. 13 shows a system to provide a compliance announcement, display and notification system that may transmit compliance data is stored locally on a requestor's internal data storage device and may be optionally accessible via a local area network, wide area network, or via any other transmission method, thus providing rapid access to compliance information;

FIG. 14 shows a system that may, for example, provide a compliance announcement, display, and notification system that allows electronic distribution of compliance information, notifications, and other relevant company information, in aggregated downloads or data transfers, thereby eliminating the need to go to multiple websites and other repositories of information and download information piecemeal;

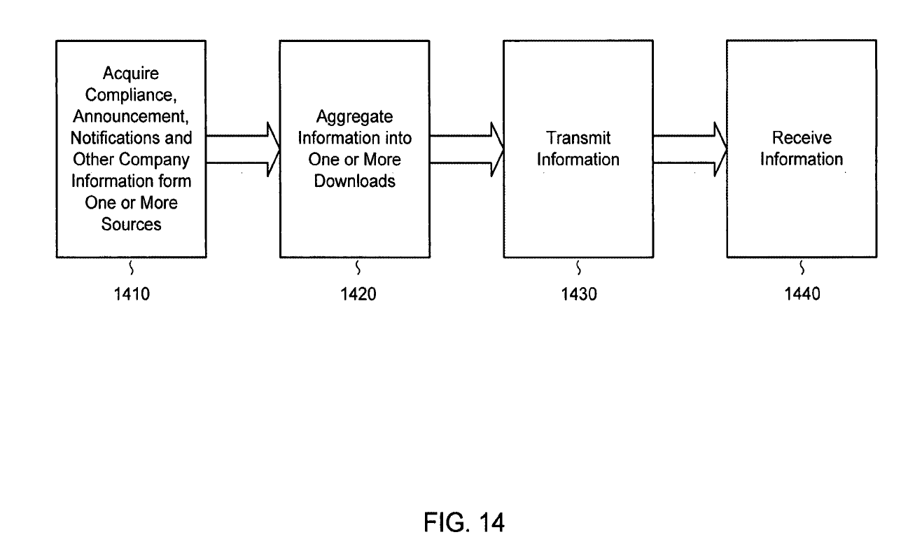

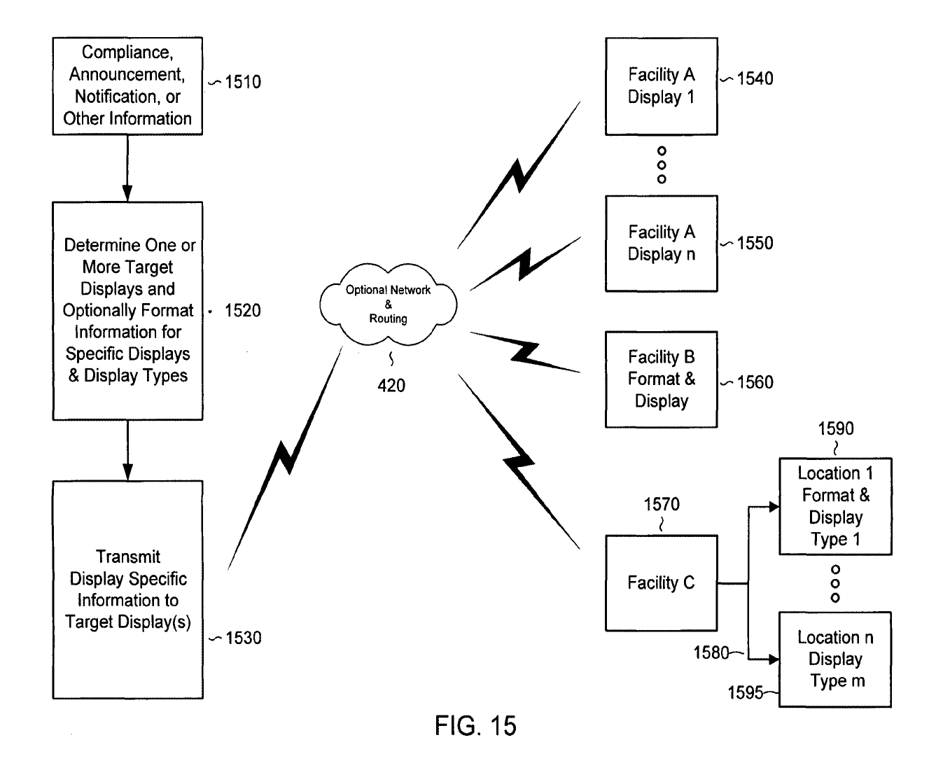

FIG. 15 shows a system that may, for example, provide a compliance announcement, display, and notification system that allows electronic distribution of compliance information, notifications, and other relevant company information that is formatted for specific displays, display types or display resolutions, may aggregate compliance data on multiple topics and/or from multiple sources for simultaneous display, and may utilize menus or other forms of user requests to display specific information, thereby providing a quick and easy means of viewing the information without the need for requestor formatting. The formatting may occur anywhere, including the end users facility. The formatting may be utilized to aggregate information for simultaneous or sequential display. In addition, formatting can utilize specific color palettes or any other visual or aural techniques for branding based upon supplied or known parameters.

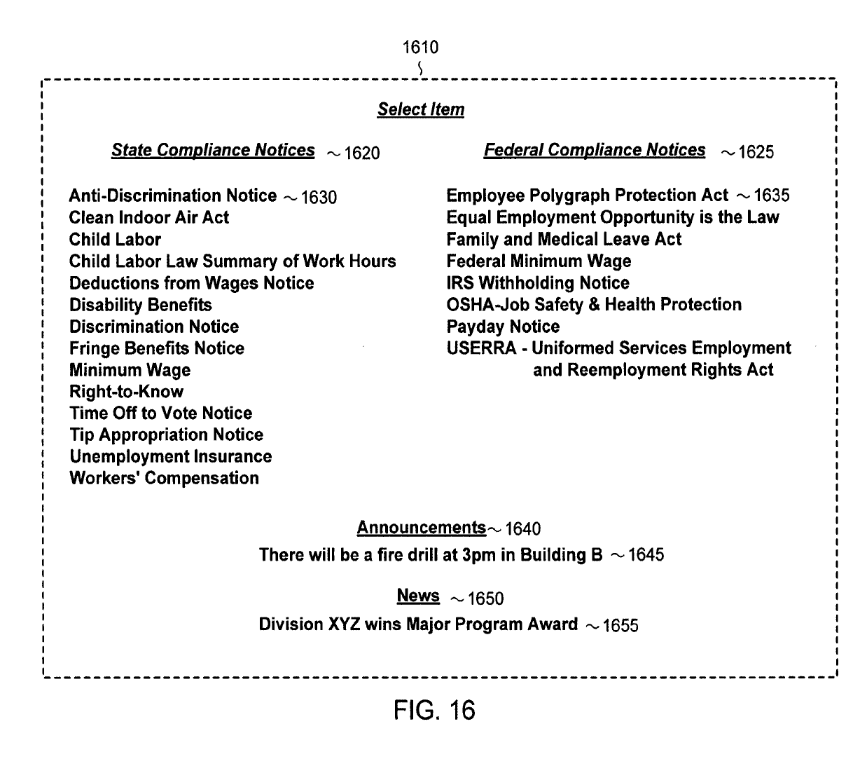

FIG. 16 shows a system that may, for example, provide a compliance announcement, display, and notification system where compliance data is displayed utilizing one or more menu systems. The menu may list compliance topics or subtopics and optionally a brief description of what the compliance subject matter covered by the topics or subtopics. The menus may be organized in a hierarchical fashion. The viewer may select one or more topics to read or review. Selection may be by any way, including an input device such as a touch screen, etc. The subject matter for each topic may be displayed in total, in part, or via additional menus. The selected data for display may be aggregated and reformatted if desired. If multiple menus are utilized the menus may be displayed concurrently, in succession, in random order, or according to a predefined sequence. Similarly the displayed information may be cycled through in whole or in part on a periodic basis. Advantageously, the usage pattern of menus, topics, or subtopics may be recorded for future use. In addition, the display of menus, specific topics, subtopics, or any other information may be learned by the system and displayed in an optimized fashion or sequence. The menu systems thus provide information display in a compact and efficient format;

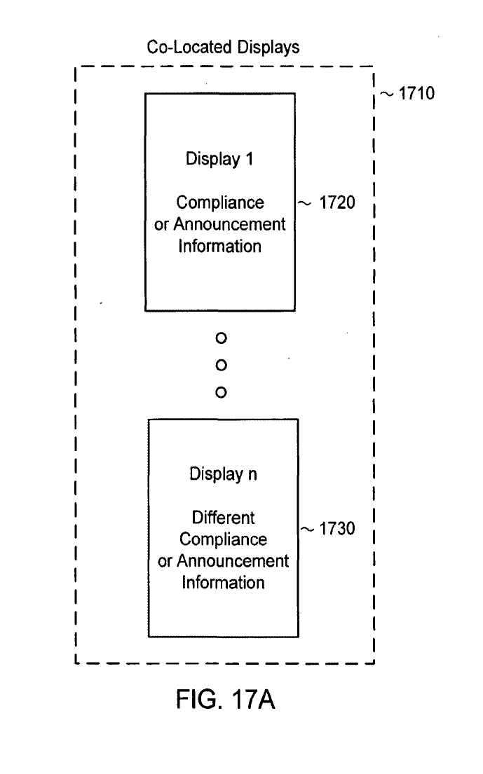

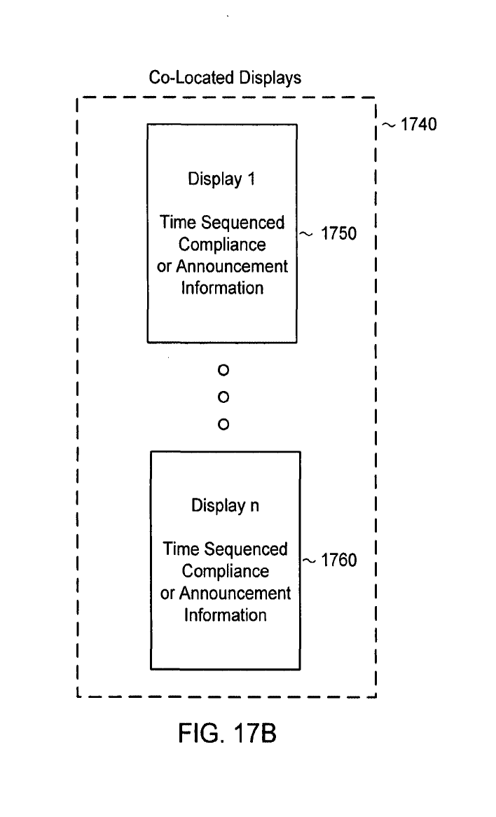

FIGS. 17A and 17B show systems that may, for example, periodically display compliance data or internal company generated information on multiple displays simultaneously, in sequence, or any combination thereof, providing a highly effective, easy to read display;

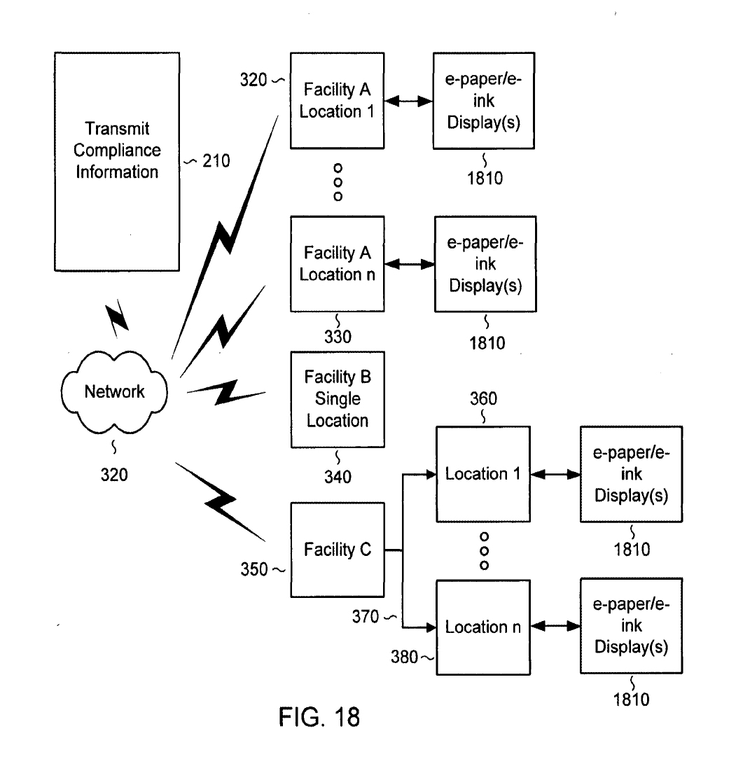

FIG. 18 shows a system to provide a compliance announcement, display, and notification system that provides electronic distribution of compliance information, notifications, and other relevant company information that utilizes emergent display technologies such as e-paper and e-ink or other non-volatile or semi-volatile display devices, thereby providing cost effective static or quasi static displays of the information;

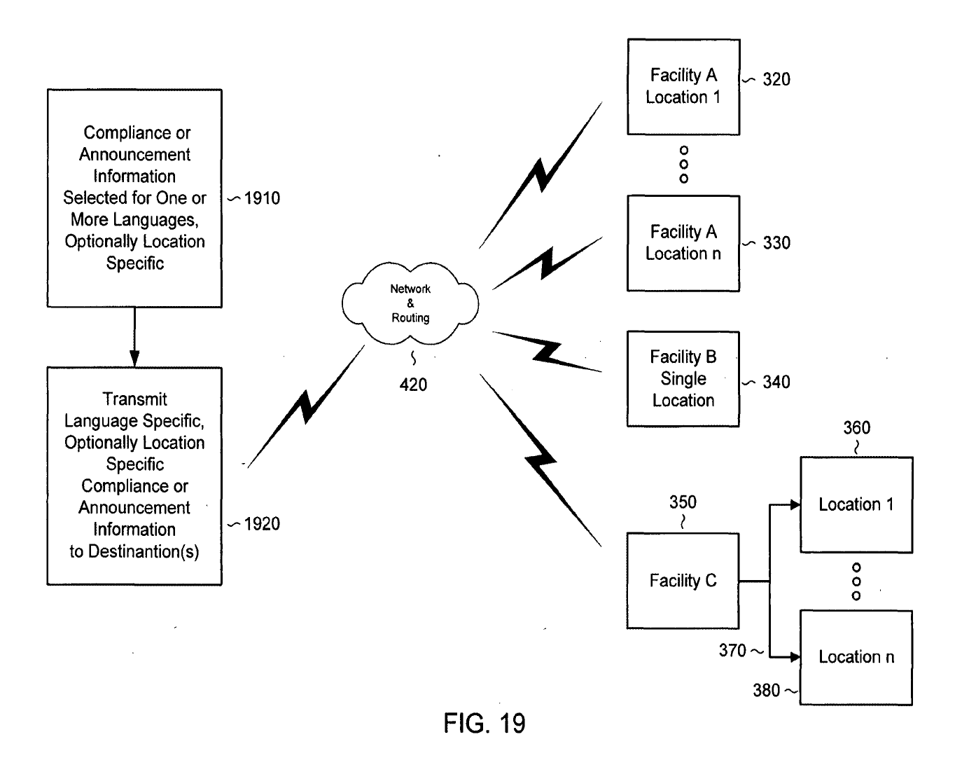

FIG. 19 shows a system that may, for example, provide a compliance announcement, display, and notification system that allows electronic distribution of information in one or more languages, that may optionally be location specific, including compliance information, notifications, and other relevant company information to multiple locations, either within the same facility or amongst multiple diverse locations, thereby reducing the logistical burden for businesses;

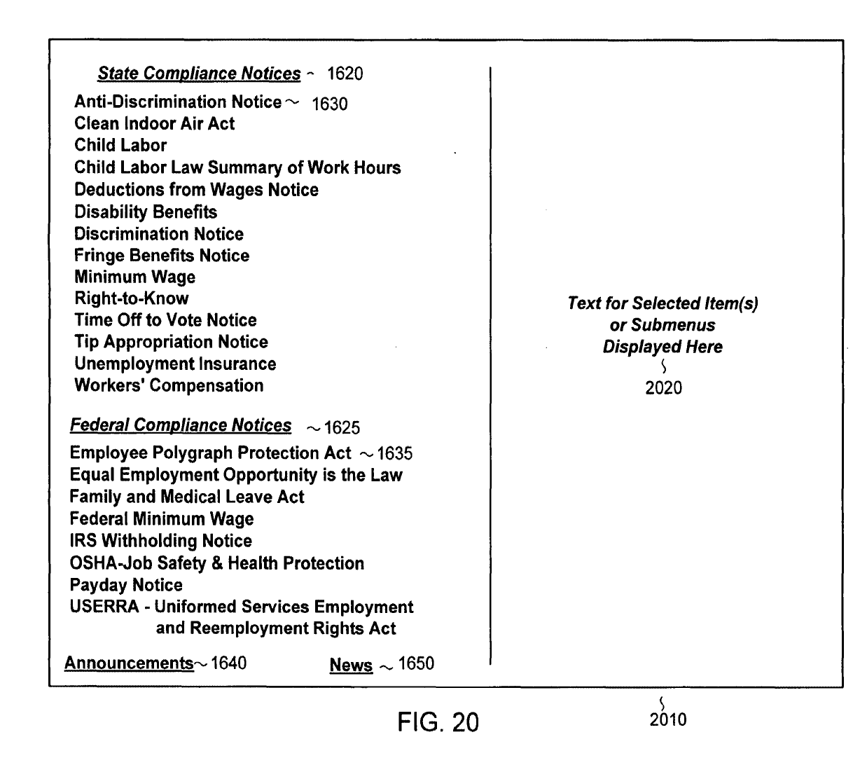

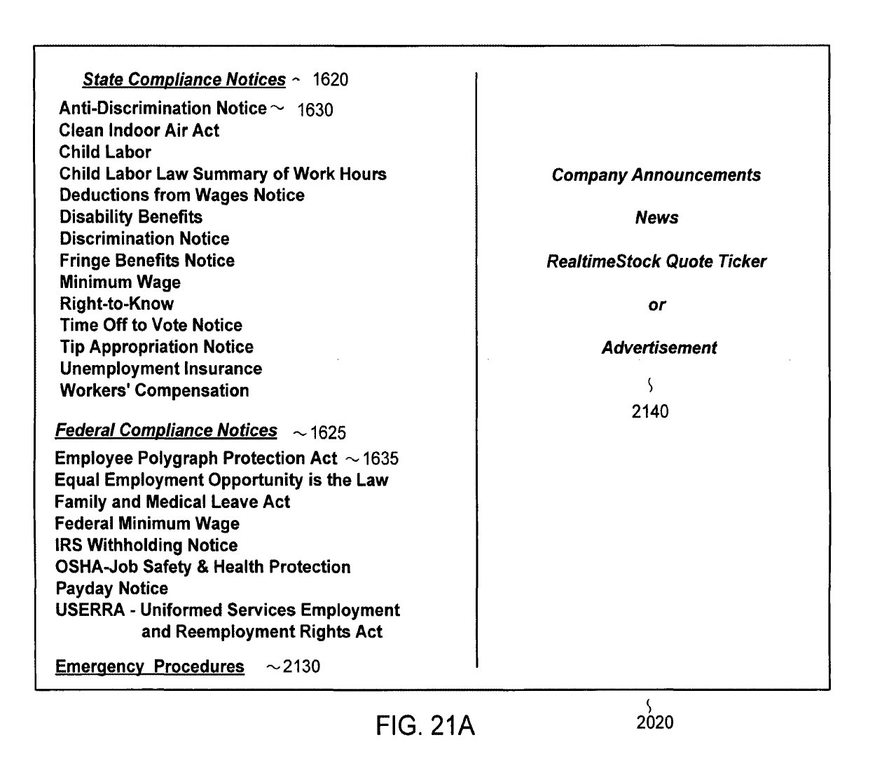

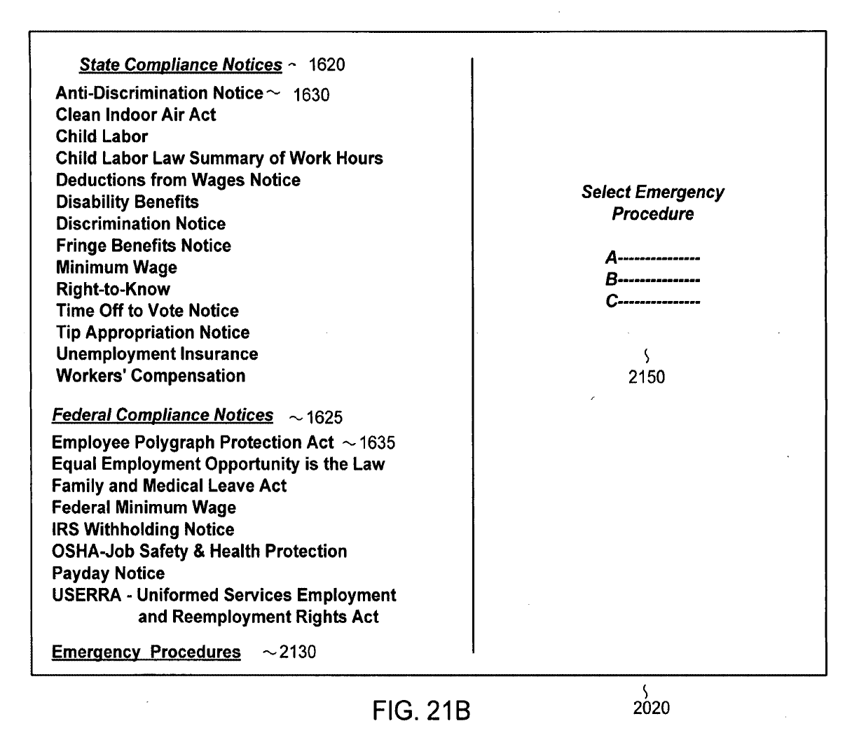

FIGS. 20, 21A, and 21B shows systems that may provide a compliance display and notification system that displays compliance information in a more compact display area via user interactive menus, cycling through various displays, or a combination thereof, thus saving wall space and enhancing readability while also reducing cost by allowing selection of various notifications and compliance information within the same display area;

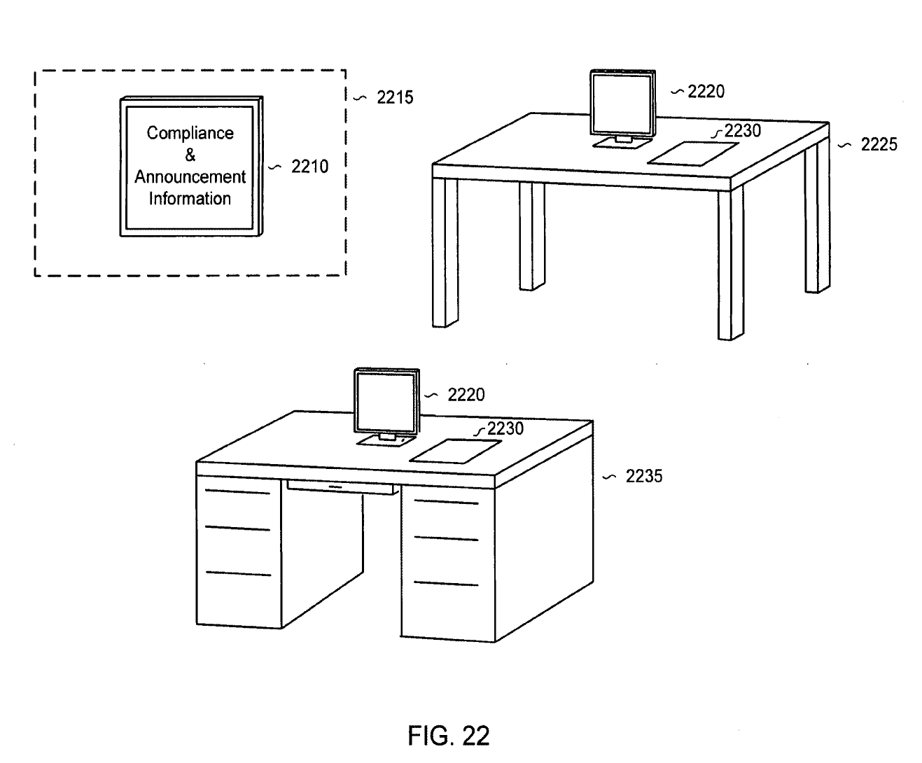

FIG. 22 shows a system that may, for example, provide a compliance announcement, display and notification system that utilizes one or more compact displays that can be mounted or positioned in more convenient locations such as desktops, tables, or wall locations, thereby enhancing readability and reducing reader fatigue;

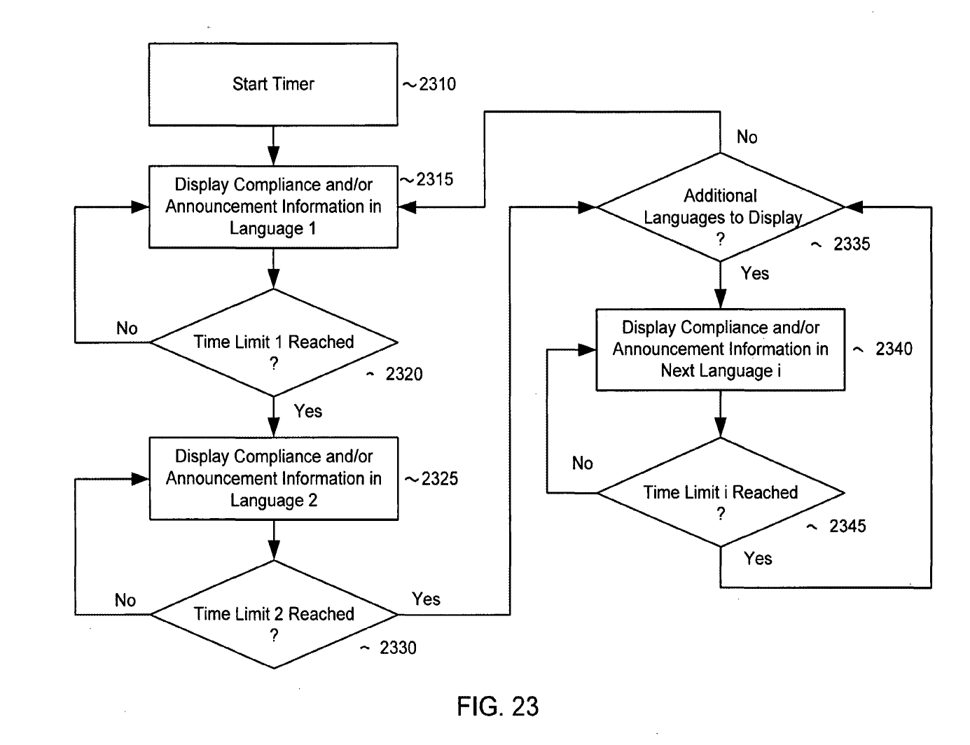

FIG. 23 (e.g., automatic), 24A (e.g., by request), and 25 (e.g., external trigger) shows systems that may, for example, provide a compliance announcement, display and notification system that allows selection of various notifications and compliance information in multiple languages, or dialects either automatically, by user request, or by sensing external information such as a badge or identification card, language recognition, visual recognition, Biometric Recognition, DNA, etc., and may display the compliance information in one or more languages within some or all of the same display area, thereby saving space and enhancing the readability of the information for the user by displaying the information in a more familiar language. The information may alternately be displayed in a new display area.

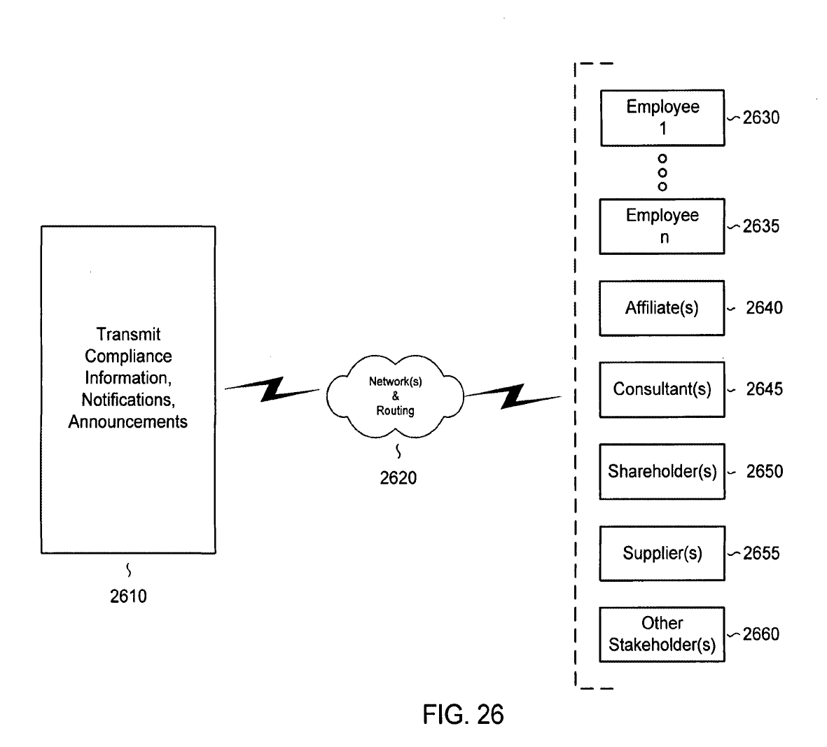

FIG. 26 shows a system that may, for example, provide a compliance announcement, display and notification system that allows electronic distribution of compliance information, notifications, and other relevant company information to employees, affiliates, consultants, shareholders, suppliers, and any other stakeholders that is required for distribution to the above recipients with or without the requirement for posting, thereby easing logistical requirements;

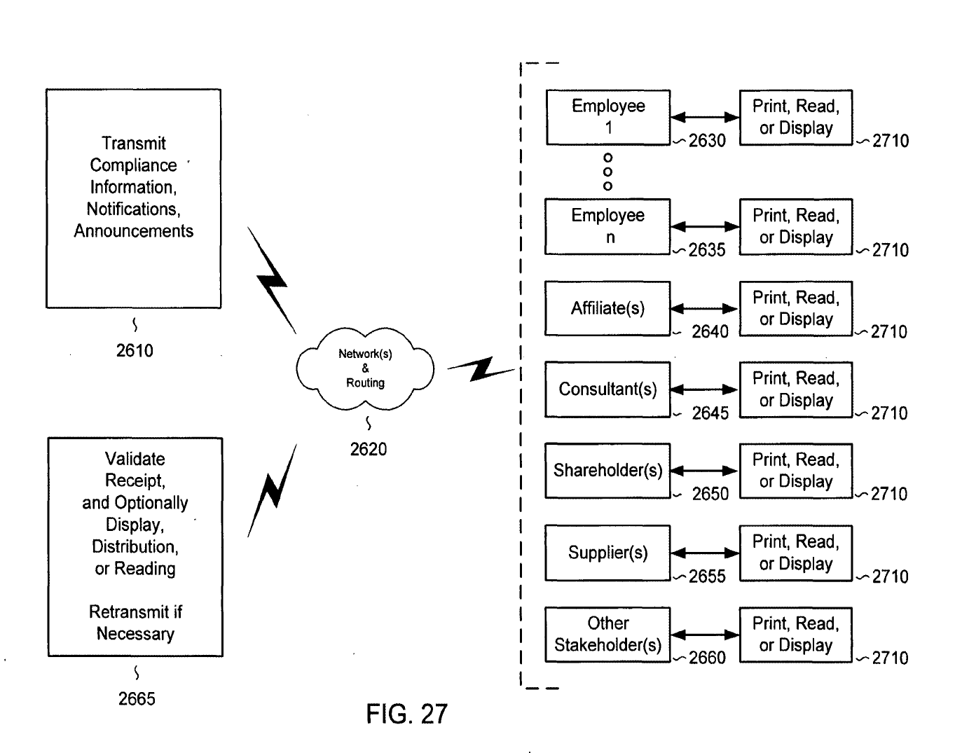

FIG. 27 shows a system that may, for example, provide a compliance announcement, display, and notification system that allows electronic distribution of compliance information, notifications, and other relevant company information to employees, affiliates, consultants, shareholders, suppliers, and any other stakeholders and validates receipt by the appropriate party and timely posting or distribution of the information, thereby eliminating the typical problems associated with sending hardcopy posters to organizations that may experience employee turnover, administrative, organizational, or legal changes within an organization, mergers, acquisitions, and divestitures, changes of address (both physical and electronic mail); the information receipt and or display may be verified on a time sensitive basis;

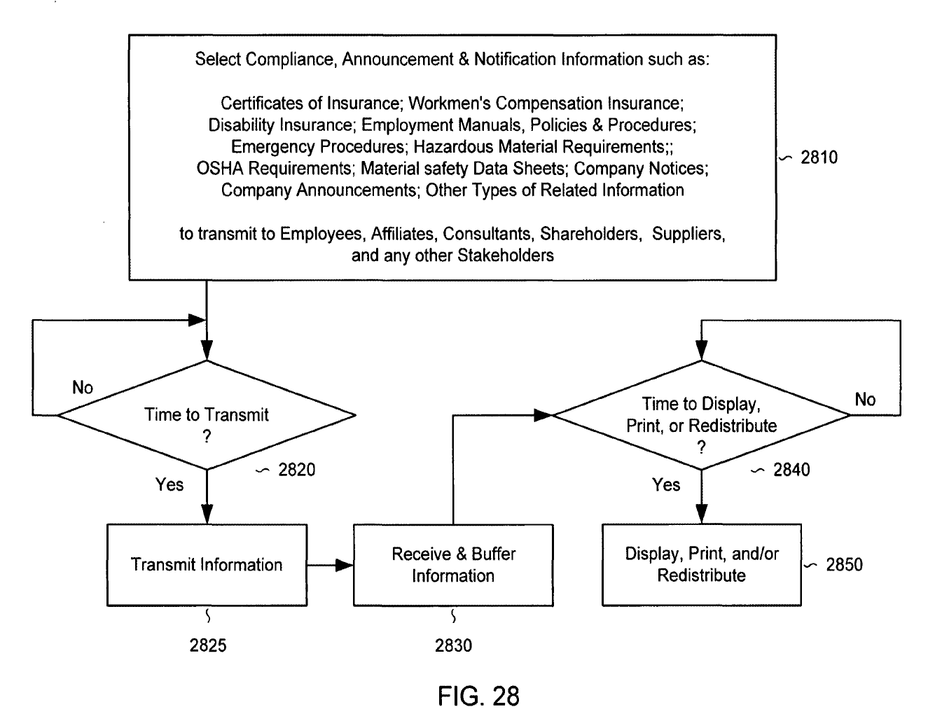

FIG. 28 shows a system that may, for example, provide a compliance announcement, display, and notification system that provides electronic distribution of compliance information, notifications, and other relevant company information including: Certificates of Insurance, Workmen's Compensation Insurance, Disability Insurance, and also provide on-demand access to information such as Company Employment Manuals, Company Policy and Procedures, Emergency Procedures, Hazardous Material Requirements, OSHA Requirements, and Materials Safety Data Sheets to employees, affiliates, consultants, shareholders, suppliers, and any other stakeholders in advance of the actual effective date and time and then displays, prints, or sends the information at a prescribed date and time, thereby ensuring time receipt and display, printing, or retransmitting of the information;

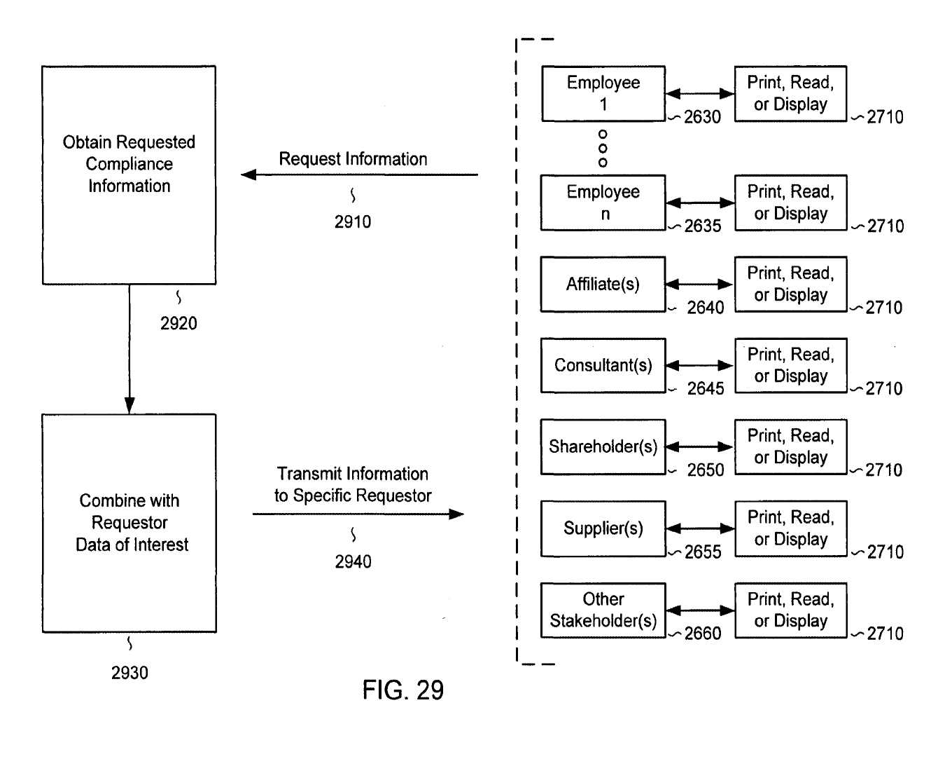

FIG. 29 shows a system that may, for example, provide a compliance announcement, display and notification system that combines compliance data with requestor data of interest and optionally then displays the combined information. The company data may include internal company notices that also have specific posing and notification requirements such as Insurance Companies Workmen's Comprehensive & Disability Insurance Notices, Company Employment Manuals, Company Policies & Procedures, Emergency Procedures, Hazardous Materials Requirements, OSHA Requirements, and Materials Safety Data Sheets;

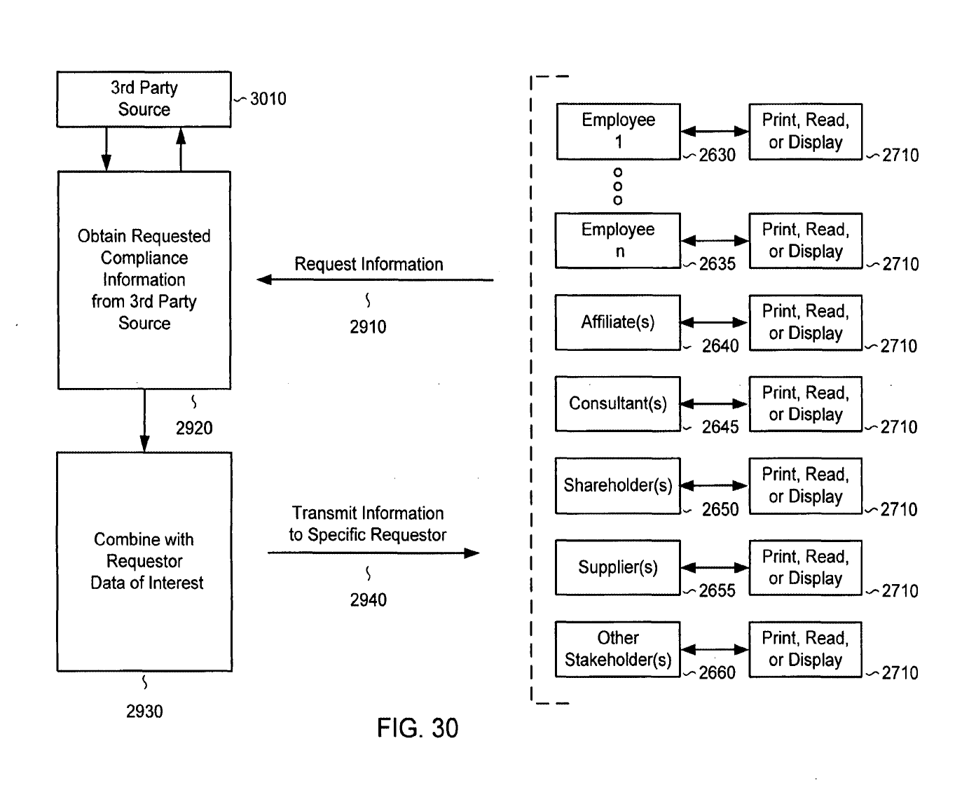

FIG. 30 shows a system that may, for example, provide a compliance announcement, display and notification system that automatically requests and obtains compliance data or other information that is from a third party source and displayed alone or in combination with other compliance data or information, easing the logistical burden on a company or other entity. If the requested data is not received, it may be re-requested. Some or all of the requests may be logged. Received information may be optionally printed or displayed;

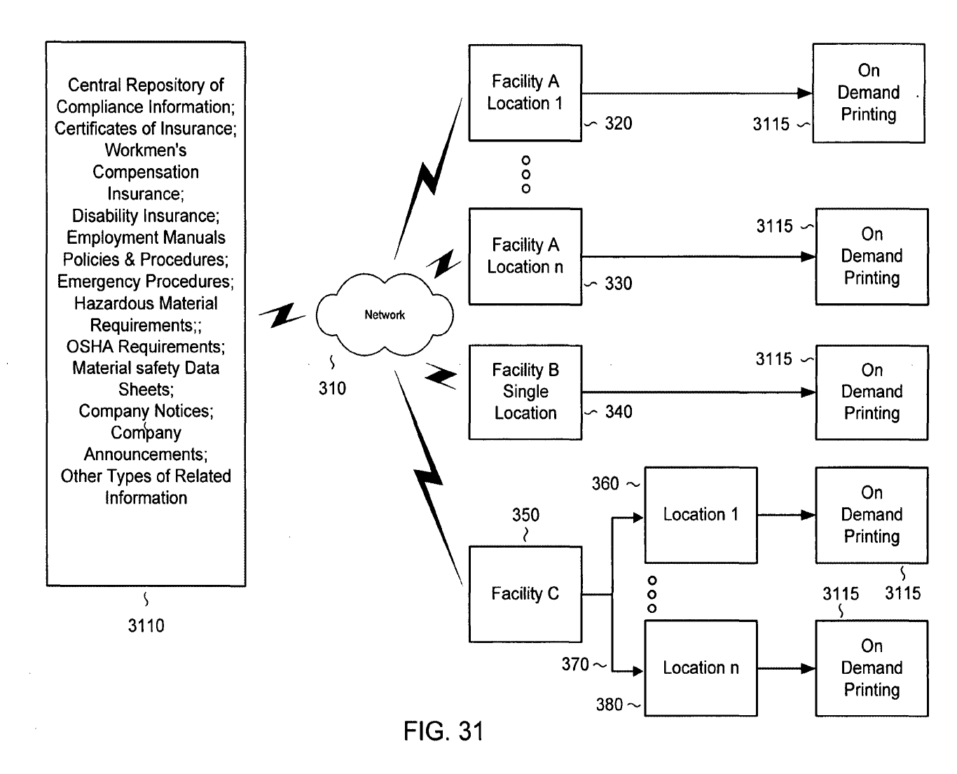

FIG. 31 shows a system that may, for example, provide a compliance announcement, display and notification system that provides electronic distribution and on-demand printing by user request of compliance information, notifications, and other relevant company information including Certificates of Insurance, Workmen's Compensation Insurance, Disability Insurance, and also provides on-demand access to information such as Company Employment Manuals, Company Policy and Procedures, Emergency Procedures, Hazardous Material Requirements, OSHA Requirements, and Materials Safety Data Sheets, providing easy access to the information. Items may be selected to print and also display;

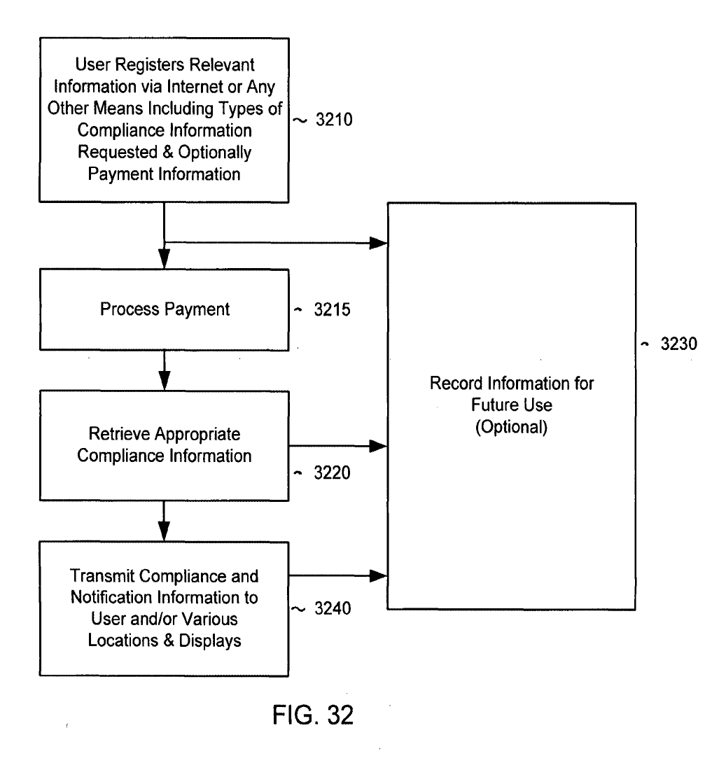

FIG. 32 shows a system that may, for example, provide a compliance announcement, display and notification system that allows requestor wishing compliance data to register relevant user information over the Internet or any other means. The user may specify which types of compliance data are required, for example, Federal, State, and Regulatory compliance information. The compliance data may be transmitted to the requestor and automatically displayed on one or more display devices, thereby providing a paperless end to end compliance display system;

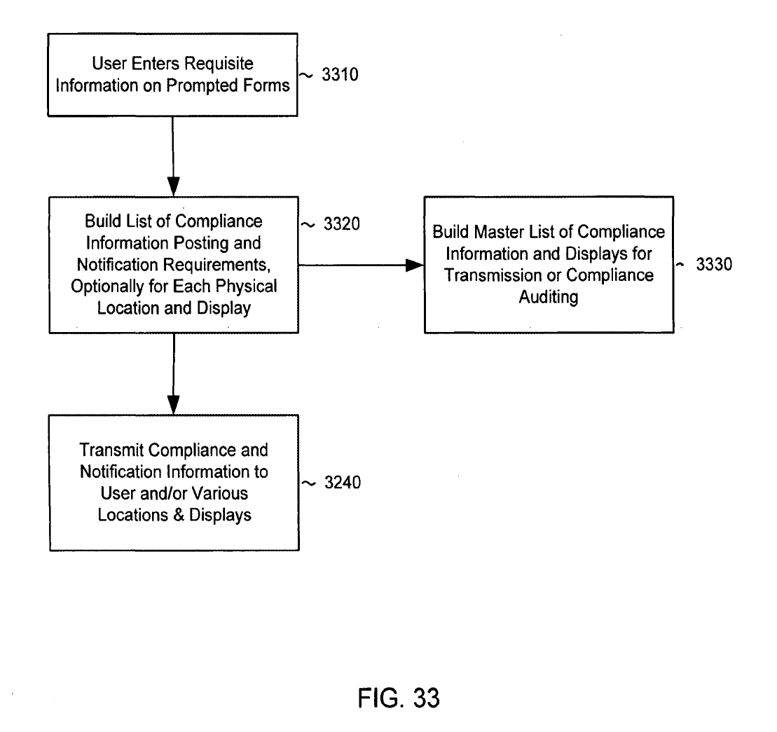

FIG. 33 shows a system that may, for example, provide a compliance announcement, display, and notification system that prompts the requestor to fill out one or more forms that determine the compliance posting and notification requirements for a specific business establishment. Representative information may include the nature and location or locations of the business, number of posting sites along with their physical and electronic locations, the types of displays utilized at each location, the number of employees at each location and in total, the languages spoken by employees at each physical location or display location, the annual dollar volume of the business at each location or in total, whether the requestor has Federal contracts or subcontracts, etc. The answers may be utilized to build a list of compliance data posting and notification requirements for each physical location and/or display. In addition, a master list may be compiled with all compliance and notification requirements for a given requestor. The individual lists may be utilized to aggregate the compliance and notification information for each display;

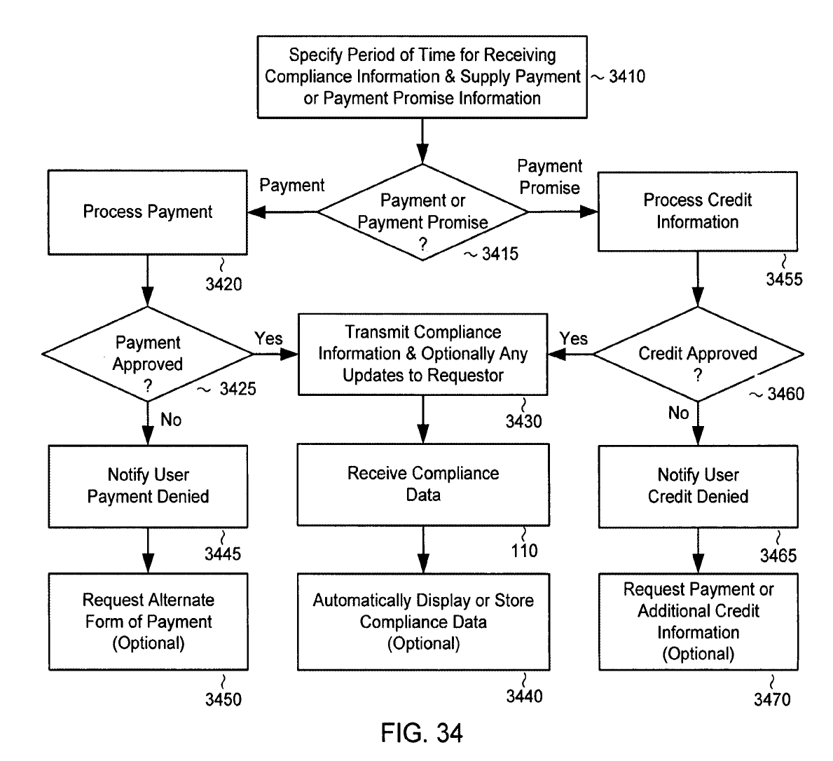

FIG. 34 shows a system that may, for example, provide a compliance announcement, display and notification system that allows the requestor to select a fixed period of time to receive compliance data and compliance data updates and to pay for the service online, or may be billed if appropriate credit information is received and approved by the compliance data service provider, thereby providing a flexible and convenient means for selecting service period and payment option;

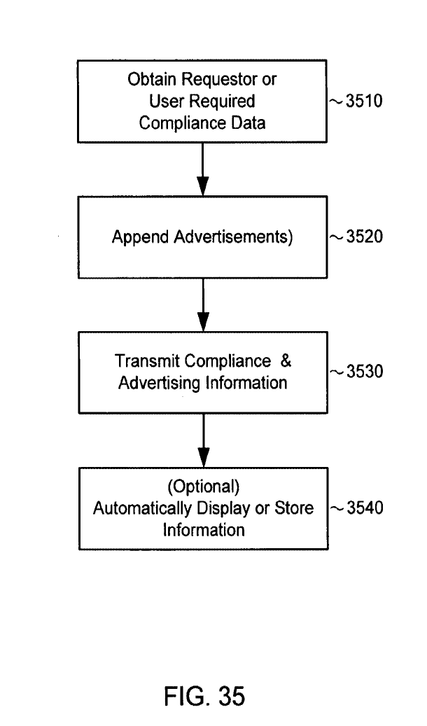

FIG. 35 shows a system that may, for example, provide a compliance announcement, display and notification system that provides compliance data to the requestor for free. The compliance data may be appended to information from one or more advertisers which is then displayed concurrently with the compliance data. The advertising may be based on one or more of the following factors: a fixed or variable fee, a per user basis, per display basis, per industry basis, flat fee, by display size, promotional from the compliance data service provider, etc;

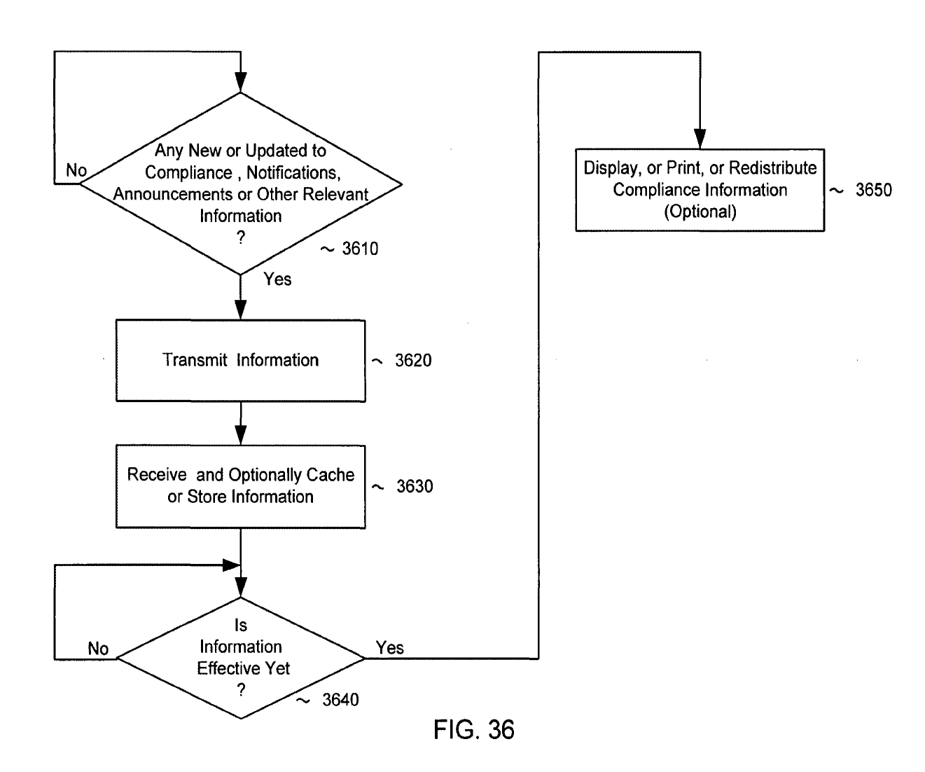

FIG. 36 shows a system that may, for example, provide a compliance announcement, display and notification system that transmits new or updated compliance or announcement data in advance of the compliance data becoming effective. The updated compliance or announcement data may be cached or otherwise stored in memory until the compliance data becomes effective, and is then optionally displayed. The updated data may replace existing data being displayed, may be appended to existing data, already being displayed, or may replace other data being displayed, thereby affording display of the information on or before the effective date as desired. The data may also be displayed in advance of or on the effective date and optionally time. Alternately the data may be displayed in advance of its effective data simultaneously or in sequence with the currently effective data, or the currently effective data may be displayed simultaneously or in sequence with the upcoming incremental changes, or vice versa;

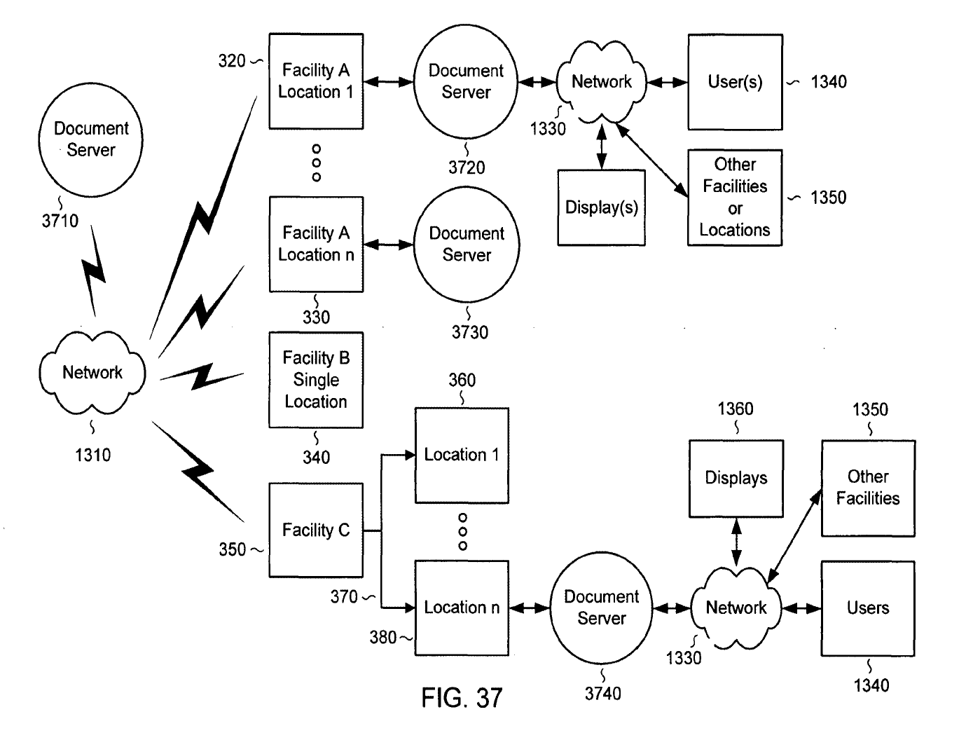

FIG. 37 shows a system that may, for example, provide a compliance announcement, display and notification system that stores compliance data on one or more Document Servers. The Document Servers may be manually or automatically updated. In addition the Document Servers may hold multiple revisions of the same compliance data with past, present, or future effective dates and any other information that may be desired by some or all of the various requestors. In addition this data, including the compliance data, may reside in multiple proprietary, industry standard, document, database, or display formats for a variety of requestors and display devices. The Document Servers may keep all revisions of a document, revisions received after a specific date, only the currently effective documents, a specified number of revisions, or any other retention criteria. The retention policy may vary by document type or area of affectivity (for example labor law), or by regulatory agency. The Document Server may store complete documents or documents and incremental updates;

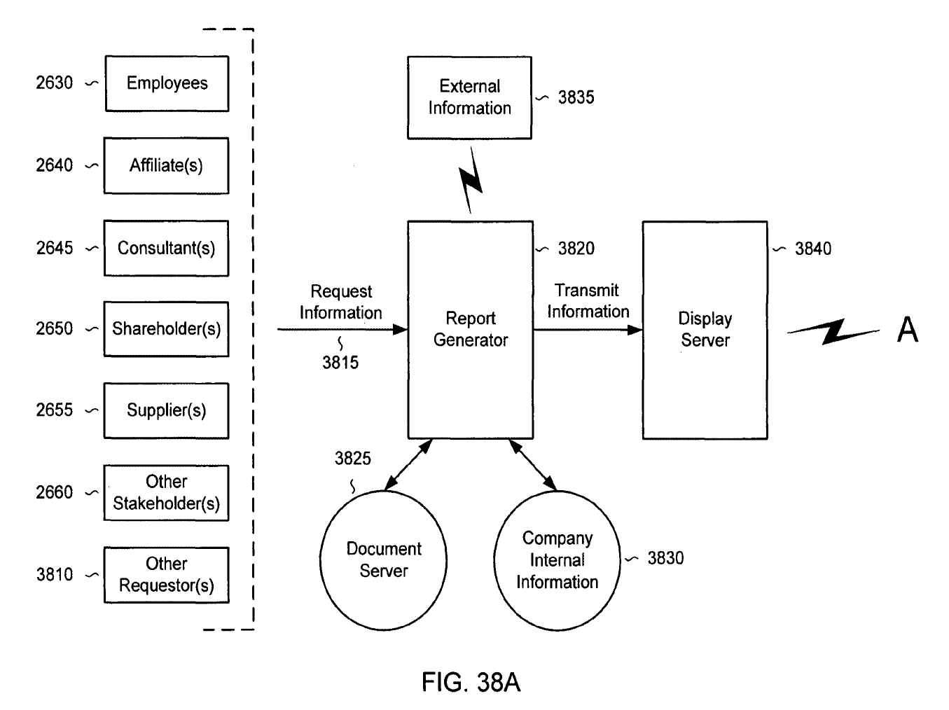

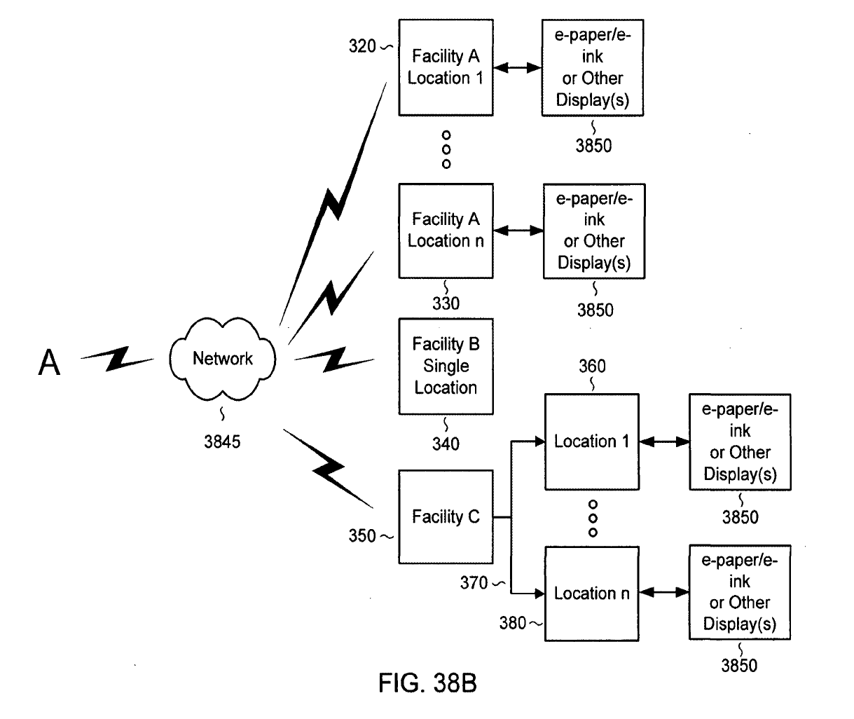

FIGS. 38A and 38B show systems that may, for example, provide a compliance announcement, display and notification system that generates compliance data specific to a given requestor. Each requestor may request multiple different reports comprising various mixtures of compliance data, internal company information, information external to the company, and any other desired information by the requestor. A Report Generator may be utilized to gather requisite information from a Document Server, Company Internal Information Systems or storage, and External Sources of Information such as, but not limited to, the Internet. The Display Server may be utilized to transmit the report data to one or more physical or electronic locations. The transmitted data may be sent by any technique including physical media or electronic connections including Ethernet, Wifi, any type of modem including cable modem, Local Area Network, Wide Area Network, Cellular, two way radio pager, one way radio pager, satellite transmission, or any combination thereof. It is anticipated that new technologies will become available and will be advantageously employed by the present invention. The report information may be displayed on any form of display including liquid crystal displays, plasma displays, projection displays, LED displays, OLED displays, e-paper, and electronic ink displays;

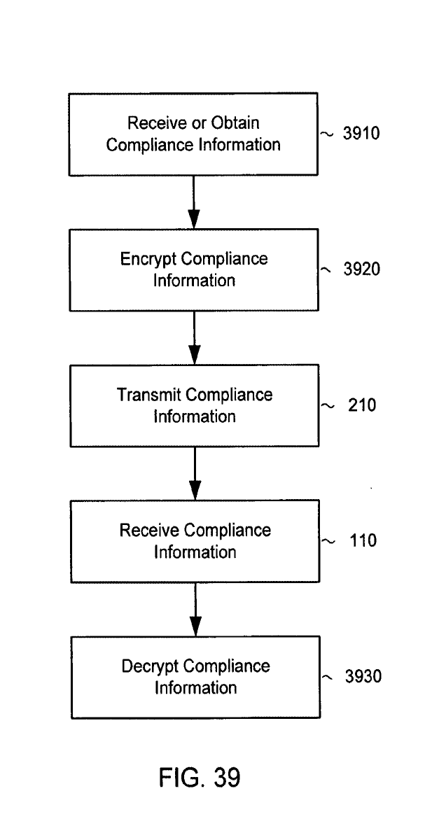

FIG. 39 shows a system that may, for example, provide a compliance announcement, display and notification system that transmits some or all of the compliance information, along with any other information, in an encrypted format to provide data security; optionally, the encrypted data may be transmitted, received, decrypted and/or displayed. The decryption may be performed on a request basis by authorized transmitter, receiver, or end user.

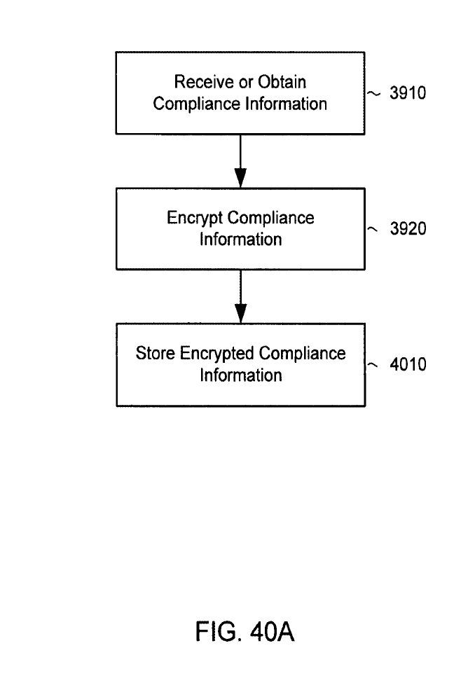

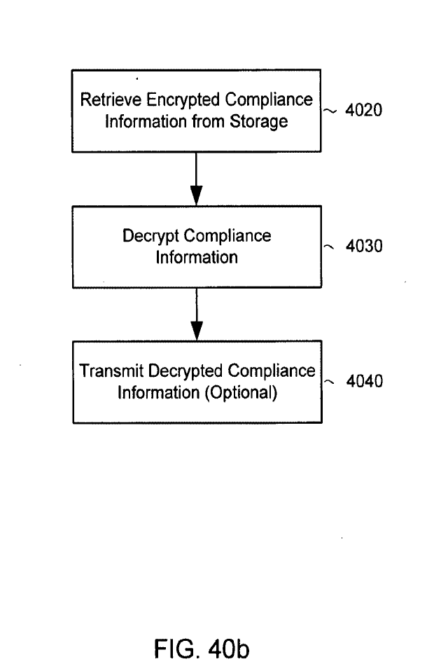

FIGS. 40A and 40B shows a system that may, for example, provide a compliance announcement, display and notification system that stores some or all of the compliance information and any other information in an encrypted format to provide data security;

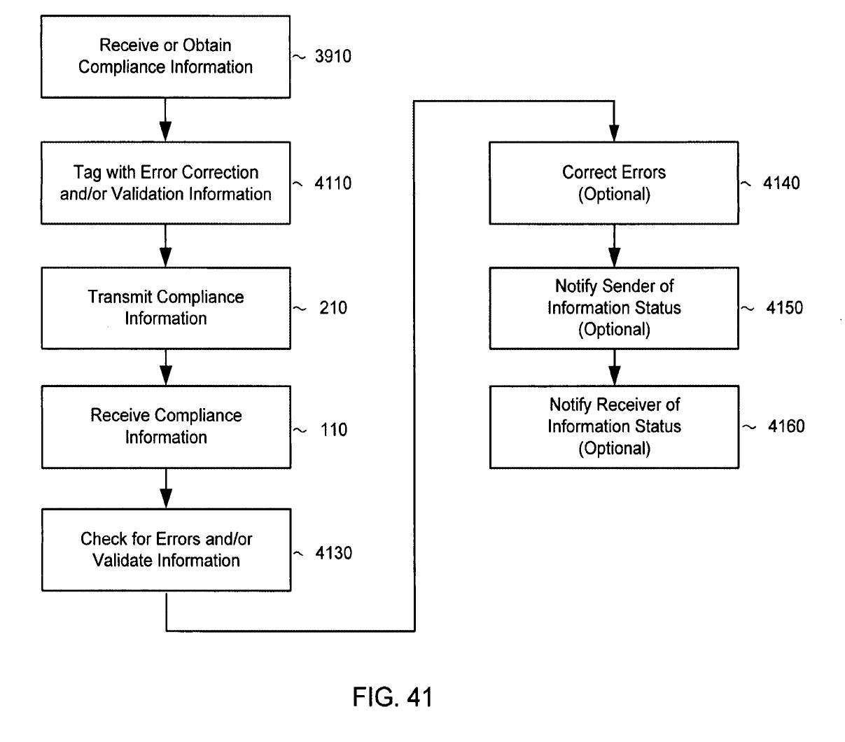

FIG. 41 shows a system that may, for example, provide a compliance announcement, display and notification system that tags some or all of the compliance data and any other information with error correction and validation information to ensure that all requested compliance data is received properly. The received data may be checked for errors, errors are fixed if possible, and data with received errors is flagged for the end, system administrator, or data provider with status as to items such as, for example, if data is received corrupted, amount of corruption, if some or all of the corrupted data has been corrected, etc;

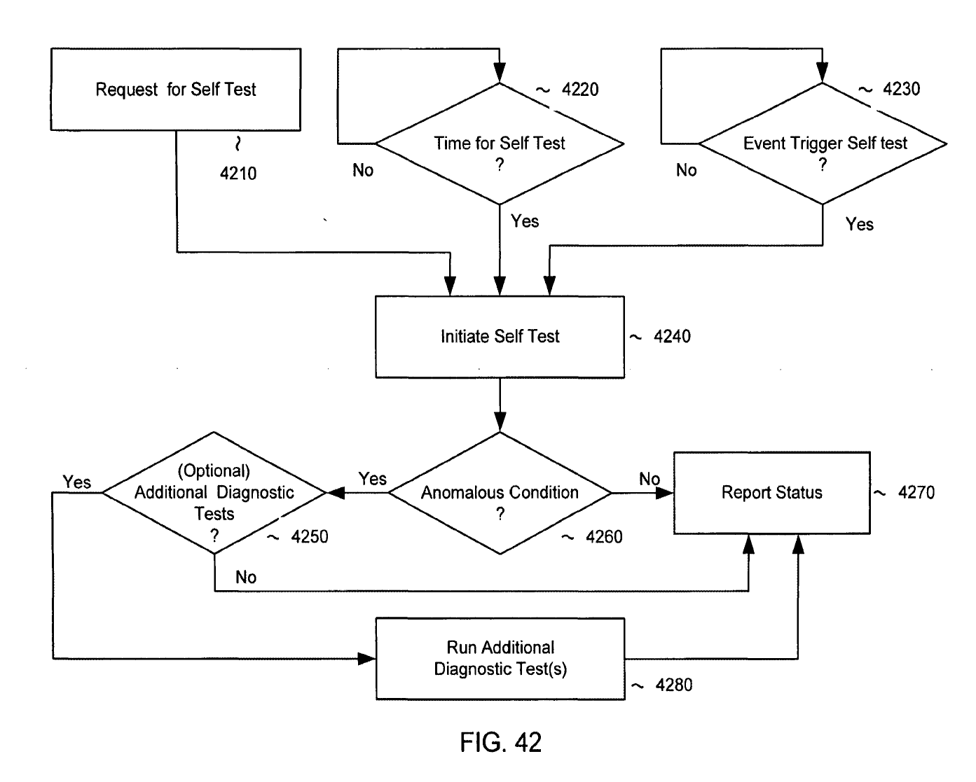

FIG. 42 shows a system that may, for example, provide a compliance announcement, display, and notification system that periodically tests one or more displays to ensure proper operation;

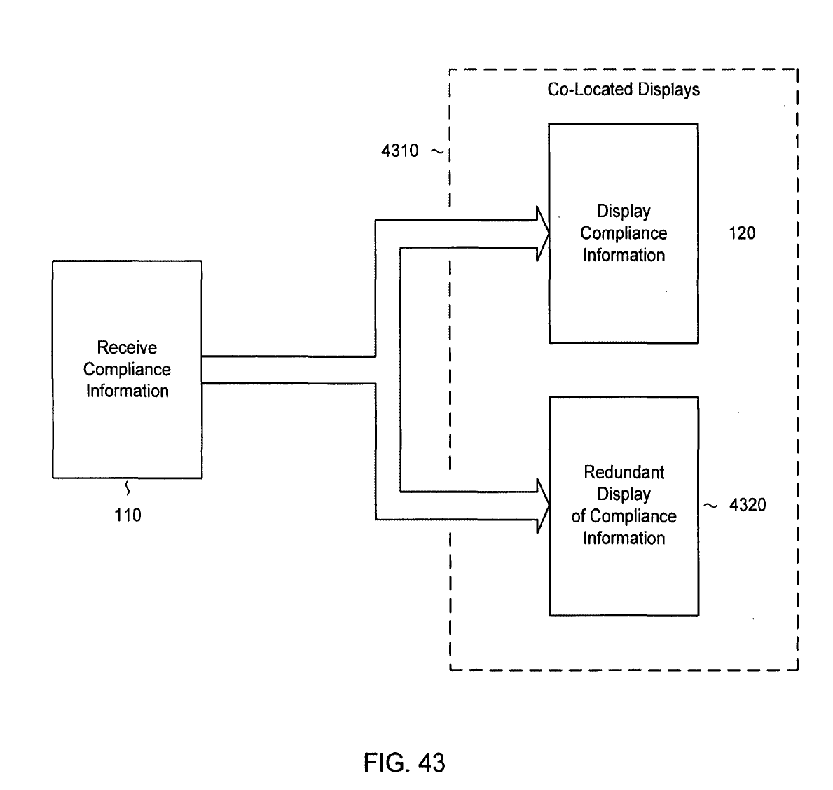

FIG. 43 shows a system that may, for example, provide a compliance announcement, display, and notification system that utilizes one or more redundant displays at the same physical location to ensure continuous uninterrupted display of compliance information and any other desired notification or emergency information;

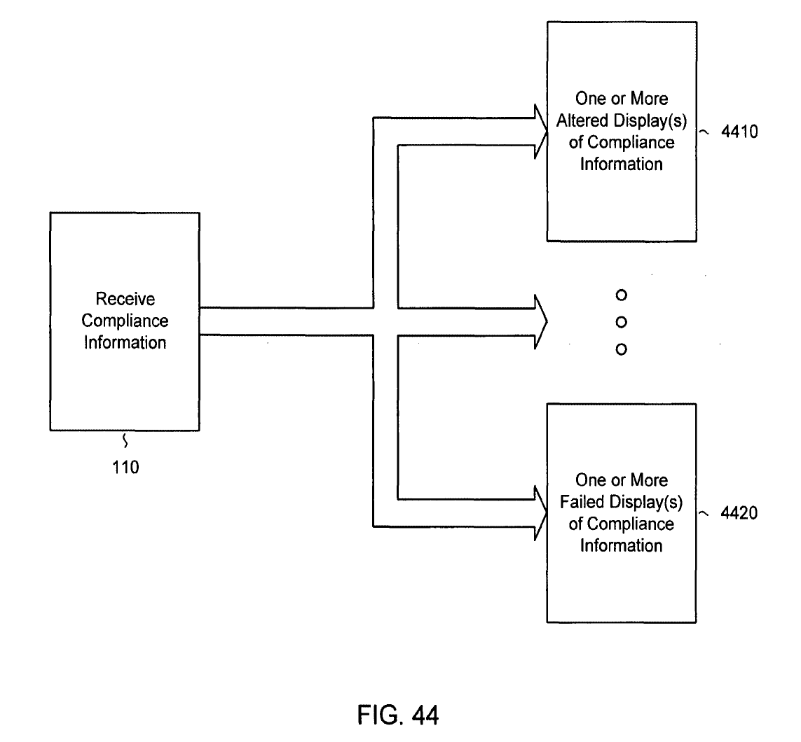

FIG. 44 shows a system that may, for example, provide a compliance announcement, display, and notification system that utilizes multiple displays devices to display compliance information in a more optimal fashion, and upon the failure of one or more, but not all of the displays, the display operative display or displays are altered to show mandated or highest priority compliance data and or information;

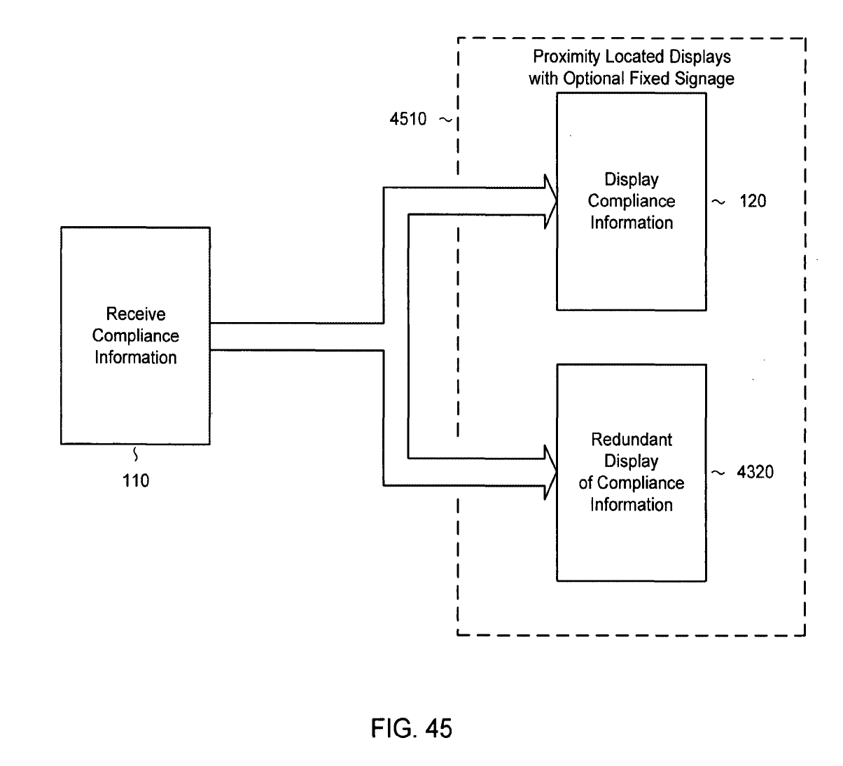

FIG. 45 shows a system that may, for example, provide a compliance announcement, display and notification system that utilizes one or more displays co-located within a fixed proximity of each other showing compliance information. In the event of a failure of one or more, but not all, displays, the remaining display(s) are so positioned to fulfill compliance for both geographic areas. Optionally, a fixed sign indicates that if this display is inoperative please see display located at xyz location;

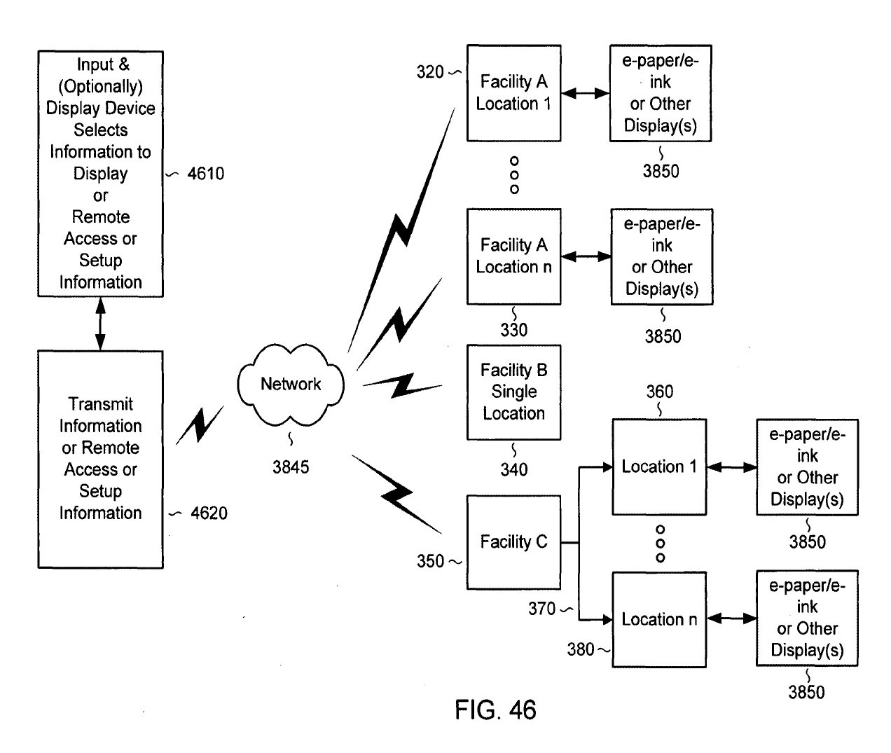

FIG. 46 shows a system that may, for example, provide a compliance announcement, display and notification system that utilizes an input device to select compliance or any other information to display along with remote access and system setup;

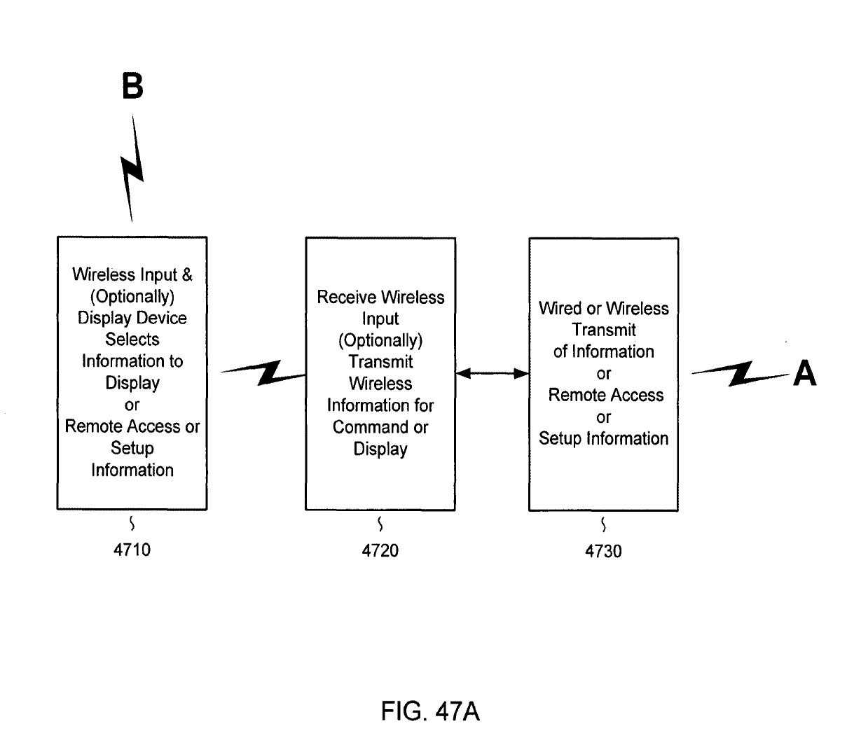

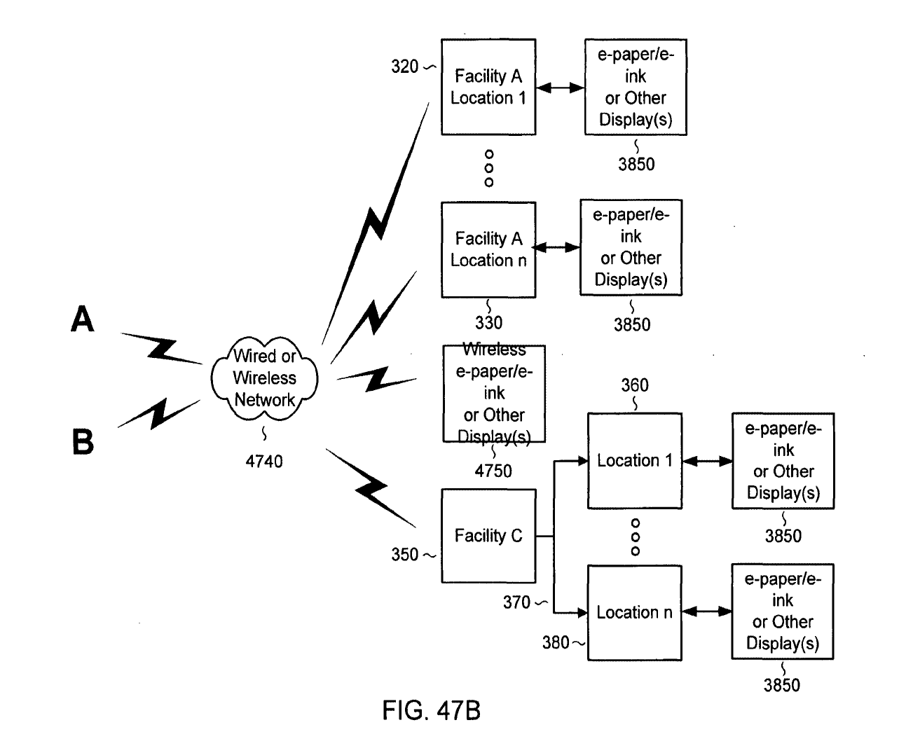

FIGS. 47A and 47B show systems that may, for example, provide a compliance announcement, display, and notification system that controls the compliance announcement, display, and notification system via one or more devices utilizing wireless interfaces-such as Bluetooth and wireless Local or Wide Area networking, utilizing any available protocol including text messaging and other standard and non-standard protocols. A wireless device may also be utilized for remote access for system setup, monitoring, updates, and compliance verification. The wireless input and optionally display device may be a cell phone device or wireless Internet-connected Personal Digital Assistant or Smart Phone to select compliance or any other information to display according to another embodiment of the present invention. In addition, the connections to the network and display device may any form of wireless including LAN, WAN, Cell, or Bluetooth;

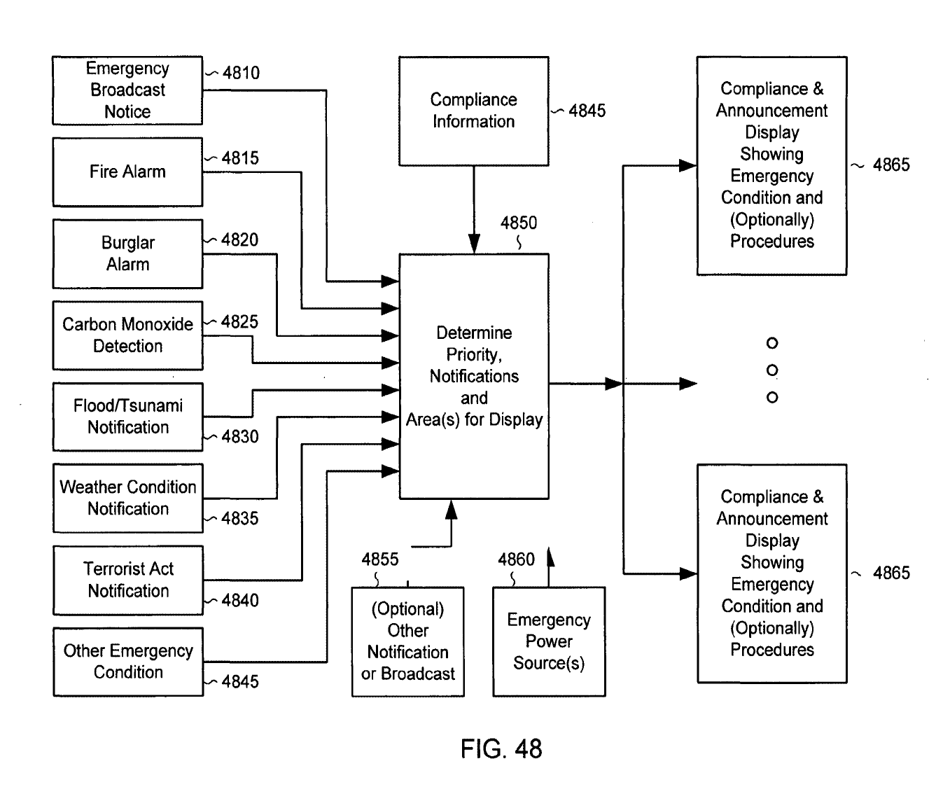

FIG. 48 shows a system that may, for example, provide a compliance announcement, display, and notification system that has one or more of the displays utilized to show compliance information or other information and are operatively coupled to an emergency notification systems such as the Emergency Broadcast System, a fire alarm, a burglar alarm, a carbon monoxide alarm, chemical agent detection, biological agent detection, or a warning system for any type of imminent or an emergent emergency situation. In the event of an emergency, the display will conspicuously display one or more of the following pieces of information: that an emergency condition exists, the nature of the emergency, any corrective actions or emergency procedures to follow. One or more emergency notices may be displayed on a priority basis, pre-empting some or all of the otherwise displayed information. Emergency, Redundant, or Backup Power may be employed to keep all devices operational. Static Display Devices such as e-paper and e-ink will advantageously retain information during periods of power loss;

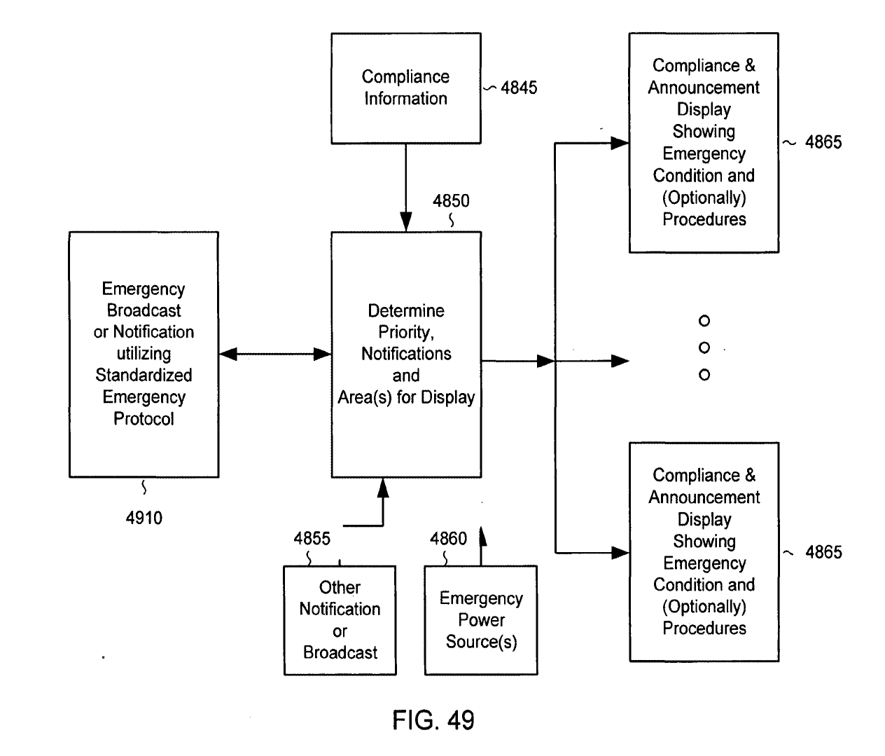

FIG. 49 shows a system that may, for example, provide a compliance announcement, display, and notification system that utilizes one or more standardized Emergency Notification Protocols to provide integration of emergency detection and notification systems and rapid dissemination of emergency information and procedures. The standard protocols may have Emergency Notification flags embedded within the header field or body of the message to provide integration of emergency detection and notification systems and rapid dissemination of emergency information and procedures;

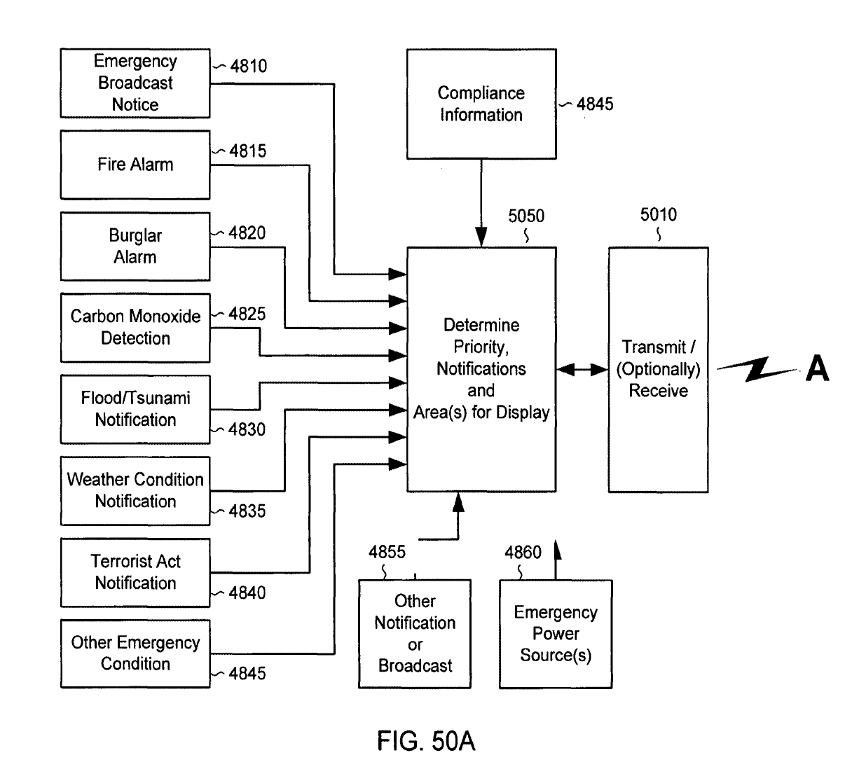

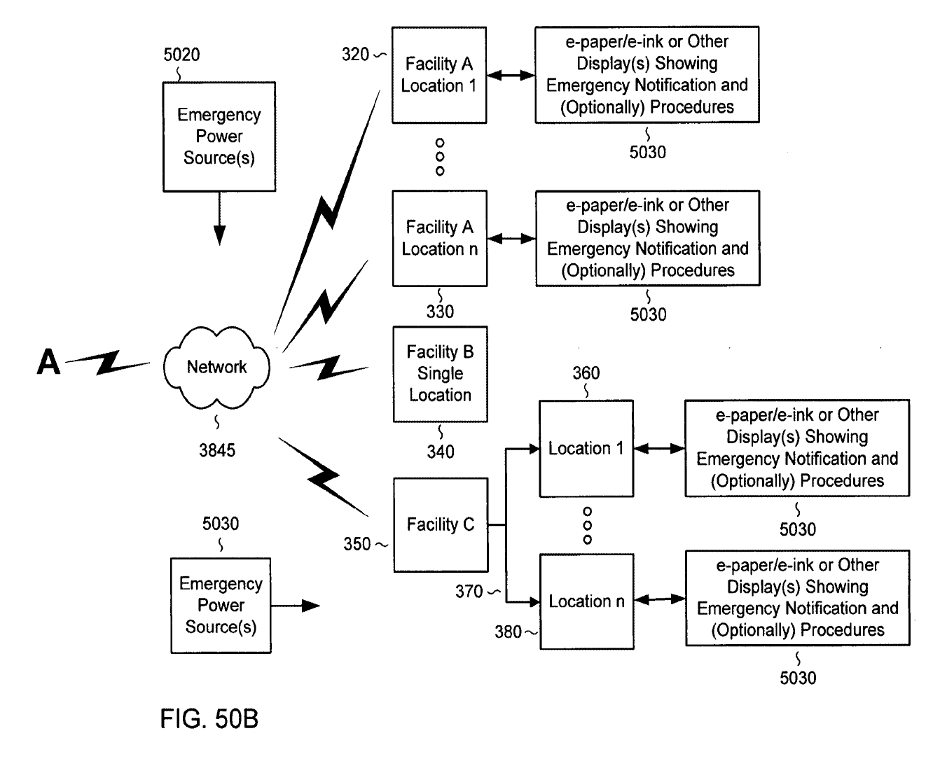

FIGS. 50A and 50B show systems that may, for example, provide a compliance announcement, display and notification system that utilizes an emergency notification and services routing system that accepts sensor input, external information and automatically generates emergency notification messages and procedures for specific address or broadcast to a range of addresses. This can be targeted for specific facilities or specific locations within a given facility;

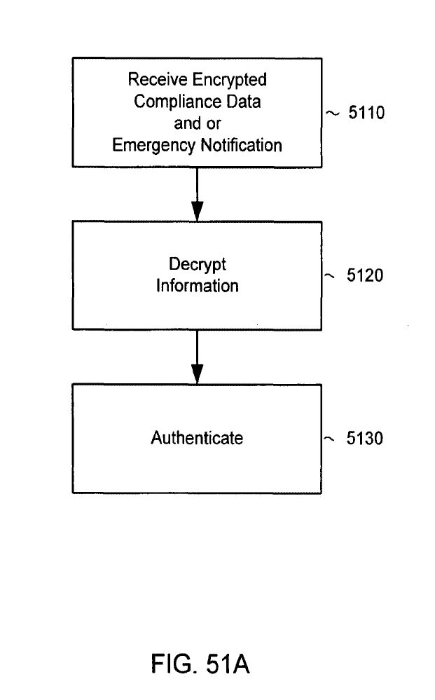

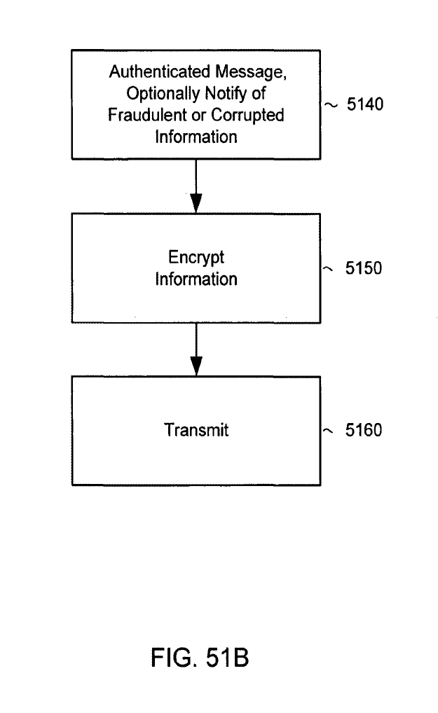

FIGS. 51A and 51B show systems that may, for example, provide a compliance announcement, display and notification system that utilizes authentication and validation of both compliance data and or emergency messages to ensure that messages are authentic and valid;

### DETAILED DESCRIPTION OF THE PREFERRED EMBODIMENTS

This is directed to systems and methods far providing displays of information and, more particularly, to systems and methods for providing automated notifications and displays of compliance issues and other announcements. In the following description, it is to be understood that system elements having equivalent or similar functionality are designated with the same reference numerals in the Figures. It is to be further understood that this may be implemented in various forms of displays, hardware, software, firmware, or a combination thereof.

In particular, the system modules described herein are preferably implemented with a combination of display devices and software as one or more application programs executable by, for example, a general purpose computer or any machine or device having any suitable and processing architecture.

It is to be further understood that, because of the wide variety of possible constituent system components described herein, actual system connections shown in the figures may differ depending upon the manner in which the systems are implemented.

Given the teachings herein, one of ordinary skill in the related art will be able to contemplate these and similar implementations or configurations of the present invention. Although illustrative embodiments have been described herein with reference to the accompanying drawings, it is to be understood that the present invention is not limited to those precise embodiments, and that various other changes and modifications may be affected therein by one skilled in the art without departing from the scope or spirit of the invention. All such changes and modifications are intended to be included within the scope of the invention as defined by the appended claims.

Referring now to FIG. 1A, a block diagram illustrates a system for compliance announcement, display and notification system in accordance with one embodiment of the present invention. The system includes a way for receiving compliance data 110, that may be operatively connected to a display device 120. Compliance data may be received via any method including hardware media, hardware interface, a network, or software protocol that has the ability to receive information in an electronic format. It should be noted that the compliance data may be received by any form of data transmission or storage media.

Transmission systems include, but are not limited to, Wide Area Networks, Local Area Networks, Telephone Dial-up Interfaces, Analog Monitor Interfaces, Digital Monitor Interfaces, Analog Signals or Digital Signals via copper wire, fiber optics, and wireless systems including all portions of the spectrum such as visible, Infrared, Ultraviolet, Ultrasonic, and Radio Frequency. Transmission systems may also include the physical delivery of Memory Storage Devices including memory sticks, and all other forms of non-volatile and quasi-non-volatile memory devices. It should be noted that the receipt of compliance information does not need to be exclusive to the present invention but may be part of a broader network or multi-purpose storage device. For example, the compliance data may be received via a wide area network that services the entire company or other persons or entities. It may be part of a cable network or satellite television distribution system. Similarly, the storage device might be an iPod™, iPhone™, or other memory device utilized to store additional information.

The display device 120 may be any form or manner of display such as, for example, traditional Liquid Crystal Displays, Plasma Displays, LED Displays, Fiber optic Displays, Projectors, Cathode Ray Tubes, e-paper and e-ink, etc. Advantageously the display device will be static or quasi-static such as e-paper or e-ink, thereby enabling the display to operate with a minimum or no power consumption, and thus also to display information when power may not be available, such as in emergency situations.

Referring now to FIG. 1B, a block diagram illustrates another system for compliance announcement, display, and notification system in accordance with another embodiment of the present invention. The system may includes a way for receiving compliance or announcement data 110, that may be operatively connected to an optional buffer 115, that may further be operatively connected to a display device 120. The buffer may be utilized to store some or all of the received compliance or announcement information which may then be displayed on the display device 120. It should be noted that all, some, or none of the received compliance or announcement information may actually be displayed dependent upon system configuration.

Referring now to FIG. 2, a block diagram illustrates yet another system for compliance announcement, display and notification system in accordance with another embodiment of the present invention. The system may include a way for transmitting compliance or announcement information 210 to a means for receiving compliance or announcement data 110, that may further be operatively connected to a display device 120. The compliance or announcement data may be transmitted via any method such as, for example, electronic data transmission or in physical electronic media. Electronic data transmissions methods include Local Area Network (LAN), Wide Area Network (WAN), Ethernet, Wifi, any type of modem including cable modem, cellular transmission, one or two way radio pager, satellite transmission, etc., or any combination thereof. In addition, it is anticipated that new data transmission technologies will become available and will be advantageously employed by the present invention when available. The received compliance or announcement information 110 may be displayed on the display device 120. Once again it should be noted that all, some, or none of the received compliance or announcement information may actually be displayed dependent upon system configuration.

Referring now to FIG. 3A, a block diagram illustrates a system for compliance announcement, display and notification system in accordance with another embodiment of the present invention. Compliance or announcement information is transmitted 210 via a network 310 to one or multiple locations, either within the same facility 350 or amongst multiple diverse locations 320, 330, etc. The compliance or announcement information may be received at one or more facilities and or locations and all, some, or none of the compliance and announcement information may be displayed, stored, or some combination thereof.

As illustrated in the block diagram, Facility A 320 and Facility A 330 may have multiple locations one through n. The transmitting network can have connections to each physical facility where the compliance or announcement may be received and optionally displayed. Facility B 340, illustrates a facility with only a single location for receipt of compliance or announcement information. Facility C 350, shows a single point of receipt for compliance or announcement information that may then be transmitted 370 to more than one location, specifically location 1 360 through location m 380. It should be noted that each location may utilize one or more devices to display compliance and announcement information that may or may not be in the same physical area.

Referring now to FIG. 3B, a block diagram illustrates a system for compliance announcement, display and notification system in accordance with another embodiment of the present invention. Compliance or announcement information may be transmitted 210 via-one or more physical media 390 to one or multiple locations, either within the same facility 350 or amongst multiple diverse locations such as 320 and 330. The compliance or announcement information is received at one or more facilities and or locations, and all, some, or none of the compliance and announcement information may be displayed, stored, or some combination thereof.

As shown in the block diagram, Facility A 320 and Facility A 330 may have multiple locations one through n. The physical media may be delivered to each location where the compliance or announcement information can then be received and optionally displayed. Facility B 340, illustrates a facility with only a single location for receipt of compliance or announcement information. Facility C 350, shows a single point of receipt for compliance or announcement information that may then be transmitted 370 to more than one location, specifically location 1 360 through location m 380. Once again it should be noted that each location may utilize one or more devices to display compliance and announcement information that may or may not be in the same physical area.

Referring now to FIG. 4A, a block diagram illustrates a system for compliance announcement, display and notification system in accordance with yet another embodiment of the present invention. Location specific compliance or announcement information may be transmitted 410 via a network with routing capability 420 to one or multiple locations, either within the same facility 350 or amongst multiple diverse locations 320, 330. Location specific compliance or announcement information can be received at one or more facilities and or locations, and all, some, or none of the compliance and announcement information can be displayed, stored, or some combination thereof. As shown in the block diagram, Facility A 320, 330 may have multiple locations one through n. The transmitting network has connections to each physical facility where the location specific compliance or announcement may be received and optionally displayed. Facility B 340 illustrates a facility with only a single location for receipt of compliance or announcement information. Facility C 350 shows a single point of receipt for compliance or announcement information that can then be transmitted 370 to more than one location, specifically location 1 360 through location m 380. Again, it should be noted that each location may utilize one or more devices to display compliance and announcement information that may or may not be in the same physical area. Further, not all transmitted compliance and announcement information must be location specific. Advantageously the present invention may transmit both location independent and location specific information. The method of transmission may be by broadcast to one or more specific locations. While routing information to specific locations is one method of information delivery, a multitude of other methods may be equally valid including broadcasting all information with unique identifiers that show applicability to a specific facility and/or location. Each method of information delivery may be utilized separately or in any combination with any other method.

Referring now to FIG. 4B, a block diagram illustrates a system for compliance announcement, display, and notification system in accordance with another embodiment of the present invention. Location specific compliance or announcement information can be transmitted 410 via a physical media 390 to one or multiple locations, within the same facility 350 or amongst multiple diverse locations 320, 330. Location specific compliance or announcement information may be received at one or more facilities and or locations, and all, some, or none of the compliance and announcement information is displayed, stored, or some combination thereof. As shown in the block diagram, Facility A 320, 330 may have multiple locations one through n. The physical media can be delivered to each location where the location specific compliance or announcement can be received and optionally displayed. Facility B 340 illustrates a facility with only a single location for receipt of compliance or announcement information. Facility C 350 shows a single point of receipt for compliance or announcement information that can be transmitted 370 to more than one location, specifically location 1 360 through location m 380. Once again, it should be noted that each location may utilize one or more devices to display compliance and announcement information that may or may not be in the same physical area. Further, not all transmitted compliance and announcement information must be location specific. Advantageously, the present invention may deliver both location independent and location specific information. While it is possible to deliver only relevant location specific and location independent compliance and announcement information to each location, it is also possible to deliver information on multiple locations to a given location, and then extract only that information which is relevant to the specific location by any form of identifier. As before, each method of information delivery may be utilized separately or in any combination with any other method.

FIG. 5 is a flow diagram illustrating a method for transmitting, receiving, and optionally displaying both location specific and non-location specific compliance and announcement information in accordance with another embodiment of the present invention. Referring to the flow diagram, a test can be performed to see if there are any locations which require compliance or announcement information 550. If “No” then continue to test. If “Yes” then determine the appropriate location specific compliance or announcement information 510, then append any requisite non-location specific compliance or announcement information 520. The aggregated information can then be transmitted to the specific location 530 where the information is received 535 and optionally displayed 540. Once the compliance or announcement data has been transmitted 530, the test 550 may be repeated.

FIG. 6 is a flow diagram illustrating a method for transmitting, receiving, and optionally displaying State specific compliance and announcement information in accordance with yet another embodiment of the present invention. Referring to the flow diagram, a test can be performed to see if here are any locations which require state specific compliance or announcement information 650. If “No” then continue to test. If “Yes” then determine the appropriate state specific compliance or announcement information 610, then append any requisite non-state specific compliance or announcement information 620. The aggregated information can be then transmitted to the specific location 630 where the information is received 635 and optionally displayed 640. Once the compliance or announcement data has been transmitted 630, the test 650 can be repeated.

Referring now to FIG. 7, a flow diagram illustrates a system for compliance announcement, display, and notification system that may allow electronic distribution of incremental updates to compliance information, notifications, and other relevant company information, in accordance with yet another embodiment of the present invention. Compliance, notification, and announcement information can periodically be scanned for any updates 710. If no updates are found, then a new scan may be performed at some later time frame. If new or updated information is located, then the system can transmit the incremental updates 720. The incremental updates are received and optionally stored or cached 730. Optionally, a display device may display the updated compliance, notification, or announcement information 120.

Referring now to FIG. 8, a block diagram illustrates a system for compliance announcement, display and notification system that may allow electronic distribution of compliance information, notifications, and other relevant company information, facilitating frequent updates and allowing for shorter cycle times from information creation to display within various companies or other users, in accordance with yet another embodiment of the present invention. The system may receive, locate, or be notified of new or updated compliance, announcement, or notification information 810. Some or all of the new or updated information may be selected for transmission based upon location specific or non-location specific selection criteria 820. The information can then be transmitted to each location as appropriate 830. The transmitted data may utilize one or more networks with or without routing functions to arrive at the appropriate facilities and locations 420. Facility A as shown has multiple locations 320 and 330, with each location receiving information from an external network. Facility B has a single location 340, and Facility C 350 has multiple locations, Location 1 360 through Location n 380, that may be connected via an internal network or any other means of data delivery 370. It should be noted that the existing connection methodology is for representative purposes and there exists an unlimited numbers of methods to connect various locations and all or any are permissible under the present invention.

Referring now to FIG. 9, a flow diagram illustrates a system for compliance announcement, display, and notification system that allows electronic distribution of compliance information, notifications, and other relevant company information in accordance with yet another embodiment of the present invention. The compliance information, notifications, and other relevant company information may come from a known database of valid, unambiguous compliance, notification, and company information, thereby eliminating possible user confusion and ambiguities. Compliance, notification, and announcement database can be periodically scanned for any updates 710. If no updates are found, then a new scan may be performed at some later time frame. If new or updated information is located, then the system may retrieve or receive the new or updated information 910. The information can then be checked for redundancy or ambiguities with existing information or within itself 920. If no redundancies or ambiguities are found, the updated information can be placed in an information database 940. If redundancies or ambiguities are found, the redundancy may be removed and the ambiguities flagged and optionally resolved if the system has the capability of resolving the ambiguities 930. The updated information may then be placed in the compliance information database 940. By way of example, if Federal Regulations take precedence over State Regulations, and there are differing rules for Child Labor, the system may flag the ambiguity and place the Federal Information in the database. Optionally it may also store the State Information with a flag or identifier stating that it is superceded by the federal Information, along with a pointer or reference to the related federal information.

Referring now to FIGS. 10A and 10B, flow diagrams illustrate another embodiment of the present invention. FIGS. 10A and 10B illustrate a system for compliance announcement, display, and notification system that may maintain links to one or more sources of compliance data, and on a predetermined time schedule such as, for example, a recurring periodic cycle, or by request, may update and optionally display the information. As shown in FIG. 10A, links can be maintained to one or more sources or repositories of compliance data 1010. The links may come from a known list or via scanning the internet or any other repository of information with an automated search tool or any other method to locate one or more relevant for sources of compliance or announcement information, and then creating a list of links to some or all of the sources of relevant compliance or announcement information. A test may be performed to see if it is time for a scheduled update 1020. If it is not yet time the test can be performed again at a later time. If it is time for a scheduled update, an additional test can be performed to see if there are any updates to the compliance data 1030. In addition to automatic scanning, the scanning can also be done upon request, on a predetermined timetable, on a recurring periodic cycle, or upon notification that additional or updated compliance or announcement data or meta data is available, etc. The links may thus be utilized to automatically scan for updated compliance data or other information of interest and meta data associated with the information such as the effective date of the new compliance information, date and or time of receipt, date and or time of creation, source of data, known ambiguities or conflicts and what data is replaced or superseded, thereby ensuring that up to date compliance data is available on a timely basis. If no updates are found or received, then the system may go back to the ‘time for scheduled update?” test 1020. If updated compliance data is found, then it may be updated 1040 and then optionally displayed 120.

Referring now to FIG. 10B, links are maintained to one or more sources or repositories of compliance data 1010. A search is then performed for update requests 1050. If updates are not requested then the system goes back to the “Search for Updates?” test 1050. If the system wishes to search for updates, an additional test may be performed to see if there are any updates to the compliance data 1030. If updated compliance information is found, the compliance information database may be updated 1060. It should be noted that some or all of the compliance or announcement data may be downloaded. The compliance and announcement data may be stored on a local hard drive or remotely, or stored in a centralized or distributed respository(s). Access to the data may be by any way including local area network, wide area network, or internet, utilizing both wireless and hardwired access, etc. Optionally a history of compliance and announcement information may be maintained. Data storage management techniques may also be applied, including storing all of the downloaded compliance and announcement data, archiving data older than a specified date, archiving revisions older than current data or above some number of prior revisions, discarding revision older than current, discarding prior revisions above a specified number, etc. In the case of incremental update, at least the data that applies to the current revision may be saved, for example, in a series of incremental updates or a master document with a list of the original documents and applied updates.

Referring now to FIG. 11, a flow diagram illustrates a system for compliance announcement, display and notification system that may automatically notify users when laws or other compliance information, notifications, or relevant company information changes, thereby ensuring that companies are aware of the latest compliance requirements and other information. A test can be performed to check for any updates to compliance, notifications, or other relevant company information 710. Once again this test may be initiated autonomously or by request. If there are no updates, the system remains in the test loop, if there are updates, then the system selects one or more methods of user notification 1110. The updated compliance or announcement data may come from one or more sources and notification to users via, for example, email (with or without attachments), instant messaging, a telephone call, voice mail messaging, file transfer protocol or any other means of electronic data transmission. One or more users are then notified 1120. Then automatically, or upon user request, the updates are optionally transmitted to one or more users 1130. It should be noted that the notification process is distinct from the transmit or download process as one or more the users may wish to be notified on one type of device, for example a cellular phone, and receive the download on another device, for example, such as a network server at a company's facility. Indeed multiple notifications. The same notification(s) can be sent periodically until a download occurs, multiple downloads can occur for redundancy, and notifications can occur until a specific event (such as displaying some or all of the downloaded information) has been acknowledged. The transmitted updates may be received by the user or users and optionally cached or stored 1140. The updated compliance information may then optionally displayed 120.

Referring now to FIGS. 12A, 12B, and 12C, flow diagrams illustrates a system for compliance announcement, display and notification system that updates a database or other repository of compliance or other information with additional or new information in accordance with yet another embodiment of the present invention. The additional or new information may be received from a transmission from an external or internal website, a file server, or any other device. As shown in FIG. 12A, new or updated compliance information may be autonomously transmitted from a website, webserver, file server, or any other computing or storage device 1210. The updated information may be stored in an updated compliance database 1220.

As depicted in FIG. 12B, a scan may be performed for new or updated compliance, notification, or announcement information 1230. The scan may be performed by any mechanism including an autonomous scanning system (BOT) that continuously scans for updated compliance data or information. The scan may be performed continuously, periodically, or upon request. A test can be performed to see if new information is located 1240. Optionally, the scanning system may request or deliver the updated information when located, thus providing updated compliance information within a known update period, thus eliminating steps 1240 and 1210. If no new or updated information is located, the system may return to the scanning system. If new or updated information is located, the information may be transmitted from a website, webserver, file server, or any other computing or storage device 1210. The new or updated information may be stored in an updated compliance database 1220.

As shown in FIG. 12C, a system for compliance announcement, display, and notification system that may update a database or other repository of compliance or other information with additional or new information by scheduled or periodic request is illustrated. Periodically, or via scheduled request, new or updated compliance, notification, or announcement information may be transmitted from a website, webserver, file server, or any other computing or storage device 1250. The updated information may be stored in a updated compliance database 1220

As shown in FIG. 13, a block diagram illustrates a system for compliance announcement, display, and notification system in accordance with yet another embodiment of the present invention. Compliance or announcement information may be transmitted 210 via a network 310 to one or multiple locations, either within the same facility 350 or amongst multiple diverse locations 320, 330. The compliance or announcement information may be received at one or more facilities and or locations, and all, some, or none of the compliance and announcement information is displayed, stored, or some combination thereof.

As shown in the block diagram, Facility A 320, 330 may have multiple locations one through n. The transmitting network may have connections to each physical facility where the compliance or announcement can be received and optionally displayed. In addition, each facility in 320, 330 may have local storage to store the compliance, announcement, or notification information. In addition, Facility A 320 illustrates a storage device 1320 operatively connected to one or more networks 1330 which may also connect to one or more of the following: display(s) 1360, other users 1340, or other facilities, locations, or networks 1350. Facility B 340, illustrates a facility with only a single location for receipt of compliance or announcement information and no provisions for local storage. Facility C 350 shows a single point of receipt for compliance or announcement information that may be transmitted 370 to more than one location, specifically location 1 360 through location m 380. In addition, it should be noted that one or more locations 380 may have local storage 1320, in addition to being operatively connected to one or more networks 1330, which may also connect to one or more of the following: display(s) 1360, other users 1340, or other facilities, locations, or networks 1350.

FIG. 14 a block diagram illustrating a system for compliance announcement, display, and notification system that may allow electronic distribution of compliance information, notifications, and other relevant company information, in aggregated downloads or data transfers, thereby eliminating the need to go to multiple websites and other repositories of information and download information piecemeal. Compliance, announcement, or notification information can be acquired from one or more sources 1410. The information can be aggregated into one or more downloads 1420. The downloads may be transmitted to various locations or users 1430. The information can then be received by the locations or users 1440. Optionally, locations or end users may request aggregated downloads which are then transmitted to the locations or users.

FIG. 15 is a block diagram illustrating a system for compliance announcement, display, and notification system that may allow electronic distribution of compliance information, notifications, and other relevant company information formatted for specific displays, display types, or display resolutions and is in accordance with yet another embodiment of the present invention. The system may aggregate compliance data from multiple topics or sources for simultaneous display, and may utilize menus or other forms of user requests to display specific information, thereby providing a quick and easy way of viewing the information without the need for requestor formatting. The formatting may occur anywhere, including the end users facility. The formatting may be utilized to aggregate information for simultaneous or sequential display. In addition, formatting can utilize specific color palettes or any other visual or aural techniques for branding based upon supplied or known parameters. Referring to FIG. 15, compliance, announcement, or notification information is ready for transmission 1510. A determination is made for some or all of the information to be displayed on one or more target displays with optional format information for specific displays or display types 1520. The information may be formatted for the specific display at the transmitting facility(s) or at the user's facility. The display specific information may be transmitted to the various target display 1530 via any transmission method, an optional network and routing 420, and may be received by one or more facilities 1540, 1550, 1560, 1570. It should be noted that each facility may have one or more displays and one or more display types. The formatting for each display or display type may include one or more types of additional information dependent upon multiple factors including the display's capability, its function, and the business model of the compliance, notification and display system.

FIG. 16 a representative screen capture illustrating menu systems for a compliance announcement, display, and notification system. As shown, compliance, announcement, and notification information may be displayed utilizing one or more menu systems 1610. The menu may list compliance topics such as State Compliance Notices 1620, Federal Compliance Notices 1625 and/or subtopics such as the Anti-Discrimination Notice 1630 or the Employee Polygraph Protection Act 1635, etc., and optionally a brief description of what the compliance subject matter covered by the topics or subtopics. As shown, the menus may be organized in a hierarchical fashion and there may be multiple levels of hierarchies. Announcements 1640 may also be included, for example, “There will be a fire drill at 3 pm in Building B” 1645 along with various notifications such as, for example, News 1650 “Division XYZ wins Major Program Award” 1655. The viewer may select one or more topics to read or review. Selection may be by any way including an input device such as a touch screen. The subject matter for each topic may be displayed in total, in part, or via additional menus. The selected data for display may be aggregated and reformatted if desired. If multiple menus are utilized, the menus may be displayed concurrently, in succession, in random order, or according to a predefined sequence. Similarly, the displayed information may be cycled through in whole or in part on a periodic basis. Advantageously, the usage pattern of menus, topics, or subtopics may be recorded for future use. In addition, the display of menus, specific topics, subtopics, or any other information may be learned by the system and displayed in an optimized fashion or sequence. The menu systems thus provide information display in a compact and efficient format.

FIGS. 17A and 17B are block diagrams illustrating a system for compliance announcement, display and notification system that may periodically display compliance data and/or internal company generated information on multiple displays simultaneously, in sequence, or any combination thereof, thereby providing a highly effective, easy to read display. As shown in FIG. 17A, two or more displays are co-located in the same facility 1710. The co-location may be adjacent or physically distributed within the same locality. Display 1 displays compliance, announcement, or notification information 1720 while display n 1730 displays different compliance, announcement, or notification information. As stated, the compliance data or internal company generated information may be periodically displayed on multiple displays simultaneously, in sequence, or any combination thereof that may be advantageous.

Similarly, FIG. 17B again shows two or more displays that are co-located in the same facility 1710. The co-location may be adjacent or physically distributed within the same local. Display 1 1750 displays compliance, announcement, or notification information that is time sequenced while display n 1750 also displays time sequenced compliance, announcement, or notification information. Due to the nature of compliance information a specific schedule may be warranted to maintain Federal, State, or Regulatory Compliance. In addition, the ability to display safety information or other information of interest, including advertising, may draw more viewers.

FIG. 18 is a block diagram illustrating a system for compliance announcement, display, and notification system that provides electronic distribution of compliance information, notifications, and other relevant company information utilizing emergent display technologies such as e-paper and e-ink or other non-volatile or semi-volatile display devices, thereby providing cost effective static or quasi-static displays of the information. Referring now to FIG. 18, compliance, announcement, or notification information may be transmitted 210 via a network 310 to one or multiple locations, either within the same facility 350 or amongst multiple diverse locations 320, 330. The compliance or announcement information can be received at one or more facilities and/or locations, and all, some, or none of the compliance and announcement information is displayed on e-paper or e-ink displays or other non-volatile or semi-volatile display devices 1810.

FIG. 19 is a block diagram illustrating a system for compliance announcement, display and notification system that that may allow electronic distribution of information in one or more languages, that optionally can be location specific, including compliance information, notifications, and other relevant company information to multiple locations, within the same facility or amongst multiple diverse locations, thereby reducing the logistical burden for businesses. As shown, compliance announcement and notification information can be selected in one or more languages. Optionally, the one or more languages may be for location specific destinations 1910. The information can be transmitted to one or more language specific, optionally location specific, destinations 1920 via a network 420 to one or multiple locations, within the same facility 350 or amongst multiple diverse locations 320, 330. The compliance or announcement information can be received at one or more facilities and or locations, and all, some, or none of the compliance and announcement information is displayed.

FIG. 20 is a representative screen capture illustrating menu systems for a compliance announcement, display, and notification system. As shown, compliance, announcement, and notification information can be displayed utilizing user interactive menus, cycling through various displays, or a combination thereof, thus saving wall space and enhancing readability while also reducing cost by allowing selection of various notifications and compliance information within the same display area. As shown, the State Compliance Notices 1620 and Federal Compliance Notices 1625 are show in a menu driven hierarchical fashion with corresponding submenus. Announcements 1640 and News 1650 are shown only as menu items. Submenu information for these and any other menu items or submenu items can be displayed in the field 2020.

FIG. 21A is yet another representative screen capture illustrating menu systems for a compliance announcement, display and notification system. Again, the compliance, announcement, and notification information can be displayed utilizing user interactive menus, cycling through various displays, or a combination thereof. As shown, the State Compliance Notices 1620 and Federal Compliance Notices 1625 are show in a menu driven hierarchical fashion with corresponding submenus. Announcements 1640 and News 1650 are again shown only as menu items. Submenu information for these and any other menu items or submenu items can be displayed in the field 2020. In absence of a menu or submenu selection, a default compliance, announcement, notification, can be located in some or all of the display area 2140. In addition, items such as a Realtime Stock Quote Ticker or advertising may be displayed.

FIG. 21B is yet another representative screen capture illustrating menu systems for a compliance announcement, display and notification system. Again, the compliance, announcement, and notification information can be displayed utilizing user interactive menus, cycling through various displays, or a combination thereof. As shown, the State Compliance Notices 1620 and Federal Compliance Notices 1625 may be show in a menu driven hierarchical fashion. Emergency Procedures 2130 may be shown only as a menu item. Submenu information for this and any other menu items or submenu items can be displayed in the field 2020. In the absence of a menus or submenu selection, a default Submenu of salient emergency procedures is shown 2150.

FIG. 22 is a diagram illustrating a compliance announcement, display, and notification system that can utilize one or more compact displays that can be mounted or positioned in more convenient locations such as desktops, tables, or wall locations, etc., thereby enhancing readability and reducing reader fatigue, and is in accordance with yet another embodiment of the present invention. As shown in FIG. 22, a compact display of any type, but preferably e-paper or e-ink, or some other type of fully static, quasi-static, or low power consumption display 2210 is mounted on a wall or other surface. Alternatively, a table top display 2220 may be utilized on a table surface 2225 or desk 2235. It should be noted that the display may actually be built into the surface of the furniture 2230 or any convenient visible surface.

FIG. 23 is a flow chart illustrating a compliance announcement, display, and notification system that provides display of compliance, announcement, or notification information in multiple languages automatically. As shown, a timer can be started 2310 and compliance announcement, or notification information may be displayed in a first language 2315. A test can be performed to see if the time limit for displaying the information in the first language is reached 2320. If “No”, then the information may remain on display. If “Yes”, then compliance announcement or notification information is displayed in a second language 2325. Similarly, a test can then be performed to see if the time limit for displaying the information in the second language is reached 2330. It should be noted that the information displayed in the first and second language may or may not be the same. By way of example, some of the information for the first or second language may be language specific. In addition to different languages, different dialects of the same language may be employed in the present invention. Finally, a third test can be performed to see if there is information in additional languages to display 2335. If “No”, the system again may display information in the first language. If “Yes”, information can be displayed in the next language 2340 until a third time limit is reached in test 2345 and a further test can be performed to see in any information in additional languages is to be displayed 2235. If “Yes” then test 2335 and steps 2340 and 2345 may repeat until all information in additional languages is displayed. If all information in additional languages is displayed, test 2335 results in “No” and the process can commence again, beginning with a first language in step 2315.

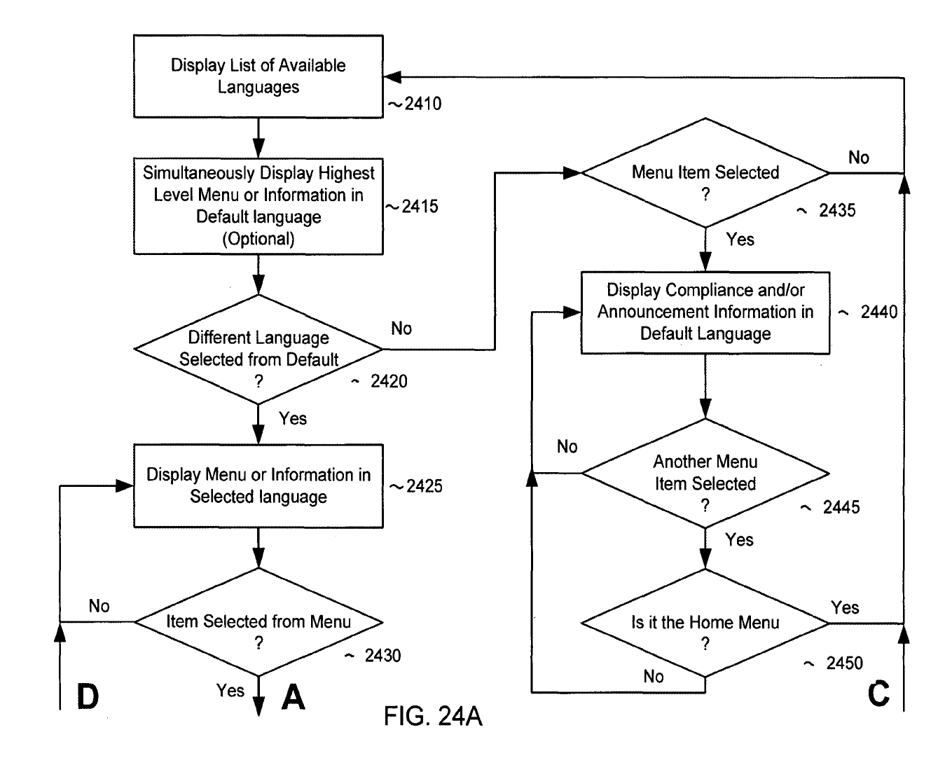

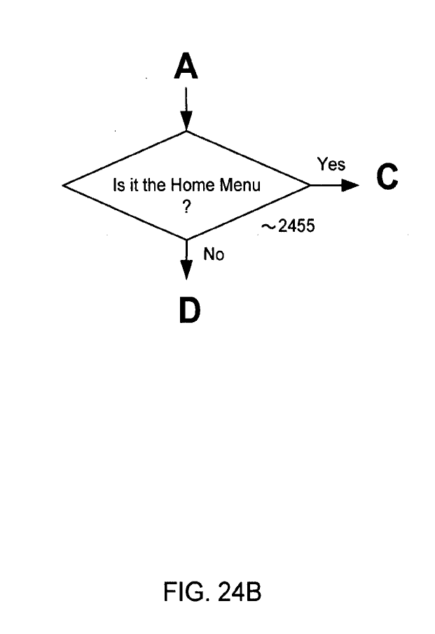

FIGS. 24A and 24B are flow charts illustrating a compliance announcement, display, and notification system that can provide display(s) of compliance, announcement, or notification information in multiple languages by user request. As shown, a list of available languages is displayed 2410 and optionally, simultaneously (or in sequence) a highest level menu or information may be displayed in a default language 2415. If a different language is selected from the list of available languages step 2420, a menu or information can be displayed in the selected language 2425. If a menu item is selected from the display 2430, then a further test 2455 can be performed to see if it is the home menu as displayed in 2410. If it is the home menu, then the process returns to 2410, otherwise the selected menu or information may be displayed in the previously selected language 2425. Referring back to test 2420, if a different language was not selected, then a further test can be performed to see if a menu item was selected 2435. If “No”, then the system returns to the home menu 2410; if “Yes”, then the compliance or announcement information or additional menu can be displayed in the default language 2440. If another menu item is selected 2445, then a test can be performed to see if it is the home menu 2450. If it is the home menu, then the home menu can be displayed 2410, otherwise the menu or information may be displayed in the default language 2440.

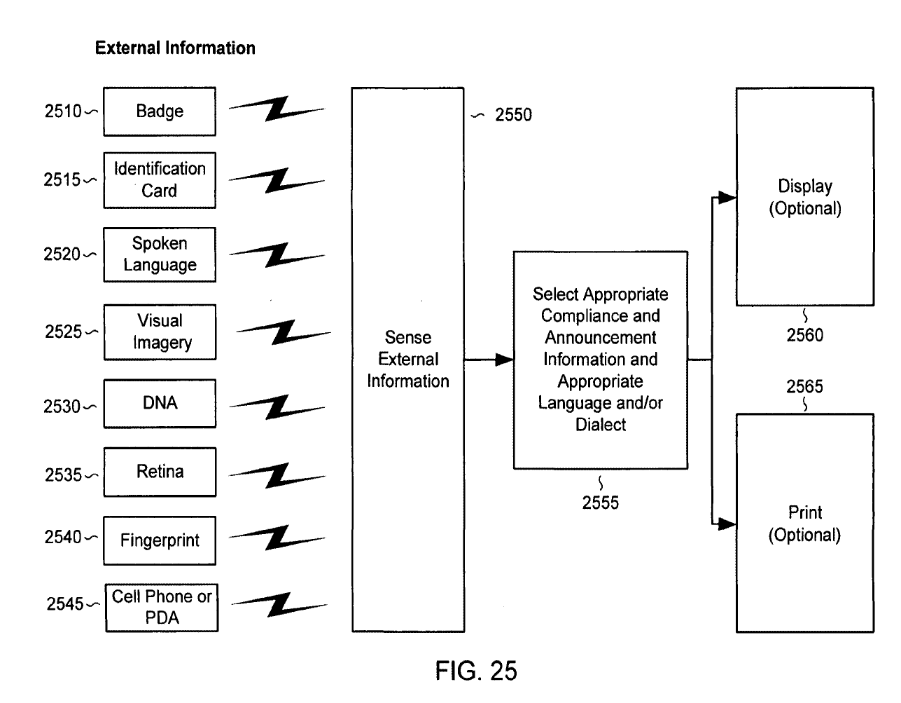

FIG. 25 is a block diagram illustrating a compliance announcement, display and notification system that provides display of compliance, announcement, or notification information in multiple languages and/or dialects by sensing external information. As shown, one or more sources of external information such as, for example, a badge with encode information 2510, an identification card 2515, spoken language 2520, visual imagery 2525 such as sign language or color coding of uniforms, DNA 2530, retinal information 2535, Finger Prints 2540, or information from a cell phone, iphone, or other personal computing device 2545, etc., is sensed 2550 and appropriate compliance, announcement, or notification information can be selected in an appropriate language and/or dialect 2555. The information can then be optionally displayed 2560 or printed 2565.

FIG. 26 is a block diagram illustrating a compliance announcement, display, and notification system that can allow electronic distribution of compliance information, notifications, and other relevant company information to employees, affiliates, consultants, shareholders, suppliers, and any other stakeholders that is required for distribution to the above recipients with or without the requirement for posting, thereby easing logistical requirements. As shown, compliance, announcement, or notification information can be transmitted 2610 via a network and routing function 2620 to various stakeholders in an organization including multiple employees 2630, 2635, affiliates 2640, consultants 2645, shareholders 2650, suppliers 2655, or any other stakeholders 2660. It should be noted that the information can optionally be addressee or stakeholder type specific.

FIG. 27 is a block diagram illustrating a compliance announcement, display and notification system that can allow electronic distribution of compliance information, notifications, and other relevant company information to employees, affiliates, consultants, shareholders, suppliers, and any other stakeholders. The illustration may validate receipt by the appropriate party and timely posting or distribution of the information, thereby eliminating the typical problems associated with sending hardcopy posters to organizations that may experience employee turnover, administrative, organizational, or legal changes within an organization, mergers, acquisitions, divestitures, changes of address (both physical and electronic mail), etc. The information receipt and/or display may be verified on a time sensitive basis. As shown in FIG. 27, compliance, announcement, or notification information can be transmitted 2610 via a network and routing function 2620 to various stakeholders in an organization including one or more employees 2630, 2635, affiliates 2640, consultants 2645, shareholders 2650, suppliers 2655, or any other stakeholders 2660. Each stakeholder may then print, read, and/or display the received information 2710. The receipt of information by each stakeholder can be verified 2665 along with the display, distribution, reading, and/or opening of some or all of the information. It should be noted that each stakeholder may be allowed different privileges with the received information. For example, a supplier might be restricted from retransmitting confidential; information. The information may be protected by any digital rights management methodology. In addition, the information can be retransmitted if acknowledgement of receipt is not received, or if an event, such as a specific period of time elapses without the information being read or opened, occurs. Automatic reminders are also possible.

FIG. 28 is a flow diagram illustrating a compliance announcement, display, and notification system that provides electronic distribution of compliance information, notifications, and other relevant company information including: Certificates of Insurance, Workmen's Compensation Insurance, Disability Insurance, etc., and also can provide on-demand access to information such as Company Employment Manuals, Company Policy and Procedures, Emergency Procedures, Hazardous Material Requirements, OSHA Requirements, and Materials Safety Data Sheets to employees, affiliates, consultants, shareholders, suppliers, and any other stakeholders in advance of the actual effective date and time. The system can then display, print, and/or send the information at a prescribed date and time, thereby ensuring timely receipt and display, printing, and/or retransmitting of the information. As shown in FIG. 28, compliance, announcement, or notification information such as Certificates of Insurance, Workmen's Compensation Insurance, Disability Insurance, can be provided. The system may additionally select on-demand access to information such as Company Employment Manuals, Company Policy and Procedures, Emergency Procedures, Hazardous Material Requirements, OSHA Requirements, and Materials Safety Data Sheets to transmit to employees, affiliates, consultants, shareholders, suppliers, and any other stakeholders in advance of the actual effective date and time 2810. At the appropriate date and time 2820, the selected information can be transmitted to one or more stakeholders 2825 and the information may be received and buffered 2830. At the appropriate time 2840, the received and buffered information can be displayed, printed, and/or redistributed 2850.

FIG. 29 is a block diagram illustrating a compliance announcement, display, and notification system that can combine compliance data with requestor data of interest and then provide electronic distribution of compliance information, notifications, and other relevant company information to employees, affiliates, consultants, shareholders, suppliers, and any other stakeholders, and optionally allow for one or more of printing, display of the information, verification of receipt, and/or reading of the information. As shown in FIG. 29, one or more stakeholders in an organization including employees 2630, 2635, affiliates 2640, consultants 2645, shareholders 2650, suppliers 2655, or any other stakeholders 2660, can request compliance information. The obtained compliance information 2920 can be combined with requestor data of interest 2930 and transmitted to one or more specific requestors, which are typically various stakeholders in an organization. The requestor data of interest may include company data, such as internal company notices, that also have specific posting and notification requirements, such as Insurance Companies Workmen's Comprehensive & Disability Insurance Notices, Company Employment Manuals, Company Policies & Procedures, Emergency Procedures, Hazardous Materials Requirements, OSHA Requirements, and Materials Safety Data Sheets, etc. Each stakeholder may then print, read, and/or display the received information 2710. The receipt of information by each stakeholder can be verified along with the display, distribution, reading, and/or opening of some or all of the information.

FIG. 30 is a block diagram illustrating a compliance announcement, display, and notification system that can automatically request and obtain compliance data or other information from a third party source, combine compliance data with requestor data of interest, and then provide electronic distribution of compliance information, notifications, and other relevant company information to employees, affiliates, consultants, shareholders, suppliers, and any other stakeholders. The system may optionally allow for printing and/or display of the information, verification of receipt and/or reading of the information, thus easing the logistical burden on a company or other entity. Received information may be optionally printed and/or displayed.

As shown in FIG. 30 one or more stakeholders in an organization, including employees 2630, 2635, affiliates 2640, consultants 2645, shareholders 2650, suppliers 2655, or any other stakeholders 2660, may request compliance information. One or more third party sources can be queried to obtain the requested compliance information. If the requested data is not received, it may be optionally re-requested. Some or all of the requests may optionally be logged. The obtained compliance information 2920 can be combined with requestor data of interest 2930, and transmitted to one or more specific requestors, which are typically various stakeholders in an organization. Once again, the requestor data of interest may include company data, such as internal company notices, that also have specific posting and notification requirements such as, for example, Insurance Companies Workmen's Comprehensive & Disability Insurance Notices, Company Employment Manuals, Company Policies & Procedures, Emergency Procedures, Hazardous Materials Requirements, OSHA Requirements, and Materials Safety Data Sheets, etc. Each stakeholder may then print, read, and/or display the received information 2710. The receipt of information by each stakeholder can be verified along with the display, distribution, reading, and/or opening of some or all of the information.

FIG. 31 is a block diagram illustrating a compliance announcement, display, and notification system that can provide electronic distribution and on-demand printing by user request of compliance information, notifications, and other relevant company information. As shown in FIG. 31, a central repository of compliance information, Certificates of Insurance, Workmen's Compensation Insurance, Disability Insurance, etc., and information such as Company Employment Manuals, Company Policy and Procedures, Emergency Procedures, Hazardous Material Requirements, OSHA Requirements, and Materials Safety Data Sheets, Company Notices, Company Announcements, and other types of related information 3110, are operatively coupled to a network 310 that can be utilized to electronically distribute some or all of the information to one or more facilities with multiple locations 320, 330, single locations 340, or to a single facility that then may redistribute the information to multiple locations 350, 360, 370. At least one of the cited facilities or locations can then perform on-demand printing 3115 of some or all of the electronically distributed information. Optionally, the information may also be displayed in a printed format, such as .pdf files displayed on a screen or, advantageously, e-paper or e-ink.

FIG. 32 is a flow diagram illustrating a compliance announcement, display and notification system that can allow a requestor wishing compliance data to register relevant user information over the Internet or by any other remote way. As shown, a user may register relevant information via the Internet, or via any other suitable method, where the relevant information includes the type(s) of compliance information requested 3210, for example Federal, State, and Regulatory compliance information. In addition, the user optionally may supply payment information. The information may be recorded for future use 3230. If payment is required, the payment can then be processed 3215. The compliance data can be retrieved by any method, such as from a central repository or by scanning various sources of compliance information 3220 and then transmitted to the requestor 3240, and optionally may be automatically displayed on one or more display devices, or may be stored. The system thereby may provide a paperless, end to end, compliance display system.

FIG. 33 is a flow diagram illustrating a compliance announcement, display, and notification system that can prompt the requestor to fill out one or more forms that can determine the compliance posting and notification requirements for a specific business establishment. As shown, a user is prompted to fill out one or more forms that can determine the compliance posting and notification requirements for a specific business or end user 3310. Representative information may include, for example, the nature and location or locations of the business, number of posting sites along with their physical and electronic locations, the types of displays utilized at each location, the number of employees at each location and in total, the languages spoken by employees at each physical location or display location, the annual dollar volume of the business at each location or in total, whether the requestor has Federal contracts or subcontracts, etc. The answers can be utilized to build a list of compliance data posting and notification requirements, optionally for each physical location and/or display 3320. In addition, a master list may be compiled with all compliance and notification requirements for a given requestor for transmission or compliance auditing 3330. The information can be transmitted to the requestor or to various locations or displays 3240, as determined from the user-supplied information.

FIG. 34 is a flow diagram illustrating a compliance announcement, display, and notification system that may allow the requestor to select a fixed period of time to receive compliance data and compliance data updates and to pay for the service online. As shown, a requestor can specify the desired period of time for receiving compliance information and can supply payment information such as a credit card, paypal, bank transfer, or a payment promise, etc., along with any system requested credit information 3410. A determination can be made as to whether payment information or payment promise information has been provided 3415. If payment information has been provided, the payment may then be processed 3420. If the payment is approved 3425, the system can transmit the compliance information, and optionally any future updates, to the requestor 3430. The compliance data can be received 110 and optionally can be automatically displayed and/or stored 3440. If payment is not approved, the user can be notified 3445 and optionally the system may request an alternate form of payment 3450. Referring back to 3415, if a determination is made that a payment promise has been provided, the credit information can be processed 3455. If credit is approved 3460, the system transmits the compliance information, and optionally any future updates, to the requestor 3430. The compliance data can be received 110 and optionally can be automatically displayed and/or stored 3440. If credit is denied, the user can be notified 3465 and, optionally, additional credit information or payment can be requested 3470.

FIG. 35 is a flow diagram illustrating a compliance announcement, display, and notification system that can provide compliance data to the requestor for free. In order to have a viable business, the compliance data can be appended to information from one or more advertisers which can then be displayed concurrently with the compliance information. As shown, requestor or user compliance data can be obtained 3510. The compliance information may have one or more advertisements or brand information appended 3520. The advertising appended may be based on one or more of the following factors: a fixed or variable fee, a per user basis, per display basis, per industry basis, flat fee, by display size, or may be promotional from the compliance data service provider. The advertising and compliance information may be transmitted 3530, and optionally displayed or stored 3540.

FIG. 36 is a flow diagram illustrating a compliance announcement, display, and notification system that may transmit new or updated compliance or announcement data in advance of the compliance data becoming effective. As shown, a test can be performed to see if any new or updated compliance, notification, or announcements or other relevant information is available 3610. If new or updated information is located, the information can be transmitted to one or more users 3620 where the information can be received, cached, and/or stored 3630. A test can be performed to see if the information is effective yet 3640. If the information is not yet effective, the test periodically repeats. If the information is effective, the information may be displayed, printed, and/or redistributed. The updated information may replace existing data being displayed, may be appended to existing data already being displayed, or may replace other data being displayed, thereby affording display of the info/oration on or before the effective date as desired. In addition, the data may also be displayed in advance of or on the effective date and, optionally, on the effective time. Alternately, the data may be displayed in advance of its effective data, simultaneously or in sequence with the currently effective data, or the currently effective data may be displayed simultaneously or in sequence with the upcoming incremental changes, or vice versa. The determination of the effective date may be by any method including, for example, scanning metadata associated with the information, by tags appended to the transmitted information, or by autonomously determining the effective date(s) from the information itself prior to transmission or after receipt.

FIG. 37 is a block diagram illustrating a compliance announcement, display, and notification system that can store compliance data on one or more Document Servers. Compliance, announcement notification, or other data may reside on one or more document server 3710. The document server can be operatively coupled to one or more networks 1310 that electronically distribute some or all of the information to one or more facilities with multiple locations 320, 330, single locations 340, or to a single facility that may then redistribute the information to multiple locations 350, 370, 380. At least one of the cited facilities or locations may have its own document server(s) 3720, 3730, 3740. The information from a document server 3720 may be redistributed to other users 1340 or facilities 1350 via a network 1330, 1310.

The Document Servers may be manually or automatically updated. In addition, the Document Servers may hold multiple revisions of the same compliance data with past, present, or future effective dates, and any other information that may be desired by some or all of the various requestors. In addition, this data, including the compliance data, may reside in for example, multiple proprietary, industry standard, document, database, or display formats, etc., for a variety of requestors and display devices. The Document Servers may keep all revisions of a document, revisions received after a specific date, only the currently effective documents, a specified number of revisions, or any other retention criteria. The retention policy may vary by document type or area of affectivity (for example labor law), or by regulatory agency. The Document Server may store complete documents, or documents and incremental updates. The information from document servers may be displayed and/or printed.

FIGS. 38A & 38B are block diagrams illustrating a compliance announcement, display, and notification system that may generate compliance data specific to a given requestor via a report generator. Requestors such as employees 2630, affiliates 2640, consultants 2645, shareholders 2650, suppliers 2655, other stakeholders 2660, or other requestors 3810, may request information 3815. Each requestor may request multiple different reports comprising various mixtures of compliance data, internal company information, information external to the company, and any other desired information by the requestor. A Report Generator can be utilized to gather requisite information from a Document Server(s) 3825, Company Internal Information Systems or storage 3830, and External Sources of Information 3835 such as, but not limited to, the Internet. The report generator may then transmit the requisite information to a display server 3840 which is may then be utilized to transmit the data via a network 3845, or any other method, to one or more physical or electronic locations 320, 330,340, 350. The transmitted data may be sent by any methods including, for example, physical media or electronic connections including Ethernet, Wifi, any type of modem including cable modem, Local Area Network, Wide Area Network, Cellular, two way radio pager, one way radio pager, satellite transmission, or any combination thereof. It is anticipated that new technologies will become available and will be advantageously employed by the present invention. The report information can be displayed on any form of display 3850 including liquid crystal displays, plasma displays, projection displays, LED displays, OLED displays, e-paper, and electronic ink displays.

FIG. 39 is a flow diagram illustrating a compliance announcement, display, and notification system that can transmit some or all of the compliance, announcement, or notification information along with any other information in an encrypted format to provide data security. Received or obtained compliance information can be encrypted 3910 utilizing any encryption technique 3920 and then transmitted 210. The transmitted information can be received 110 and decrypted 3930. Optionally, the encrypted data may be transmitted, received, decrypted and/or displayed. The encryption may be performed on some or all of the transmitted information. A flag or other identifier may be appended to the information to indicate information that is encrypted or un-encrypted. The receiver may perform decryption on some or all of the decrypted data upon receipt or the receiver may store the data in the received encrypted format. The decryption may also be performed on a request basis by authorized transmitter, receiver, or end user, as appropriate.

FIGS. 40A and 40B are flow diagrams illustrating a compliance announcement, display and notification system that may store or retrieve some or all of the compliance information and any other information in an encrypted format to provide data security. As shown in FIG. 40A, received or obtained compliance information 3910 is encrypted 3920 utilizing any encryption technique 3920 and then can be stored 4010 in any form of storage device. It should be noted that the received or obtained compliance information 3910 may already be encrypted or encoded in some fashion. Optionally, this initial encoding or encryption may be decoded or decrypted prior to encrypting 3920 and storage 4010. Referring to FIG. 40B, encrypted and stored information is retrieved 4020 from a storage device and decrypted 4030. Optionally the decrypted information may be transmitted, processed, displayed, and/or printed 4040. Again, it should be noted that not all of the retrieved information need be decrypted, nor does all of the retrieved information have to in an encrypted format.

FIG. 41 is a flow diagram illustrating a compliance announcement, display, and notification system that may tag some or all of the compliance data, and any other information, with error correction and validation information to ensure that all requested compliance data is received properly. As shown, received or obtained compliance information 3910 can be tagged with error correcting and/or validation information. For example, the error correcting codes could be computed and appended Hamming Codes, or the information itself may be reformatted into a more robust format, such as Grey Code. The information can then be transmitted 210 and received 110. The received data can be checked for errors and/or validated as appropriate 4130. Optionally, errors may be fixed 4140 if possible, and data with any received errors can optionally be flagged for the sender 4150 or receiver 4160. This may allow end users, system administrators, or data provider to know the status on items such as: data received corrupted, amount of corruption, and if some or all of the corrupted data has been corrected. In addition, the status of the information could optionally include information on validation to trigger an alert if unauthorized use of the system occurs. In addition, validation may fail because of data transmission corruption, and this information may also be indicated in an alert level. By way of example, the user can have a low level alert if occasional data corruption occurs or if a validation fails, likely due to data corruption. Alternately, the user can have a high level alert if significant data corruption occurs or validation fails, likely due to system tampering.

FIG. 42 is a flow diagram illustrating a compliance announcement, display, and notification system that can periodically test one or more displays to ensure proper operation. As shown, one or more requests are made for self testing. The request may be made autonomously based upon system performance or an event trigger 4230, autonomously by specified time interval or frequency 4220, or by system or external request 4210. The self test can be initiated 4240 and various test can be performed to see if an anomalous condition occurs 4260. If no anomalous condition exists, a pass or normal operation status may be reported 4270. If an anomalous condition does exist, an optional check can be performed to see if there are additional diagnostic tests available and optionally if those test should be performed 4250. If no additional diagnostic tests are to be performed, then the anamolous condition(s) may be reported 4270. If additional diagnostic tests are to be performed, then they can be executed 4280 and the status may then reported 4270. It should be noted that anomalous conditions may include items that are fully operational but show indications of possible future failure conditions. In this manner, the tests may be used for predictive failure analysis and to request preventive maintenance to avoid any failures.

FIG. 43 is a block diagram illustrating a compliance announcement, display, and notification system that can utilize one or more redundant displays at the same physical location to ensure continuous uninterrupted display of compliance information and any other desired notification or emergency information. As shown, received compliance information 110 can be displayed on two or more co-located displays 120 and 4310. The co-located displays 120 and 4320 are capable of showing the same compliance information. If one display fails the other display can ensure that requisite compliance information is available for viewing. It should be noted that it is not necessary for both displays to show the same information at the same time. Indeed, in an interactive menu driven version of the system, each display may serve a different end user viewing different information. In addition, in an advertising driven business model, each display may show different advertising information.

FIG. 44 is a block diagram illustrating a compliance announcement, display, and notification system that can utilize multiple displays devices to display compliance information in a more optimal fashion. Upon the failure of one or more display devices, but not all of the displays, the display operative display or displays may be altered to show mandated or highest priority compliance data. As shown, received compliance information 110 can be displayed on two or more co-located displays, where one or more of the displays have failed 4420, and at least one remaining operational displays 4410 is altered to ensure that requisite compliance information is available for viewing. Thus, it is not necessary that all of the displays were initially used to show compliance information.

FIG. 45 is a block diagram illustrating a compliance announcement, display, and notification system that can utilize one or more displays co-located within a fixed proximity of each other and can be showing compliance information. In the event of a failure of one or more, but not all, displays, the remaining display(s) can be so positioned as to fulfill compliance for both geographic areas. Optionally, a fixed sign indicates that, if this display is inoperative, please see display located at xyz location, thus allowing for greater geographical separation of the displays.

As shown, received compliance information 110 can be displayed on two or more co-located displays 4510, where at least one display has a fixed signage indicating where one or more displays capable of showing the same compliance information are located. The co-located displays 120 and 4320 can be capable of showing the same compliance information. If one display fails, the other display can ensure that requisite compliance information is available for viewing. Once again, it should be noted that it is not necessary for both displays to show the same information at the same time. Indeed, in an interactive menu driven version of the system, each display may serve a different end user viewing different information. In addition, in an advertising driven business model, each display may show different advertising information.

FIG. 46 is a block diagram illustrating a compliance announcement, display, and notification system that can utilize an input device utilized to select compliance or any other information to display or remote access or system setup information. As shown, an input, and optional display, device selects the appropriate information, system setup, configuration, or maintenance information 4610 to display. The compliance or remote access or setup information can then be transmitted 4620 via a network 3845, or any other method, to one or more physical or electronic locations 320, 330,340, 350. The transmitted data may be sent by any electronic means including Ethernet, Wifi, any type of modem including cable modem, Local Area Network, Wide Area Network, Cellular, two way radio pager, one way radio pager, satellite transmission, or any combination thereof. The information can optionally be displayed on any form of display 3850, including liquid crystal displays, plasma displays, projection displays, LED displays, OLED displays, e-paper, and electronic ink displays.

FIGS. 47 A and 47B are block diagrams illustrating a compliance announcement, display, and notification system that can controls the compliance announcement, display, and notification system via one or more devices utilizing wireless interfaces such as, for example, Bluetooth and wireless Local or Wide Area networking, utilizing any available protocol including text messaging and other standard and non-standard protocols. As shown, one or more wireless input, and optionally wireless display device, may select the appropriate information to display or system setup, configuration, or maintenance information 4710. The wireless device may also be utilized for remote access for system setup, monitoring, updates, and compliance verification. The wireless input and optionally display device may be a cell phone device or wireless Internet-connected Personal Digital Assistant or Smart Phone to select compliance or any other information to display according to another embodiment of the present invention. In addition, the connections to the network and display device may be any form of wireless including LAN, WAN, Cell, or Bluetooth. The wireless information can optionally be received by a wireless receiver and retransmitted 4720 via a wired or wireless network 4740, which can then be utilized to transmit the data to one or more physical or electronic locations 320, 330,350. Alternately, the wireless device 4710 can connect directly with one or more facilities 320, 330, 350, or directly with display devices 4750. It should be noted that a direct wireless connection, such as a cell phone text message, may employ a mixture of transmission technologies such as wireless, the Internet, and ground or satellite based links. Optionally, compliance information or the received remote access or setup information can then be displayed on any form of display 3850, 4750, including liquid crystal displays, plasma displays, projection displays, LED displays, OLED displays, e-paper, and electronic ink displays.

FIG. 48 is a block diagram illustrating a compliance announcement, display, and notification system that can have one or more of the displays utilized to show compliance information or other information along with emergency alerts and, optionally, emergency condition and emergency procedures or recommended action. As shown, one or more sources of emergency condition notification such as, for example, the Emergency Broadcast System 4810, a fire alarm 4815, a burglar alarm 4820, a carbon monoxide alarm 4825, flood/tsunami notification 4830, weather condition notification 4835, terrorist act notification 4840, or other emergency conditions 4845 such as chemical agent detection, biological agent detection, or a warning system for any type of imminent or an emergent emergency situation. The emergency notification may be as simple as a notification that an emergency exists, with optional information such as the type of emergency, location, and recommended course of action. Alternately, the recommended course(s) of action and procedures may be pre-stored in the system and their display on various displays triggered by a logic system that utilizes the emergency notification inputs coupled with a prior knowledge of the building or facilities and, optionally, the known or expected occupants. In addition to sources of emergency information, the system can be operatively connected to compliance information 4845 and, optionally, other sources of notification or broadcast 4855 such as news ticker or a stock ticker or audio or video broadcast. The sources of emergency notification 4810, 4815, 4820, 4825, 4830, 4835, 4840, 4845, compliance information 4845, and optional broadcast sources 4855 are operatively coupled to a computer or other logic device that determines the priority of information to display 4850. Once the priority and, optionally, sequence of display information has been determined for one or more displays, the information can then be sent to the appropriate display 4865. In the event of an emergency, the display(s) may conspicuously display one or more of the following pieces of information: that an emergency condition exists, the nature of the emergency, any corrective actions or emergency procedures to follow. One or more emergency notices may be displayed on a priority basis, pre-empting some or all of the otherwise displayed information. In order to make the system robust, Emergency, Redundant, or Backup Power 4860 may be employed to keep all devices operational. Static Display Devices such as e-paper and e-ink may advantageously retain information during periods of power loss and do not require continuous updates—something extremely valuable for robustness in various emergency conditions. In addition, the system may be coupled with display reporting and self monitoring so that emergency rescue personnel will know the information and procedures each display is showing. This may be invaluable in a rescue operation. Finally, other means of communication to rescue and/or emergency personnel may be co-located with each display such as, for example, a two way audio or video system, a simple alarm actuator, etc.

FIG. 49 is a block diagram illustrating a compliance announcement, display, and notification system that can utilize one or more standardized Emergency Notification Protocols to provide integration of emergency detection and notification systems and rapid dissemination of emergency information and procedures. As shown, an emergency broadcast or notification utilizing a standardized emergency protocol 4910 can be utilized as input to the system along with compliance information 4845, and optional broadcast sources 4855 are operatively coupled to a computer or other logic device that may determine the priority of information to display 4850. Once the priority and, optionally, sequence of display information has been determined for one or more displays, the information may then be sent to the appropriate display 4865. The standard emergency broadcast or notification protocols may have Emergency Notification flags embedded within the header field or body of the message to provide rapid integration into emergency detection and notification systems and rapid dissemination of emergency information and procedures.

FIGS. 50A and 50B are block diagrams illustrating a compliance announcement, display and notification system that may utilize an emergency notification and services routing system that can accept sensor input, external information, and may automatically generate emergency notification messages and procedures for specific address or may broadcast to a range of addresses. The emergency notification and services routing system can be targeted for specific facilities or for specific locations within a given facility. As shown, one or more sources of emergency condition notification such as, for example, the Emergency Broadcast System 4810, a fire alarm 4815, a burglar alarm 4820, a carbon monoxide alarm 4825, flood/tsunami notification 4830, weather condition notification 4835, terrorist act notification 4840, or other emergency conditions 4845 such as chemical agent detection, biological agent detection, or a warning system for any type of imminent or an emergent emergency situation. The emergency notification may be as simple as a notification that an emergency exists, with optional information such as, for example, the type of emergency, location, and recommended course of action. Alternately, the recommended course(s) of action and procedures may be pre-stored in the system and their display on various displays triggered by a logic system that may utilize the emergency notification inputs coupled with a-prior knowledge of the building or facilities and, optionally, the known or expected occupants. In addition to sources of emergency information, the system may be operatively connected to compliance information 4845 and, optionally, other sources of notification or broadcast 4855 such as news ticker or a stock ticker or audio or video broadcast. The sources of emergency notification 4810, 4815, 4820, 4825, 4830, 4835, 4840, 4845, compliance information 4845, and optional broadcast sources 4855 are operatively coupled to a computer or other logic device that determines the priority of information to display along with the various areas for display of specific information 5050. Once the priority and, optionally, sequence of display information has been determined for each display or displays, the information may then be transmitted to various locations 5010 and/or displays. Optionally, information may also be received for acknowledgement of receipt and/or end user signaling. In the event of an emergency, the display(s) may conspicuously displays one or more of the following pieces of information: that an emergency condition exists, the nature of the emergency, any corrective actions or emergency procedures to follow, etc. One or more emergency notices may be displayed on a priority basis, pre-empting some or all of the otherwise displayed information. In order to make the system robust, Emergency, Redundant, or Backup Power 4860 may be employed to keep all devices operational. Additionally and/or alternatively, back-up or emergency power may also be utilized to keep data distribution networks viable 5020 or may be kept at various facilities and locations 5030. Facilities may have single 340 or multiple locations 320, 350. Static Display Devices such as e-paper and e-ink may advantageously retain information during periods of power loss and do not require continuous updates—something extremely valuable for robustness in various emergency conditions. In addition, the system may be coupled with display reporting and self monitoring so that emergency rescue personnel can know the information and procedures each display is showing. This may be invaluable in a rescue operation. Other means of communication to rescue and/or emergency personnel may be co-located with each display such as, for example, a two way audio or video system or a simple alarm actuator.

FIGS. 51A and 51B are block diagrams illustrating a compliance announcement, display, and notification system that can utilize authentication and validation of both compliance data and/or emergency messages to ensure that messages are authentic and valid. As shown in FIG. 51A, received, encrypted compliance and/or emergency notification information 5110 can be decrypted 5120 and authenticated 5130 prior to use. It should be noted that it is not necessary that all of the received information be encrypted or authenticated. It may be advantageous to use only authentication and/or only encryption for certain types of information, such as only encryption for compliance information or only authentication for emergency information. As shown in FIG. 51B, authenticated compliance and/or emergency notification information 5140 can be encrypted 5150 and transmitted 5130 to one or more physical or electronic locations. Again, it should be noted that it is not necessary that all of the information be authenticated or encrypted.

From the foregoing description, persons skilled in the art will recognize that this invention provides display and notification of information. In addition, persons skilled in the art will appreciate that the various configurations described herein may be combined without departing from the present invention. It will also be recognized that the invention may take many forms other than those disclosed in this specification. Accordingly, it is emphasized that the invention is not limited to the disclosed methods, systems, and apparatuses, but is intended to include variations to and modifications thereof which are within the spirit of the following claims.

What is claimed is:

1. A computer implemented method for labor law compliance information display and notification, the method comprising:
locating one or more electronic sources of labor law compliance information;
automatically generating a list of computer links to one or more of the electronic sources based on predetermined criteria associated with the labor law compliance information;
downloading over a network, utilizing the generated list of links, labor law compliance information comprising data posting and notification requirements for a physical location, wherein the labor law compliance information comprises information an employer is required to publicly post in compliance with governmental regulatory requirements;
selecting, automatically, at least a portion of the labor law compliance information based on the data posting and notification requirements and the physical location; and
displaying, on an electronic display, the selected portion of the labor law compliance information,
wherein the locating, generating, downloading, selecting, and displaying are performed using one or more processors.

2. The computer implemented method of claim 1, wherein the labor law compliance information comprises at least one of: Certificates of Insurance, Workmens' Compensation Insurance, and OSHA Requirements.

3. The computer implemented method of claim 1, further comprising:
receiving a user request to print a subset of the portion of the labor law compliance information, wherein the user request is received via an input device of an electronic device.

4. The computer implemented method of claim 1, further comprising:
periodically testing the electronic display to ensure proper operation of the electronic display, wherein the testing is performed by a microprocessor within the electronic display.

5. The computer implemented method of claim 1, wherein the electronic display comprises a redundant electronic display at a same physical location.

6. The computer implemented method of claim 1, further comprising:
automatically determining if the labor law compliance information associated with a generated link has been updated;
downloading the updated labor law compliance information; and
replacing, on the electronic display, at least a portion of the currently displayed labor law compliance information with the updated labor law compliance information.

7. The computer implemented method of claim 6, further comprising:
automatically sending an alert to a user that the updated labor law compliance information has been received.

8. The computer implemented method of claim 1, further comprising:
identifying a user's identity;
identifying a specific language based on the user's identity; and
displaying the labor law compliance information in the identified language on the electronic display.

9. The computer implemented method of claim 1, further comprising:
determining the effective date of the downloaded labor law compliance information; and
withholding from displaying the labor law compliance information on the electronic display until a specific date, wherein the specific date is determined based on the effective date of the received labor law compliance information.

10. The computer implemented method of claim 1, further comprising:
displaying a plurality of menus on the electronic display, wherein each menu of the plurality of menus comprises at least a portion of the labor law compliance information.

11. The computer implemented method of claim 1, further comprising:
displaying, on the electronic display, at least a portion of the labor law compliance information in a first menu, wherein the first menu includes a plurality of selectable items;
receiving a user selection of a particular selectable item of the plurality of selectable items, wherein the user selection is received via an input device of an electronic device; and
displaying a second menu on the electronic display in response to receiving the user selection.

12. The computer implemented method of claim 11, further comprising:
storing user selections of selectable items in a storage device; and
displaying on the electronic display a particular set of labor law compliance information in a menu based on the stored user selections.

13. The computer implemented method of claim 1, further comprising:
utilizing an input control device and the electronic display to perform at least one of remotely accessing:
system setup, monitoring, updates, and labor law compliance verification information.

14. The computer implemented method of claim 1, further comprising:
receiving emergency notification information; and
simultaneously displaying on the at least a portion of the labor law compliance information and the emergency information.

15. A computer implemented method for labor law compliance information display and notification comprising:
locating one or more network based sources of labor law compliance information;
generating a list of links to one or more of the networked based sources based on predetermined criteria associated with the labor law compliance information;
downloading, utilizing the generated list of links, labor law compliance data posting and notification requirements for a physical location;
downloading, utilizing the generated list of links, labor law compliance information comprising information an employer is required to publicly post in compliance with governmental regulatory requirements;
selecting, automatically, at least a portion of the labor law compliance information based on labor law compliance data posting and notification requirements and the physical location; and
storing the downloaded labor law compliance information in an information database,
wherein the locating, generating, downloading, selecting, and storing are performed using one or more processors.

16. The computer implemented method of claim 15, further comprising:
tagging the downloaded labor law compliance information with one or more of its effective date, date of creation, meta data, date of receipt, source information, and known conflicts.

17. The computer implemented method of claim 15, further comprising:
identifying a portion of the downloaded labor law compliance information that is currently valid, wherein the remaining received labor law compliance information is not currently valid; and
storing only the currently valid labor law compliance information in the information database.

18. The computer implemented method of claim 15, further comprising:
storing a list of a plurality of sources in a second database, wherein each of the plurality of sources provide information relating to labor law compliance information; and
automatically determining if the labor law compliance information associated with a generated link has been updated; and
identifying the updated labor law compliance information in the sources.

19. The computer implemented method of claim 18 wherein locating comprises automatically scanning the internet for data related to labor law compliance information.

20. A computer implemented method for labor law compliance and announcement display and notification comprising:
locating one or more electronic sources of labor law compliance information;
generating a list of links to one or more of the electronic sources based on predetermined criteria associated with the labor law compliance information;
downloading, utilizing the generated list of links, labor law compliance labor law compliance information, wherein the labor law compliance information comprises information an employer is required to publicly post in compliance with governmental regulatory requirements;
identifying a particular display of a plurality of displays;
formatting the labor law compliance information to match a display resolution of the particular display; and
displaying the labor law compliance information on the particular display,
wherein the locating, generating, downloading, identifying, formatting, and displaying are performed using one or more processors.
